(19) United States
(12) Patent Application Publication
(10) Pub. No.: US 2014/0377697 A1
(43) Pub. Date: Dec. 25, 2014

(54) CYAN TONER CONTAINING COMPOUND HAVING AZO SKELETON

(71) Applicant: CANON KABUSHIKI KAISHA, Tokyo (JP)

(72) Inventors: Chiaki Nishiura, Kawasaki-shi (JP); Yasuaki Murai, Kawasaki-shi (JP); Yuki Hasegawa, Yokohama-shi (JP); Waka Hasegawa, Tokyo (JP); Masashi Kawamura, Yokohama-shi (JP); Taiki Watanabe, Akishima-shi (JP); Masanori Seki, Yokohama-shi (JP); Ayano Mashida, Kawasaki-shi (JP); Takayuki Toyoda, Yokohama-shi (JP); Masashi Hirose, Machida-shi (JP)

(21) Appl. No.: 14/376,225

(22) PCT Filed: Feb. 27, 2013
(86) PCT No.: PCT/JP2013/056058

§ 371 Date: Aug. 1, 2014

(30) Foreign Application Priority Data
Feb. 29, 2012 (JP) 2012-043075

(51) Int. Cl. G03G 9/10; G03G 9/09

(52) U.S. Cl. CPC G03G 9/10; G03G 9/0918
USPC 430/108.21

(57) ABSTRACT

An object of the present invention is to provide a cyan toner having a high coloring ability, enabling suppression of fogging, and having high transfer efficiency. The object can be attained by a toner including toner particles containing a binder resin, a compound having a polymeric portion bound to an azo skeleton, and a phthalocyanine pigment as a colorant.

### TECHNICAL FIELD

The present invention relates to a cyan toner containing a compound that has an azo skeleton structure as a dispersant for a phthalocyanine pigment and is used for electrophotography, electrostatic recording, electrostatic printing, or toner jet recording.

### BACKGROUND ART

Insufficient dispersibility of a pigment in toner particles causes reduction in the coloring ability of the toner. For this, techniques of dispersing a pigment using various methods have been developed.

As a technique of dispersing a phthalocyanine pigment in toner particles, PTL 1 discloses an example in which a polymer containing a sodium styrenesulfonate used as a monomer unit is used as a dispersant.

Another example of the technique proposes a method in which a metal-containing phthalocyanine and a polymer having a substituent coordinatable with the metal-containing phthalocyanine (hereinafter, also referred to as a coordinatable polymer) coexist to improve dispersibility of a phthalocyanine pigment.

PTL 2 discloses an example in which a 4-vinylpyridine/styrene copolymer is used as the coordinatable polymer.

Meanwhile, PTL 3 discloses an example in which a monomer having an amide group and a styrene copolymer are used as the coordinatable polymer.

### CITATION LIST

### Patent Literature

PTL 1: Japanese Patent Application Laid-Open No. H03-113462
PTL 2: Japanese Patent Application Laid-Open No. 2003-277643
PTL 3: Japanese Patent No. 4510687

### SUMMARY OF INVENTION

### Technical Problem

The dispersant for a phthalocyanine pigment according to PTL 1 contains a sodium styrenesulfonate having high affinity with water. For this reason, in a method for producing a toner in water such as a suspension polymerization method, the dispersant is easily distributed unevenly on the surface of the toner. As a result, dispersibility may be reduced. Moreover, change in the surface state may affect the charging properties of the toner, causing image defects called “fogging” in which the toner is developed in a non-image portion.

Moreover, in the method for improving dispersibility of a phthalocyanine pigment according to PTLs 2 and 3, the metal-containing phthalocyanine and the coordinatable polymer are coordinated to develop dispersibility. For this reason, to keep the dispersibility, a large amount of the coordinatable polymer needs to be added.

Accordingly, an object of the present invention is to provide a cyan toner having improved dispersibility of a cyan pigment in a binder resin and a high coloring ability. Another object of the present invention is to provide a cyan toner that enables suppression of “fogging” and has high transfer efficiency.

### Solution to Problem

The objects above can be attained by the present invention below.

Namely, the present invention provides a cyan toner including toner particles containing a binder resin; a compound having a partial structure and a polymeric portion having a monomer unit, the partial structure being bound to the polymeric portion; and a phthalocyanine pigment as a colorant, the partial structure being represented by the following formula (1):

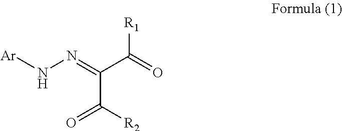

[wherein at least one of R₁, R₂, and Ar is bound to the polymeric portion via a linking group or by a single bond; R₁ and R₂ not bound to the polymeric portion each independently represent an alkyl group, a phenyl group, an OR₅ group, or an NR₆R₇ group; Ar not bound to the polymeric portion represents an aryl group; R₁ and R₂ bound to the polymeric portion each independently represent a divalent group in which a hydrogen atom in the alkyl group, the phenyl group, the OR₅ group, or the NR₆R₇ group is eliminated; Ar bound to the polymeric portion represents a divalent group in which a hydrogen atom in the aryl group is eliminated; R₅ to R₇ each independently represent a hydrogen atom, an alkyl group, a phenyl group, or an aralkyl group; and the monomer unit being represented by the following formula (2):

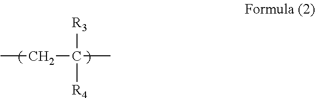

wherein R₃ represents a hydrogen atom or an alkyl group; and R₄ represents a phenyl group, a carboxyl group, a carboxylic acid ester group, or a carboxylic acid amide group].

### Advantageous Effects of Invention

The present invention can provide a cyan toner having a high coloring ability, enabling suppression of fogging, and having high transfer efficiency.

Further features of the present invention will become apparent from the following description of exemplary embodiments with reference to the attached drawings.

### BRIEF DESCRIPTION OF DRAWINGS

FIG. 1 is a drawing showing a ¹H NMR spectrum at 400 MHz and room temperature in CDCl₃ of Compound (101) having an azo skeleton structure.

FIG. 2 is a drawing showing a ¹H NMR spectrum at 400 MHz and room temperature in CDCl₃ of Compound (110) having an azo skeleton structure.

FIG. 3 is a drawing showing a ¹H NMR spectrum at 600 MHz and room temperature in CDCl₃ of Compound (118) having an azo skeleton structure.

FIG. 4 is a drawing showing a ¹H NMR spectrum at 600 MHz and room temperature in CDCl₃ of Compound (119) having an azo skeleton structure.

FIG. 5 is a drawing showing a ¹H NMR spectrum at 600 MHz and room temperature in CDCl₃ of Compound (150) having an azo skeleton structure.

FIG. 6 is a drawing showing a ¹H NMR spectrum at 600 MHz and room temperature in CDCl₃ of Compound (108) having an azo skeleton structure.

FIG. 7 is a drawing showing a ¹H NMR spectrum at 600 MHz and room temperature in CDCl₃ of Compound (109) having an azo skeleton structure.

FIG. 8 is a drawing showing a ¹H NMR spectrum at 600 MHz and room temperature in CDCl₃ of Compound (152) having an azo skeleton structure.

FIG. 9 is a drawing showing a ¹H NMR spectrum at 600 MHz and room temperature in CDCl₃ of Compound (155) having an azo skeleton structure.

FIG. 10 is a drawing showing a ¹H NMR spectrum at 600 MHz and room temperature in CDCl₃ of Compound (157) having an azo skeleton structure.

### DESCRIPTION OF EMBODIMENTS

Hereinafter, the present invention will be described in detail using suitable embodiments.

The toner according to the present invention includes toner particles containing a binder resin, a compound having a partial structure and a polymeric portion having a monomer unit, the partial structure being bound to the polymeric portion, and a phthalocyanine pigment as a colorant, the partial structure being represented by the following formula (1):

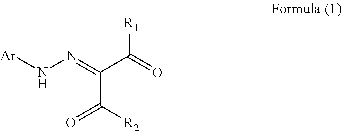

[wherein at least one of R₁, R₂, and Ar is bound to the polymeric portion via a linking group or by a single bond; R₁ and R₂ not bound to the polymeric portion each independently represent an alkyl group, a phenyl group, an OR₅ group, or an NR₆R₇ group; Ar not bound to the polymeric portion represents an aryl group; R₁ and R₂ bound to the polymeric portion each independently represent a divalent group in which a hydrogen atom in the alkyl group, the phenyl group, the OR₅ group, or the NR₆R₇ group is eliminated; Ar bound to the polymeric portion represents a divalent group in which a hydrogen atom in the aryl group is eliminated; R₅ to R₇ each independently represent a hydrogen atom, an alkyl group, a phenyl group, or an aralkyl group; and the monomer unit being represented by the following formula (2):

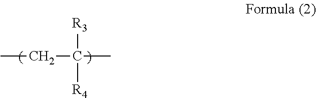

wherein R₃ represents a hydrogen atom or an alkyl group; and R₄ represents a phenyl group, a carboxyl group, a carboxylic acid ester group, or a carboxylic acid amide group].

The compound having the partial structure represented by the above formula (1) bound to the polymeric portion having a monomer unit represented by the above formula (2) has high affinity with a water-insoluble solvent, a polymerizable monomer, and a binder resin for a toner and high affinity with the phthalocyanine pigment. Accordingly, by use of the compound as the pigment dispersant, the phthalocyanine pigment is dispersed in the binder resin well, providing a cyan toner having a high coloring ability. Moreover, by adding the compound to the cyan toner particles, fogging is suppressed, providing a cyan toner having high transfer efficiency.

The partial structure represented by the formula (1) is also referred to as an “azo skeleton structure.” Further, the compound having the azo skeleton structure bound to the polymeric portion having a monomer unit represented by the formula (2) is also referred to as a “compound having an azo skeleton structure.” The polymeric portion not bound to the azo skeleton structure and having a monomer unit represented by the formula (2) is also referred to as a “polymeric portion.”

First, the compound having an azo skeleton structure will be described.

The compound having an azo skeleton structure includes the azo skeleton structure represented by the above formula (1) having high affinity with the phthalocyanine pigment, and the polymeric portion having a monomer unit represented by the above formula (2) and high affinity with a water-insoluble solvent.

First, the azo skeleton structure represented by the above formula (1) will be described in detail.

Examples of the alkyl group for R₁ and R₂ in the above formula (1) include a linear, branched, or cyclic alkyl group such as a methyl group, an ethyl group, an n-propyl group, an n-butyl group, an n-pentyl group, an n-hexyl group, an isopropyl group, an isobutyl group, a sec-butyl group, a tert-butyl group, and a cyclohexyl group.

Examples of the alkyl group for R₅ to R₇ in the OR₅ group and the NR₆R₇ group in the above formula (1) include a linear, branched or cyclic alkyl group such as a methyl group, an ethyl group, an n-propyl group, an n-butyl group, an n-pentyl group, an n-hexyl group, an isopropyl group, an isobutyl group, a sec-butyl group, a tert-butyl group, and a cyclohexyl group.

Examples of the aralkyl group for R₅ to R₇ in the OR₅ group and the NR₆R₇ group in the above formula (1) include a benzyl group and a phenethyl group.

Further, R₁ and R₂ in the above formula (1) may optionally have a substituent as long as the affinity with the phthalocyanine pigment is not significantly inhibited. In this case, examples of the optional substituent include a halogen atom, a nitro group, an alkyl group, an amino group, a hydroxyl group, a cyano group, and a trifluoromethyl group.

Considering the affinity with the phthalocyanine pigment, R₁ in the above formula (1) can be a methyl group.

Considering the affinity with the phthalocyanine pigment, R₂ in the above formula (1) can be an NR₆R₇ group, R₆ can be a hydrogen atom, and R₇ can be a phenyl group.

Ar in the above formula (1) represents an aryl group, and examples of the aryl group include a phenyl group and a naphthyl group.

Further, Ar in the above formula (1) may optionally have a substituent as long as the affinity with the phthalocyanine pigment is not significantly inhibited. In this case, examples of the optional substituent include an alkyl group, an alkoxy group, a halogen atom, a hydroxyl group, a cyano group, a trifluoromethyl group, a carboxyl group, a carboxylic acid ester group, and a carboxylic acid amide group.

At least one of R₁, R₂, and Ar in the above formula (1) is bound to the polymeric portion via a linking group or by a single bond. R₁ and R₂ bound to the polymeric portion each independently represent a divalent group in which a hydrogen atom in the alkyl group, the phenyl group, the OR₅ group, or the NR₆R₇ group is eliminated. Ar bound to the polymeric portion represents a divalent group in which a hydrogen atom in the aryl group is eliminated. In this case, the linking group is not particularly limited as long as the linking group is a divalent linking group. From the viewpoint of easy production, the bond preferably includes a carboxylic acid ester bond, a carboxylic acid amide bond, or a sulfonic acid ester bond. Particularly, the bond more preferably includes a secondary amide bond having high synthesis yield and high stability of the bond.

From the viewpoint of the affinity with the phthalocyanine pigment, the partial structure represented by the above formula (1) can be a structure represented by the following formula (3):

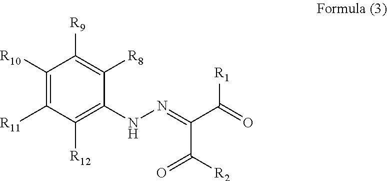

[wherein R₁ and R₂ each independently represent an alkyl group, a phenyl group, an OR₅ group, or an NR₆R₇ group; R₈ to R₁₂ each independently represent a hydrogen atom, a COOR₁₃ group, or a CONR₁₄R₁₅ group; R₁₃ to R₁₅ each independently represent a hydrogen atom, an alkyl group, a phenyl group, or an aralkyl group; and at least one of R₁, R₂, and R₈ to R₁₂ has a portion linking to the polymeric portion represented by the above formula (2)].

Examples of the alkyl group for R₁₃ to R₁₅ in the above formula (3) include a methyl group, an ethyl group, an n-propyl group, and an isopropyl group.

Examples of the aralkyl group for R₁₃ to R₁₅ in the above formula (3) include a benzyl group and a phenethyl group.

From the viewpoint of the affinity with the phthalocyanine pigment, at least one of R₈ to R₁₂ in the above formula (3) can be a COOR₁₃ group or a CONR₁₄R₁₅ group.

From the viewpoint of the affinity with the phthalocyanine pigment, R₁₃ can be a methyl group, R₁₄ can be a hydrogen atom, and R₁₅ can be a methyl group or a hydrogen atom.

At least one of R₁, R₂, and R₈ to R₁₂ in the above formula (3) has a linking portion to the polymeric portion. From the viewpoint of the affinity with the phthalocyanine pigment and easy production, particularly, R₂ can be an NR₆R₇ group, R₆ can be a hydrogen atom, and R₇ can be a phenyl group having a linking group to the polymeric portion.

From the viewpoint of the affinity with phthalocyanine pigment, the partial structure represented by the above formula (1) can be a structure represented by the following formula (4) or (5):

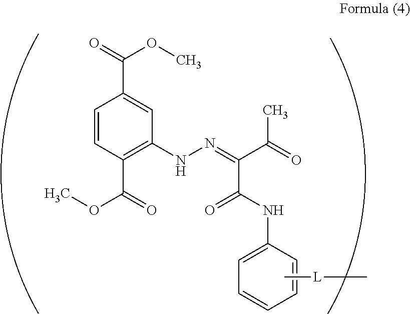

[wherein L represents a divalent linking group bound to the polymeric portion having a monomer unit represented by the above formula (2):

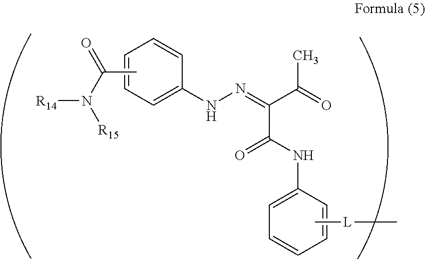

wherein R₁₄ and R₁₅ each independently represent a hydrogen atom, an alkyl group, a phenyl group, or an aralkyl group; L represents a divalent linking group bound to the polymeric portion having a monomer unit represented by the above formula (2)].

The linking group L to the polymeric portion in the above formulas (4) and (5) is not particularly limited as long as the linking group is a divalent linking group. From the viewpoint of easy production, the bond preferably includes a carboxylic acid ester bond, a carboxylic acid amide bond, or a sulfonic acid ester bond. Particularly, the bond more preferably includes a secondary amide bond having high synthesis yield and high stability of the bond.

In the above formulas (4) and (5), the affinity with the phthalocyanine pigment, which is derived from the difference in the substitution position of the linking group L bound to the azo skeleton structure, is equal.

Examples of the substitution position of the carboxylic acid amide in the above formula (5) include the case of substitution with the carboxylic acid amide at the o-position, the m-position, or the p-position with respect to an azo group. From the viewpoint of the affinity with the phthalocyanine pigment, substitution with the carboxylic acid amide at the m-position or the p-position is preferable.

Next, the polymeric portion having a monomer unit represented by the above formula (2) will be described in detail.

The alkyl group for R₃ in the above formula (2) is not particularly limited. Examples of the alkyl group include a linear, branched or cyclic alkyl group such as a methyl group, an ethyl group, an n-propyl group, an n-butyl group, an n-pentyl group, an n-hexyl group, an isopropyl group, an isobutyl group, a sec-butyl group, a tert-butyl group, and a cyclohexyl group.

R₃ in the above formula (2) can be a hydrogen atom or a methyl group from the viewpoint of the polymerizability of the monomer unit.

The carboxylic acid ester group for R₄ in the above formula (2) is not particularly limited. Examples of the carboxylic acid ester group include a linear or branched ester group such as a methyl ester group, an ethyl ester group, an n-propyl ester group, an isopropyl ester group, an n-butyl ester group, an isobutyl ester group, a sec-butyl ester group, a tert-butyl ester group, an octyl ester group, a nonyl ester group, a decyl ester group, an undecyl ester group, a dodecyl ester group, a hexadecyl ester group, an octadecyl ester group, an eicosyl ester group, a docosyl ester group, a 2-ethylhexyl ester group, a phenyl ester group, and a 2-hydroxyethyl ester group.

Examples of the carboxylic acid amide group for R₄ in the above formula (2) include a linear or branched amide group such as an N-methylamide group, an N,N-dimethylamide group, an N-ethylamide group, an N,N-diethylamide group, an N-isopropylamide group, an N,N-diisopropylamide group, an N-n-butylamide group, an N,N-di-n-butylamide group, an N-isobutylamide group, an N,N-diisobutylamide group, an N-sec-butylamide group, an N,N-di-sec-butylamide group, an N-tert-butylamide group, an N-octylamide group, an N,N-dioctylamide group, an N-nonylamide group, an N,N-dinonylamide group, an N-decylamide group, an N,N-didecylamide group, an N-undecylamide group, an N,N-diundecylamine group, an N-dodecylamide group, an N,N-didodecylamide group, an N-hexadecylamide group, an N-octadecylamide group, an N-phenylamide group, an N-(2-ethylhexyl)amide group, and an N,N-di-(2-ethylhexyl)amide group.

Further, R₄ in the above formula (2) may optionally have a substituent. The optional substituent is not particularly limited as long as the polymerizability of the polymerizable monomer that forms the monomer unit is not inhibited, or the solubility of the compound having an azo skeleton structure is not significantly reduced. In this case, examples of the optional substituent include an alkoxy group such as a methoxy group and an ethoxy group; an amino group such as an N-methylamino group and an N,N-dimethylamino group; an acyl group such as an acetyl group; and a halogen atom such as a fluorine atom and a chlorine atom.

R₄ in the above formula (2) can be a phenyl group, a carboxylic acid ester group, or a carboxylic acid amide group from the viewpoint of the dispersibility and compatibility of the toner containing the compound having an azo skeleton structure with respect to the binder resin.

The polymeric portion can control the affinity with a dispersion medium by changing the proportion of the monomer unit represented by the above formula (2). In the case where the dispersion medium is a non-polar solvent such as styrene, R₄ in the above formula (2) can have a large proportion of the monomer unit represented by the phenyl group from the viewpoint of the affinity with the dispersion medium. In the case where the dispersion medium is a solvent having a certain degree of polarity such as acrylic acid ester, R₄ in the above formula (2) can have a larger proportion of the monomer unit represented by the carboxyl group, the carboxylic acid ester group, or the carboxylic acid amide group from the viewpoint of the affinity with the dispersion medium.

As the molecular weight of the polymeric portion, the number average molecular weight can be 500 or more from the viewpoint of the dispersibility of the phthalocyanine pigment. A larger molecular weight provides a higher effect of improving the dispersibility of the phthalocyanine pigment. However, an excessively large molecular weight is not preferable because the affinity with the water-insoluble solvent tends to be reduced. Accordingly, the number average molecular weight of the polymeric portion is preferably 200000 or less. Besides, considering easy production, the number average molecular weight of the polymeric portion is more preferably within the range of 2000 to 50000.

As disclosed in National Publication of International Patent Application No. 2003-531001, a method for improving dispersibility is known in which a branched aliphatic chain is introduced into a terminal in a polyoxyalkylene carbonyl dispersant. In the polymeric portion in the present invention, if a telechelic polymeric portion is synthesized using a method such as ATRP (Atom Transfer Radial Polymerization) described later, a branched aliphatic chain can be introduced into the terminal. This operation may lead to improvement in dispersibility.

The position of the azo skeleton structure in the compound having an azo skeleton structure may be sparse at random, or one or more blocks may be formed at one end and unevenly distributed.

Higher affinity with the phthalocyanine pigment is attained if the number of the azo skeleton structures in the compound having an azo skeleton structure is larger. However, if the number is excessively large, the affinity with the water-insoluble solvent tends to be reduced. Accordingly, this case is not preferable. Accordingly, the number of the azo skeleton structures is preferably within the range of 0.5 to 10, and more preferably within the range of 0.5 to 5 based on the number of monomers that form the polymeric portion of 100.

As shown in the drawing below, the azo skeleton structure represented by the above formula (1) includes tautomers represented by the following formulas (7-A), (7-B), and the like. These tautomers are also included in the scope of the present invention:

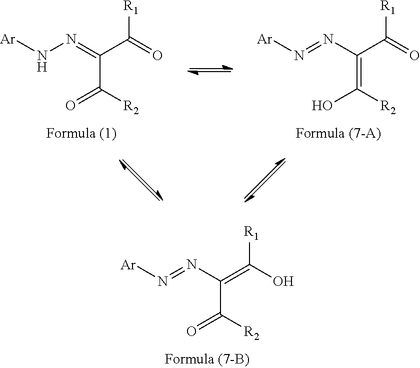

[wherein R₁, R₂, and Ar in the formulas (7-A) and (7-B) each are the same as those in R₁, R₂, and Ar in the formula (1)].

The compound having an azo skeleton structure can be synthesized according to a known method.

Examples of a method of synthesizing the compound having an azo skeleton structure include methods shown in (i) to (iv) below.

First, the method (i) will be described in detail using an example of a scheme shown below:

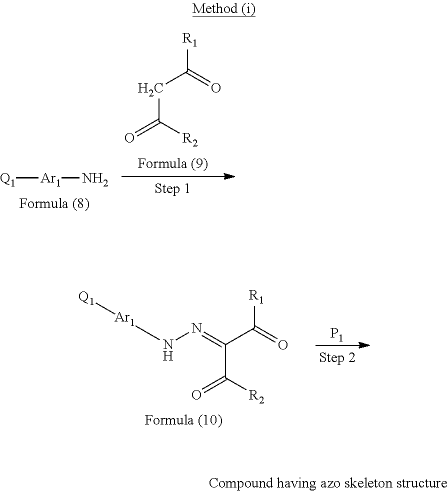

[wherein R₁ and R₂ in the formulas (9) and (10) each are the same as R₁ and R₂ in the above formula (1); Ar₁ in the formulas (8) and (10) represents an arylene group; P₁ is a polymeric portion obtained by polymerizing the monomer unit represented by the above formula (2); Q₁ in the formulas (8) and (10) represents a substituent that reacts with P₁ to form the divalent linking group L].

In the method (i) exemplified above, the compound having an azo skeleton structure can be synthesized by Step 1 of diazo coupling an aniline derivative represented by the formula (8) and Compound (9) to synthesize the azo skeleton structure (10), and Step 2 of linking the azo skeleton structure (10) to the polymeric portion P₁ by a condensation reaction or the like.

First, Step 1 will be described. In Step 1, a known method can be used. Examples of the method include those shown below. First, the aniline derivative (8) is reacted with a diazotizing agent such as sodium nitrite or nitrosylsulfuric acid in a methanol solvent in the presence of an inorganic acid such as hydrochloric acid or sulfuric acid to synthesize a corresponding diazonium salt. Further, the diazonium salt is coupled to Compound (9) to synthesize azo compound (10).

A variety of the aniline derivative (8) is commercially available, and easily available. The aniline derivative (8) can also be easily synthesized by a known method.

The step can be performed without a solvent, but is preferably performed in the presence of a solvent in order to prevent rapid progress of the reaction. The solvent is not particularly limited as long as the solvent does not inhibit the reaction. Examples of the solvent include alcohols such as methanol, ethanol, and propanol; esters such as methyl acetate, ethyl acetate, and propyl acetate; ethers such as diethyl ether, tetrahydrofuran, and dioxane; hydrocarbons such as benzene, toluene, xylene, hexane, and heptane; halogen-containing hydrocarbons such as dichloromethane, dichloroethane, and chloroform; amides such as N,N-dimethylformamide, N-methylpyrrolidone, and N,N-dimethylimidazolidinone; nitriles such as acetonitrile and propionitrile; acids such as formic acid, acetic acid, and propionic acid; and water. These solvents can be used by mixing two or more. The mixing ratio in use by mixing can be arbitrarily determined according to the solubility of a solute. The amount of the solvent to be used can be arbitrarily determined, but is preferably in the range of 1.0 to 20 times by mass the compound represented by the above formula (8) from the viewpoint of the reaction rate.

Step 1 is usually performed at a temperature in the range of −50° C. to 100° C., and completed within usually 24 hours.

Next, a method for synthesizing the polymeric portion P₁ used in Step 2 will be described. In the synthesis of the polymeric portion P₁, a known polymerization method can be used [for example, Krzysztof Matyjaszewski, et. al., “Chemical Reviews,” (US), American Chemical Society, 2001, Vol. 101, pp. 2921-2990].

Examples of the method include a radical polymerization, a cationic polymerization, and an anionic polymerization. From the viewpoint of easy production, the radical polymerization can be used.

The radical polymerization can be performed by use of a radical polymerization initiator, irradiation with radiation, laser light, or the like, use of a photopolymerization initiator in combination with irradiation with light, heating, or the like.

The radical polymerization initiator may be any radical polymerization initiator that can generate radicals to initiate the polymerization reaction. The radical polymerization initiator is selected from compounds that generate radicals by action of heat, light, radiation, an oxidation reduction reaction, and the like. Examples of the compounds include azo compounds, organic peroxides, inorganic peroxides, organic metal compounds, and photopolymerization initiators. Examples of the compounds include azo polymerization initiators such as 2,2′-azobis(isobutyronitrile), 2,2′-azobis(2-methylbutyronitrile), 2,2′-azobis(4-methoxy-2,4-dimethylvaleronitrile), and 2,2′-azobis(2,4-dimethylvaleronitrile); organic peroxide polymerization initiators such as benzoyl peroxide, di-tert-butyl peroxide, tert-butylperoxyisopropyl carbonate, tert-hexyl peroxybenzoate, and tert-butyl peroxybenzoate; inorganic peroxide polymerization initiators such as potassium persulfate and ammonium persulfate; and redox initiators such as hydrogen peroxide-ferrous redox initiators, benzoyl peroxide-dimethylaniline redox initiators, and cerium(IV) salt-alcohol redox initiators. Examples of the photopolymerization initiators include benzophenones, benzoinethers, acetophenones, and thioxanthones. These radical polymerization initiators may be used in combination.

The amount of the polymerization initiator to be used at this time can be adjusted within the range of 0.1 to 20 parts by mass based on 100 parts by mass of the monomer to obtain a copolymer having target molecular weight distribution.

The polymeric portion represented by P₁ above can be produced by any method of solution polymerization, suspension polymerization, emulsion polymerization, dispersion polymerization, precipitation polymerization, bulk polymerization, and the like, and is not particularly limited. The solution polymerization in a solvent that can dissolve components used in production is preferable. For example, alcohols such as methanol, ethanol, and 2-propanol; ketones such as acetone and methyl ethyl ketone; ethers such as tetrahydrofuran and diethyl ether; ethylene glycol monoalkyl ethers or acetates thereof; propylene glycol monoalkyl ethers or acetates thereof; polar organic solvents such as diethylene glycol monoalkyl ethers; and non-polar solvents such as toluene and xylene in some cases can be used singly, or used in mixtures. Among these, more preferably, the solvents having a boiling point in the range of 100 to 180° C. are used singly or in mixtures.

A preferable temperature range of the polymerization temperature varies according to the kind of initiators to be used, and is not particularly limited. Usually, polymerization is performed at a temperature in the range of −30 to 200° C., and more preferably 40 to 180° C.

The molecular weight distribution and molecular structure of the polymeric portion represented by P₁ can be controlled using a known method. For example, a polymeric portion whose molecular weight distribution and molecular structure are controlled can be produced using the following methods such as a method using an addition-fragmentation chain transfer agent (see Japanese Patent Nos. 4254292 and 3721617), an NMP method using dissociation and bonding of amine oxide radicals [for example, Craig J. Hawker, et al., “Chemical Reviews,” (US), American Chemical Society, 2001, Vol. 101, pp. 3661-3688], an ATRP method using a halogen compound as a polymerization initiator and performing polymerization using a heavy metal and a ligand [for example, Masami Kamigaito, et al., “Chemical Reviews,” (US), American Chemical Society, 2001, Vol. 101, pp. 3689-3746], an RAFT method using dithiocarboxylic acid ester or a xanthate compound as a polymerization initiator (for example, National Publication of International Patent Application No. 2000-515181), an MADIX method (for example, WO99/05099), and a DT method [for example, Atsushi Goto, et al., “Journal of The American Chemical Society” (US), American Chemical Society, 2003, Vol. 125, pp. 8720-8721].

Next, Step 2 will be described. In Step 2, a known method can be used. For example, by using the polymeric portion P₁ having a carboxyl group and azo compound (10) having a hydroxyl group, the compound having an azo skeleton structure in which the linking group has the carboxylic acid ester bond can be synthesized. Moreover, by using the polymeric portion P₁ having a hydroxyl group and azo compound (10) having a sulfonic acid group, the compound having an azo skeleton structure in which the linking group has the sulfonic acid ester bond can be synthesized. Further, by using the polymeric portion P₁ having a carboxyl group and azo compound (10) having an amino group, the compound having an azo skeleton structure in which the linking group has the carboxylic acid amide bond can be synthesized. Examples of the method include a method using 1-ethyl-3-(3-dimethylaminopropyl)carbodiimidehydrochloric acid salt or the like (for example, Melvin S. Newman, et al., “The Journal of Organic Chemistry,” (US), American Chemical Society, 1961, Vol. 26, No. 7, pp. 2525-2528), and a Schotten-Baumann method (for example, Norman O. V. Sonntag, “Chemical Reviews,” (US), American Chemical Society, 1953, Vol. 52, No. 2, pp. 237-416).

The step can be performed without a solvent, but is preferably performed in the presence of a solvent in order to prevent rapid progress of the reaction. The solvent is not particularly limited as long as the solvent does not inhibit the reaction. Examples of the solvent include ethers such as diethyl ether, tetrahydrofuran, and dioxane; hydrocarbons such as benzene, toluene, xylene, hexane, and heptane; halogen-containing hydrocarbons such as dichloromethane, dichloroethane, and chloroform; amides such as N,N-dimethylformamide, N,N-dimethylacetamide, N-methylpyrrolidone, and N,N-dimethylimidazolidinone; and nitriles such as acetonitrile and propionitrile. These solvents can be used by mixing two or more according to the solubility of the solute. The mixing ratio in use by mixing can be arbitrarily determined. The amount of the solvent to be used can be arbitrarily determined. From the viewpoint of the reaction rate, the amount can be within the range of 1.0 to 20 times by mass the polymeric portion represented by P₁.

The step is usually performed at a temperature in the range of 0° C. to 250° C., and usually completed within 24 hours.

Next, the method (ii) will be described in detail using an example of a scheme shown below:

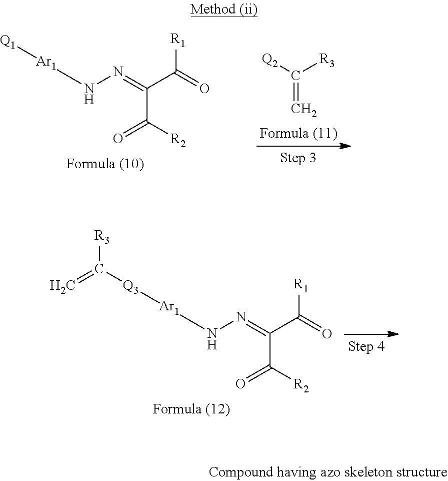

[wherein R₁, R₂, Ar₁, and Q₁ in the formula (10) each are the same as R₁, R₂, Ar₁, and Q₁ in the formula (10) in the scheme of the method (i); Q₂ in the formula (11) represents a substituent that reacts with Q₁ in the formula (10) to form Q₃ in the formula (12); R₃ in the formulas (11) and (12) is the same as R₃ in the above formula (2); Q₃ represents a substituent that forms a divalent linking group formed by reacting Q₁ in the formula (10) with Q₂ in the formula (11)].

In the method (ii) exemplified above, the compound having an azo skeleton structure can be synthesized by Step 3 of reacting the azo compound represented by the formula (10) with the vinyl group-containing compound represented by the formula (11) to synthesize azo compound (12) having a polymerizable functional group, and a Step 4 of copolymerizing azo compound (12) having a polymerizable functional group with a polymerizable monomer that forms the monomer unit represented by the above formula (2).

First, Step 3 will be described. In Step 3, the same method as Step 2 in the method (i) can be used to synthesize the azo skeleton structure (12) having a polymerizable functional group. For example, by using vinyl group-containing compound (11) in which Q₂ is a substituent having a carboxyl group and azo compound (10) in which Q₁ is a substituent having a hydroxyl group, azo compound (12) having a polymerizable functional group in which Q₃ is a substituent having the carboxylic acid ester bond can be synthesized. By using vinyl group-containing compound (11) in which Q₂ is a substituent having a hydroxyl group and azo compound (10) in which Q₁ is a substituent having a sulfonic acid, azo compound (12) having a polymerizable functional group in which Q₃ is a substituent having the sulfonic acid ester bond can be synthesized. Further, by using vinyl group-containing compound (11) in which Q₂ is a substituent having a carboxyl group and azo compound (10) in which Q₁ is a substituent having an amino group, azo compound (12) in which Q₃ is a substituent having the carboxylic acid amide bond can be synthesized.

A variety of vinyl group-containing compounds (11) are commercially available, and easily available. Moreover, vinyl group-containing compound (11) can be easily synthesized by a known method.

Next, Step 4 will be described. In Step 4, the compound having an azo skeleton structure and represented by the above formula (1) can be synthesized by copolymerizing compound (12) having a polymerizable functional group with a polymerizable monomer that forms the monomer unit represented by the above formula (2). As the synthesis method in Step 4, the same method as the method of synthesizing the polymeric portion P₁ in the method (i) can be used.

Next, the method (iii) will be described in detail using an example of a scheme shown below:

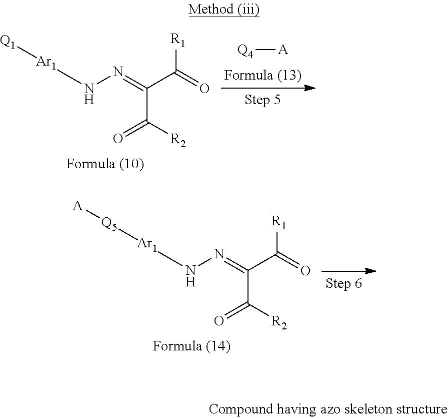

[R₁, R₂, Ar₁, and Q₁ in the formula (10) each are the same as R₁, R₂, Ar₁, and Q₁ in the formula (10) in the scheme of the method (i); Q₄ in the formula (13) represents a substituent that reacts with Q₁ in the formula (10) to form Q₅ in the formula (14); Q₅ represents a substituent that reacts Q₁ in the formula (10) with Q₄ in the formula (13) to form a divalent linking; R₁, R₂, and Ar₁ each are the same as R₁, R₂, and Ar₁ in the above formula (10); A represents a chlorine atom, a bromine atom, or an iodine atom].

In the method (iii) exemplified above, the compound having an azo skeleton structure can be synthesized by Step 5 of reacting the azo compound represented by the formula (10) with the halogen atom-containing compound represented by the formula (13) to synthesize azo compound (14) having a halogen atom, and Step 6 of polymerizing azo compound (14) having a halogen atom as a polymerization initiator with a polymerizable monomer that forms the monomer unit represented by the above formula (2).

First, Step 5 will be described. In Step 5, the same method as that in Step 2 in the method (i) can be used to synthesize azo compound (14) having a halogen atom. For example, azo compound (14) having a halogen atom can be synthesized by using halogen atom-containing compound (13) in which Q₄ is a substituent having a carboxyl group and azo compound (10) in which Q₁ is a substituent having a hydroxyl group. Azo compound (14) having a halogen atom can also be synthesized by using halogen atom-containing compound (13) in which Q₄ is a substituent having a hydroxyl group and azo compound (10) in which Q₁ is a substituent having a sulfonic acid. Further, azo compound (14) having a halogen atom can be synthesized by using halogen atom-containing compound (13) in which Q₄ is a substituent having a carboxyl group and azo compound (10) in which Q₁ is a substituent having an amino group.

Examples of halogen atom-containing compound (13) having a carboxyl group include chloroacetic acid, α-chloropropionic acid, α-chlorobutyric acid, α-chloroisobutyric acid, α-chlorovaleric acid, α-chloroisovaleric acid, α-chlorocaproic acid, α-chlorophenylacetic acid, α-chlorodiphenylacetic acid, α-chloro-α-phenylpropionic acid, α-chloro-β-phenylpropionic acid, bromoacetic acid, α-bromopropionic acid, α-bromobutyric acid, α-bromoisobutyric acid, α-bromovaleric acid, α-bromoisovaleric acid, α-bromocaproic acid, α-bromophenylacetic acid, α-bromodiphenylacetic acid, α-bromo-α-phenylpropionic acid, α-bromo-β-phenylpropionic acid, iodoacetic acid, α-iodopropionic acid, α-iodobutyric acid, α-iodoisobutyric acid, α-iodovaleric acid, α-iodoisovaleric acid, α-iodocaproic acid, α-iodophenylacetic acid, α-iododiphenylacetic acid, α-iodo-α-phenylpropionic acid, α-iodo-β-phenylpropionic acid, β-chlorobutyric acid, β-bromoisobutyric acid, iododimethylmethylbenzoic acid, and 1-chloroethylbenzoic acid. Acid halides thereof and acid anhydrides thereof can also be used in the present invention.

Examples of halogen atom-containing compound (13) having a hydroxyl group include 1-chloroethanol, 1-bromoethanol, 1-iodoethanol, 1-chloropropanol, 2-bromopropanol, 2-chloro-2-propanol, 2-bromo-2-methylpropanol, 2-phenyl-1-bromoethanol, and 2-phenyl-2-iodoethanol.

Next, Step 6 will be described. In Step 6, the compound having an azo skeleton structure can be synthesized using the ATRP method in the method (i) by using azo compound (14) having a halogen atom as the polymerization initiator to polymerize the polymerizable monomer (2), which forms the monomer unit, in the presence of a metal catalyst and a ligand.

The metal catalyst used in the ATRP method is not particularly limited. The metal catalyst is suitably at least one selected from the transition metals in Groups 7 to 11 in the periodic table. In a redox catalyst (redox conjugated complex) that changes a low-valent complex and a high-valent complex reversibly, examples of the low-valent metal specifically used include metals selected from the group consisting of Cu⁺, Ni⁰, Ni⁺, Ni²⁺, Pd⁰, Pd⁺, Pt⁰, Pt⁺, Pt²⁺, Rh⁺, Rh²⁺, Rh³⁺, Co⁺, Co²⁺, Ir⁰, Ir⁺, Ir²⁺, Ir³⁺, Fe²⁺, Ru²⁺, Ru³⁺, Ru⁴⁺, Ru⁵⁺, Os²⁺, Os³⁺, Re²⁺, Re³⁺, Re⁴⁺, Re⁶⁺, Mn²⁺, and Mn³⁺. Among these, Cu⁺, Ru²⁺, Fe²⁺, and Ni²⁺ are preferable, and Cu⁺ is preferable particularly from the viewpoint of availability. As a monovalent copper compound, cuprous chloride, cuprous bromide, cuprous iodide, cuprous cyanide, and the like can be suitably used, for example.

As the ligand used in the ATRP method, usually, an organic ligand is used. Examples of the organic ligand include 2,2′-bipyridyl and derivatives thereof, 1,10-phenanthroline and derivatives thereof, tetramethylethylenediamine, N,N,N′,N″,N″-pentamethyldiethylenetriamine, tris(dimethylaminoethyl)amine, triphenylphosphine, and tributylphosphine. Considering easy production, particularly aliphatic polyamines such as N,N,N′,N″,N″-pentamethyldiethylenetriamine are preferable.

In the case where R₂ in the above formula (1) is the NR₆R₇ group, R₆ is a hydrogen atom, and R₇ is a phenyl group, the compound having an azo skeleton structure can be synthesized by the method (iv) below:

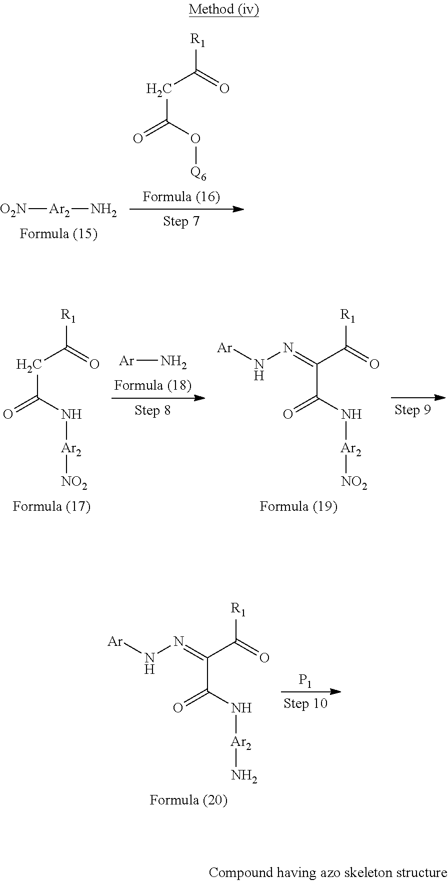

[Ar₂ in the formulas (15), (17), (19) and (20) represents an arylene group; R₁ in the formulas (16), (17), (19) and (20) is the same as that in the above formula (1); Q₆ in the formulas (16) represents a substituent that is eliminated when the substituent reacts with an amino group in the formula (15) to form an amide group in the formula (17); P₁ is the same as that in the scheme in the method (i)].

In the method (iv) exemplified above, the compound having an azo skeleton structure can be synthesized by Step 7 of amidizing the aniline derivative represented by the formula (15) and Compound (16) to obtain Compound (17), Step 8 of coupling Compound (17) with the diazo component of an aniline analog represented by the formula (18) to obtain the azo compound represented by the formula (19), Step 9 of reducing a nitro group in the azo compound represented by the formula (19) to an amino group using a reducing agent to obtain the azo compound represented by the formula (20), and Step 10 of amidizing the amino group in the azo compound represented by the formula (20) and a carboxyl group in the polymeric portion represented by P₁ and separately synthesized to bond the azo compound to the polymeric portion.

First, Step 7 will be described. In Step 7, a known method can be used (for example, “Journal of Organic Chemistry,” 1998, Vol. 63, No. 4, pp. 1058-1063). In the case where R₁ in Compound (17) is a methyl group, synthesis can be performed by a method using diketene instead of Compound (16) (for example, “Journal of Organic Chemistry,” 2007, Vol. 72, No. 25, pp. 9761-9764). A variety of Compounds (16) is commercially available and easily available. Compound (16) can also be synthesized by a known method easily.

The step can be performed without a solvent, but is preferably performed in the presence of a solvent in order to prevent rapid progress of the reaction. The solvent is not particularly limited as long as the solvent does not inhibit the reaction. For example, a solvent having a high boiling point such as toluene and xylene can be used.

Next, Step 8 will be described. In Step 8, azo compound (19) can be synthesized using the same method as that in Step 1 in the method (i).

Next, Step 9 will be described. In Step 9, for example, a reduction reaction of a nitro group may be performed using a method as below. First, azo compound (19) is dissolved in a solvent such as alcohol, a nitro group in azo compound (19) is reduced to an amino group in the presence of a reducing agent under a normal temperature or heating condition to obtain azo compound (20). The reducing agent is not particularly limited. Examples of the reducing agent include sodium sulfide, sodium hydrogen sulfide, sodium hydrosulfide, sodium polysulfide, iron, zinc, tin, SnCl₂, and SnCl₂.2H₂O. The reduction reaction also progresses using a method of contacting hydrogen gas in the presence of a catalyst in which a metal such as nickel, platinum, and palladium is carried on an insoluble carrier such as activated carbon.

Next, Step 10 will be described. In Step 10, using the same method as that in Step 2 in the method (i), the compound having an azo skeleton structure can be synthesized by amidizing an amino group in the azo compound represented by the formula (20) and a carboxyl group in the polymeric portion represented by P₁ to bond the azo compound to the polymeric portion.

The compounds obtained in the respective steps in the synthesis method can be refined using an ordinary method for separating and refining an organic compound. Examples of the separation and refining method include a recrystallization or reprecipitation method using an organic solvent, and column chromatography using silica gel or the like. By using these methods singly or in combinations in two or more to perform refining, a compound with high purity can be obtained.

Next, the binder resin used in the toner according to the present invention will be described.

Examples of the binder resin used in the toner according to the present invention include styrene-methacrylic acid copolymers, styrene-acrylic acid copolymers, polyester resins, epoxy resins, and styrene-butadiene copolymers, which are usually used. In a method for directly obtaining toner particles using a polymerization method, a monomer for forming the toner particles is used. For example, styrene monomers such as styrene, α-methylstyrene, α-ethylstyrene, o-methylstyrene, m-methylstyrene, p-methylstyrene, o-ethylstyrene, m-ethylstyrene, and p-ethylstyrene; methacrylate monomers such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, and methacrylic acid amide; acrylate monomers such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, and acrylic acid amide; and olefin monomers such as butadiene, isoprene, and cyclohexene can be used. These monomers are used singly, or in proper mixtures such that the logical glass transition temperature (Tg) falls within the range of 40 to 75° C. [see “Polymer Handbook,” (US), the 3rd edition, edited by J. Brandrup and E. H. Immergut, John Wiley & Sons, 1989, pp. 209-277]. At a logical glass transition temperature less than 40° C., problems tend to arise in storage stability or durability stability of the toner. Meanwhile, at a logical glass transition temperature more than 75° C., the transparency of the toner is reduced in the case of forming a full color image.

The binder resin used in the toner according to the present invention can control distribution of additives such as a colorant, a charge control agent, and wax inside of the toner if a non-polar resin such as polystyrene is used in combination with a polar resin such as polyester resin and a polycarbonate resin. For example, in the case where the toner particles are directly produced using a suspension polymerization method or the like, the polar resin is added during the polymerization reaction from a dispersing step to a polymerization step. The polar resin is added according to the balance of the polarity of a monomer unit composition, which is turned into the toner particles, and the polarity of an aqueous medium. As a result, the concentration of the resin can be controlled to successively change from the surface to the center of the toner particle, for example, the polar resin forms a thin layer on the surface of the toner particle. At this time, by using a polar resin that interacts with the compound having an azo skeleton structure, a colorant, and a charge control agent, control can be performed such that the colorant exists in the toner particles in a desirable state.

As the colorant usable for the toner according to the present invention, the phthalocyanine pigment represented by the following formula (6) can be suitably used.

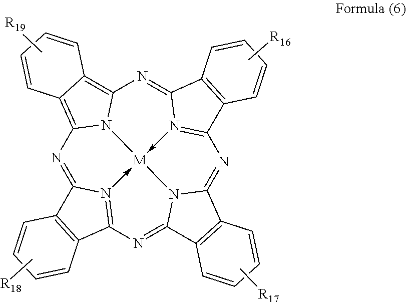

[wherein R₁₆ to R₁₉ each independently represent hydrogen, an alkyl group, a sulfonic acid group, or a sulfonic acid salt group; and M represents a metal atom or a hydrogen atom].

Examples of the phthalocyanine pigment represented by the above formula (6) include C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, C.I. Pigment Blue 16, C.I. Pigment Blue 17, C.I. Pigment Blue 17:1, C.I. Pigment Blue 68, C.I. Pigment Blue 70, C.I. Pigment Blue 75, C.I. Pigment Blue 76, and C.I. Pigment Blue 79. Particularly, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, and C.I. Pigment Blue 15:6 represented by the following formula (21) are more preferable because of the effect such that these phthalocyanine pigments are highly dispersed by the compound having an azo skeleton structure.

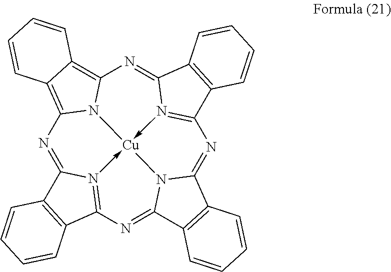

The phthalocyanine pigments may be used singly, or may be used in mixtures of two or more. In the case where two or more of the phthalocyanine pigments are mixed, one or more phthalocyanine pigments may be contained.

These phthalocyanine pigments may be a crude pigment, or a prepared pigment composition as long as the pigments do not significantly inhibit the effect of the compound having an azo skeleton structure.

The mass composition ratio of the phthalocyanine pigment to the compound having an azo skeleton structure in the toner according to the present invention can be within the range of 100:0.1 to 100:100.

As the colorant for the toner according to the present invention, the phthalocyanine pigment is always used. Other colorant can be used in combination for the purpose of adjusting color tone as long as the colorant does not inhibit the dispersibility of the phthalocyanine pigment.

As the colorant usable in combination, known cyan colorants can be used.

Examples of the cyan colorant usable in combination include C.I. Pigment Blue 1, C.I. Pigment Blue 1:2, C.I. Pigment Blue 1:3, C.I. Pigment Blue 2, C.I. Pigment Blue 2:1, C.I. Pigment Blue 2:2, C.I. Pigment Blue 3, C.I. Pigment Blue 4, C.I. Pigment Blue 5, C.I. Pigment Blue 6, C.I. Pigment Blue 7, C.I. Pigment Blue 8, C.I. Pigment Blue 9, C.I. Pigment Blue 9:1, C.I. Pigment Blue 10, C.I. Pigment Blue 10:1, C.I. Pigment Blue 11, C.I. Pigment Blue 12, C.I. Pigment Blue 13, C.I. Pigment Blue 14, C.I. Pigment Blue 18, C.I. Pigment Blue 19, C.I. Pigment Blue 20, C.I. Pigment Blue 21, C.I. Pigment Blue 22, C.I. Pigment Blue 23, C.I. Pigment Blue 24, C.I. Pigment Blue 24:1, C.I. Pigment Blue 25, C.I. Pigment Blue 26, C.I. Pigment Blue 27, C.I. Pigment Blue 28, C.I. Pigment Blue 29, C.I. Pigment Blue 30, C.I. Pigment Blue 31, C.I. Pigment Blue 32, C.I. Pigment Blue 33, C.I. Pigment Blue 34, C.I. Pigment Blue 35, C.I. Pigment Blue 36, C.I. Pigment Blue 36:1, C.I. Pigment Blue 52, C.I. Pigment Blue 53, C.I. Pigment Blue 56, C.I. Pigment Blue 56:1, C.I. Pigment Blue 57, C.I. Pigment Blue 58, C.I. Pigment Blue 59, C.I. Pigment Blue 60, C.I. Pigment Blue 61, C.I. Pigment Blue 61:1, C.I. Pigment Blue 62, C.I. Pigment Blue 63, C.I. Pigment Blue 64, C.I. Pigment Blue 65, C.I. Pigment Blue 66, C.I. Pigment Blue 67, C.I. Pigment Blue 69, C.I. Pigment Blue 71, C.I. Pigment Blue 72, C.I. Pigment Blue 73, C.I. Pigment Blue 74, C.I. Pigment Blue 77, C.I. Pigment Blue 78, C.I. Pigment Blue 80, C.I. Pigment Blue 81, C.I. Pigment Blue 82, C.I. Pigment Blue 83, and C.I. Pigment Blue 84.

Moreover, in order to adjust the color tone, a colorant other than cyan can be used. For example, if C.I. Pigment Green 7 is mixed with C.I. Pigment Blue 15:3 in use, color purity of cyan can be improved.

The amount of these colorants to be used depends on the kind of colorants, but a suitable total amount is 0.1 to 60 parts by mass, and preferably 0.5 to 50 parts by mass based on 100 parts by mass of the binder resin.

Further, in the present invention, in order to enhance the mechanical strength of the toner particles and control the molecular weight of the molecule that forms the particle, a crosslinking agent can also be used in synthesis of the binder resin.

Among the crosslinking agents used for the toner particles according to the present invention, examples of a bifunctional crosslinking agent include divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, polyester-type diacrylate, and dimethacrylates thereof.

Examples of a polyfunctional crosslinking agent include pentaerythritol triacrylate, trimethylolethane triacrylate, trimethylolpropane triacrylate, tetramethylolmethane tetraacrylate, oligoester acrylate and methacrylate thereof, 2,2-bis(4-methacryloxyphenyl)propane, diallyl phthalate, triallyl cyanurate, triallyl isocyanurate, and triallyl trimellitate.

These crosslinking agents may be used in the range of preferably 0.05 to 10 parts by mass, and more preferably 0.1 to 5 parts by mass based on 100 parts by mass of the monomer from the viewpoint of fixing properties and off-set resistance of the toner.

Further, in the present invention, in order to prevent adhesion of the toner to the fixing member, a wax component can also be used in synthesis of the binder resin.

Examples of the wax component usable in the present invention include petroleum waxes such as paraffin waxes, microcrystalline waxes, petrolatum, and derivatives thereof; montan wax and derivatives thereof; hydrocarbon waxes obtained by a Fischer-Tropsch method and derivatives thereof; polyolefin waxes such as polyethylene wax and derivatives thereof; and natural waxes such as carnauba wax and candelilla wax and derivatives thereof. The derivatives also include oxides, block copolymers with a vinyl monomer, and graft modified products. Examples of the wax component also include alcohols such as higher aliphatic alcohol; fatty acids such as stearic acid and palmitic acid; fatty acid amides; fatty acid esters; hard castor oil and derivatives thereof; plant waxes; and animal waxes. These wax components can be used singly or in combinations.

As the amount of the wax component to be added, the total content based on 100 parts by mass of the binder resin is within the range of preferably 2.5 to 15.0 parts by mass, and more preferably 3.0 to 10.0 parts by mass. If the amount of the wax component to be added is less than 2.5 parts by mass, oilless fixing is difficult. If the amount is more than 15.0 parts by mass, the amount of the wax component in the toner particles is excessively large. As a result, an excessively large amount of the wax component exists on the surfaces of the toner particles, and may inhibit desired charging properties. Accordingly, this case is not preferable.

When necessary, a charge control agent can be mixed with the toner according to the present invention. The charge control agent can control the frictional charge amount to be optimal for a developing system.

As the charge control agent, known charge control agents can be used. Particularly, a charge control agent having a high charging speed and being capable of stably keeping a fixed charging amount can be used. Further, in the case where the toner particles are directly produced by the polymerization method, a charge control agent having low polymerization inhibition and having substantially no soluble substance in an aqueous dispersion medium can be particularly used.

Among the charge control agents, examples of those that control to negatively charge the toner include polymers or copolymers having a sulfonic acid group, a sulfonic acid salt group, or a sulfonic acid ester group; salicylic acid derivatives and metal complexes thereof; monoazo metal compounds; acetyl acetone metal compounds; aromatic oxycarboxylic acid, aromatic mono- and polycarboxylic acids and metal salts, anhydrides, esters thereof; phenol derivatives such as bisphenol; urea derivatives; metal-containing naphthoic acid compounds; boron compounds; quaternary ammonium salts; calixarene; and resin charge control agents. Examples of those that control to positively charge the toner include nigrosine and nigrosine modified products with a fatty acid metallic salt and the like; guanidine compounds; imidazole compounds; quaternary ammonium salts such as tributylbenzylammonium-1-hydroxy-4-naphthosulfonic acid salt and tetrabutylammonium tetrafluoroborate, analogs thereof such as onium salts of phosphonium salts, and lake pigments thereof; triphenylmethane dyes and lake pigments thereof (laking agents such as phosphorus tungstate, phosphorus molybdate, phosphorus tungsten molybdate, tannic acid, lauric acid, gallic acid, ferricyanide, and ferrocyanide); metal salts of higher fatty acids; diorganotin oxides such as dibutyltin oxide, dioctyltin oxide, dicyclohexyltin oxide; diorganotin borates such as dibutyltin borate, dioctyltin borate, and dicyclohexyltin borate; and resin charge control agents. These can be used singly or in combinations of two or more.

In the toner according to the present invention, an inorganic fine powder may be added to the toner particles as a fluidizing agent. As the inorganic fine powder, silica, titanium oxide, alumina, or multiple oxides thereof, and fine powders of these surfaces treated.

Examples of a method of producing the toner particles that form the toner according to the present invention include a pulverizing method, a suspension polymerization method, a suspension granulation method, and an emulsion polymerization, which are used conventionally. From the viewpoint of environmental load during production and particle diameter control properties, among these production methods, the method in which the toner particles are produced in an aqueous medium can be used, and particularly the suspension polymerization method or the suspension granulation method can be used.

In the method of producing the toner according to the present invention, the compound having an azo skeleton structure is mixed with the phthalocyanine pigment in advance to prepare a pigment composition. Thereby, the dispersibility of the phthalocyanine pigment can be improved.

The pigment composition can be produced by a wet or dry method. Considering that the compound having an azo skeleton structure has high affinity with the water-insoluble solvent, production of the pigment composition by the wet method that can easily produce a uniform pigment composition can be used. For example, the pigment composition is obtained as follows. The compound having an azo skeleton structure, and when necessary, a resin are dissolved in a dispersion medium. While the dispersion medium is stirred, a pigment powder is gradually added and sufficiently mixed with the dispersion medium. Further, using a dispersing machine such as a kneader, a roll mill, a ball mill, a paint shaker, a dissolver, an Attritor, a sand mill, and a high speed mill, a mechanical shear force is applied to the dispersion medium. Thereby, the phthalocyanine pigment can be finely dispersed in the state of uniform fine particles stably.

The dispersion medium usable for the pigment composition is not particularly limited. In order to obtain a high pigment dispersing effect of the compound having an azo skeleton structure, the case where the dispersion medium is a water-insoluble solvent is preferable. Examples of the water-insoluble solvent include esters such as methyl acetate, ethyl acetate, and propyl acetate; hydrocarbons such as hexane, octane, petroleumether, cyclohexane, benzene, toluene, and xylene; and halogen-containing hydrocarbons such as carbon tetrachloride, trichloroethylene, and tetrabromoethane.

The dispersion medium usable for the pigment composition may be a polymerizable monomer. Examples of the polymerizable monomer can include styrene, α-methylstyrene, α-ethylstyrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, ethylene, propylene, butylene, isobutylene, vinyl chloride, vinylidene chloride, vinyl bromide, vinyl iodide, vinyl acetate, vinyl propionate, vinyl benzoate, methacrylic acid, methyl methacrylate, ethyl methacrylate, propyl methacrylate, butyl methacrylate, n-octyl methacrylate, dodecyl methacrylate, 2-ethylhexyl-methacrylate, stearyl methacrylate, behenyl methacrylate, phenyl methacrylate, dimethylaminoethyl methacrylate, diethylaminoethyl methacrylate, acrylic acid, methyl acrylate, ethyl acrylate, n-butyl acrylate, isobutyl acrylate, propyl acrylate, n-octyl acrylate, dodecyl acrylate, 2-ethylhexyl acrylate, stearyl acrylate, behenyl acrylate, 2-chloroethyl acrylate, phenyl acrylate, vinyl methyl ether, vinyl ethyl ether, vinyl isobutyl ether, vinyl methyl ketone, vinyl hexyl ketone, methyl isopropenyl ketone, vinylnaphthalene, acrylonitrile, methacrylonitrile, and acrylamide.

As the resin usable for the pigment composition, the resins usable as the binder resin for the toner according to the present invention can be used. Examples of the binder resins include styrene-methacrylic acid copolymers, styrene-acrylic acid copolymers, polyester resins, epoxy resins, and styrene-butadiene copolymers. These dispersion media can be used by mixing two or more. Further, the pigment composition can be separated by a known method such as filtration, decantation, or centrifugation. The solvent can be removed by washing.

Further, an aid may be added to the pigment composition during the production. Specific examples of the aid include a surfactant, a dispersant, a filler, a standardizer, a resin, a wax, an antifoaming agent, an antistatic agent, an anti-rust agent, an extender, a shading colorant, a preservant, a dry suppressing agent, a rheology control additive, a wetting agent, an antioxidant, a UV absorber, and a photostabilizer. These aides can be used singly or in combinations of two or more. The compound having an azo skeleton structure may be added in advance in production of a crude pigment.

The toner particles according to the present invention produced by the suspension polymerization method are produced as follows. The pigment composition, the polymerizable monomer, a wax component, a polymerization initiator, and the like are mixed to prepare a polymerizable monomer composition. Next, the polymerizable monomer composition is dispersed in an aqueous medium to granulate the polymerizable monomer composition into particles. Then, the polymerizable monomer in the particles of the polymerizable monomer composition is polymerized in an aqueous medium to obtain toner particles.

The polymerizable monomer composition in the step above can be prepared by dispersing the pigment composition in a first polymerizable monomer to obtain a dispersion, and mixing the dispersion with a second polymerizable monomer. Namely, the pigment composition is sufficiently dispersed in the first polymerizable monomer, and mixed with the second polymerizable monomer together with other toner materials. Thereby, the phthalocyanine pigment can exist in the toner particles in a better dispersion state.

Examples of the polymerization initiator used in the suspension polymerization method can include known polymerization initiators such as azo compounds, organic peroxides, inorganic peroxides, organic metal compounds, and photopolymerization initiators. Examples of the polymerization initiator include azo polymerization initiators such as 2,2′-azobis(isobutyronitrile), 2,2′-azobis(2-methylbutyronitrile), 2,2′-azobis(4-methoxy-2,4-dimethylvaleronitrile), 2,2′-azobis(2,4-dimethylvaleronitrile), and dimethyl-2,2′-azobis(isobutyrate); organic peroxide polymerization initiators such as benzoyl peroxide, di-tert-butyl peroxide, tert-butylperoxyisopropyl monocarbonate, tert-hexyl peroxybenzoate, and tert-butyl peroxybenzoate; inorganic peroxide polymerization initiators such as potassium persulfate and ammonium persulfate; and redox initiators such as hydrogen peroxide-ferrous redox initiators, BPO-dimethylaniline redox initiators, and cerium(IV) salt-alcohol redox initiators. Examples of the photopolymerization initiator include acetophenones, benzoinethers, and ketals. These methods can be used singly or in combinations of two or more.

The concentration of the polymerization initiator is preferably within the range of 0.1 to 20 parts by mass, and more preferably 0.1 to 10 parts by mass based on 100 parts by mass of the polymerizable monomer. The kind of the polymerization initiator slightly varies according to the polymerization method, but the polymerization initiators are used singly or in mixtures with reference to a 10-hour half-life temperature.

The aqueous medium used in the suspension polymerization method can contain a dispersion stabilizer. As the dispersion stabilizer, known inorganic and organic dispersion stabilizers can be used. Examples of the inorganic dispersion stabilizers include calcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and alumina. Examples of the organic dispersion stabilizers include polyvinyl alcohol, gelatin, methyl cellulose, methyl hydroxypropyl cellulose, ethyl cellulose, a sodium salt of carboxymethyl cellulose, and starch. Nonionic, anionic, and cationic surfactants can also be used. Examples of the surfactants include sodium dodecyl sulfate, sodium tetradecyl sulfate, sodium pentadecyl sulfate, sodium octyl sulfate, sodium oleate, sodium laurate, potassium stearate, and calcium oleate.

Among the dispersion stabilizers, poorly water-soluble inorganic dispersion stabilizers soluble in an acid can be used in the present invention. In the present invention, in the case where a poorly water-soluble inorganic dispersion stabilizer is used to prepare an aqueous dispersion medium, these dispersion stabilizers can be used in a proportion ranging from 0.2 to 2.0 parts by mass to 100 parts by mass of the polymerizable monomer from the viewpoint of droplet stability of the polymerizable monomer composition in the aqueous medium. In the present invention, the aqueous medium can be prepared using 300 to 3000 parts by mass of water based on 100 parts by mass of the polymerizable monomer composition.

In the present invention, in the case where the aqueous medium in which the poorly water-soluble inorganic dispersion stabilizer is dispersed is prepared, a commercially available dispersion stabilizer may be used as it is and dispersed. In order to obtain dispersion stabilizer particles having a fine uniform particle size, the poorly water-soluble inorganic dispersion stabilizer can be generated and prepared in water under high speed stirring. For example, in the case where calcium phosphate is used as the dispersion stabilizer, a sodium phosphate aqueous solution is mixed with a calcium chloride aqueous solution under high speed stirring to form fine particles of calcium phosphate. Thereby, a preferable dispersion stabilizer can be obtained.

In the case where the toner particles according to the present invention are produced by the suspension granulation method, suitable toner particles can also be obtained. The production step in the suspension granulation method has no heating step. Accordingly, fusing of the resin with the wax component, which is caused when a low melting point wax is used, can be suppressed to prevent reduction in the glass transition temperature of the toner attributed to the fusing. The suspension granulation method has a wider choice of the toner materials for the binder resin, and has no difficulties to use a polyester resin as the main component. The polyester resin is usually thought to be advantageous in the fixing properties. For this reason, the suspension granulation method is a production method advantageous in production of the toner containing a resin composition to which the suspension polymerization method cannot be applied.

The toner particles produced by the suspension granulation method are produced as follows. First, the pigment composition, the binder resin, the wax component, and the like are mixed in a solvent to prepare a solvent composition. Next, the solvent composition is dispersed in an aqueous medium and the solvent composition is granulated into particles to obtain a toner particle suspension. Then, the solvent is removed by heating the obtained suspension or reducing the pressure. Thereby, toner particles can be obtained.

The solvent composition in the step above can be prepared by dispersing the pigment composition in a first solvent to prepare a dispersion, and mixing the dispersion with a second solvent. Namely, the pigment composition is sufficiently dispersed in the first solvent, and mixed with the second solvent together with other toner materials. Thereby, the phthalocyanine pigment can exist in the toner particles in a better dispersion state.

Examples of the solvent usable in the suspension granulation method include hydrocarbons such as toluene, xylene, and hexane; halogen-containing hydrocarbons such as methylene chloride, chloroform, dichloroethane, trichloroethane, and carbon tetrachloride; alcohols such as methanol, ethanol, butanol, and isopropyl alcohol; polyhydric alcohols such as ethylene glycol, propylene glycol, diethylene glycol, and triethylene glycol; cellosolves such as methyl cellosolve and ethyl cellosolve; ketones such as acetone, methyl ethyl ketone, and methyl isobutyl ketone; ethers such as benzyl alcohol ethyl ether, benzyl alcohol isopropyl ether, and tetrahydrofuran; and esters such as methyl acetate, ethyl acetate, and butyl acetate. There can be used singly or in mixtures of two or more. Among these, a solvent that has a low boiling point and can sufficiently dissolve the binder resin can be used to easily remove the solvent in the toner particle suspension.

The amount of the solvent to be used is preferably within the range of 50 to 5000 parts by mass, and more preferably 120 to 1000 parts by mass based on 100 parts by mass of the binder resin.

The aqueous medium used in the suspension granulation method can contain a dispersion stabilizer. As the dispersion stabilizer, known inorganic and organic dispersion stabilizers can be used. Examples of the inorganic dispersion stabilizers include calcium phosphate, calcium carbonate, aluminum hydroxide, calcium sulfate, and barium carbonate. Examples of the organic dispersion stabilizers include water-soluble polymers such as polyvinyl alcohol, methyl cellulose, hydroxyethyl cellulose, ethyl cellulose, a sodium salt of carboxymethyl cellulose, sodium polyacrylate, and sodium polymethacrylate; and surfactants such as anionic surfactants such as sodium dodecylbenzenesulfonate, sodium octadecylsulfate, sodium oleate, sodium laurate, and potassium stearate; cationic surfactants such as laurylamine acetate, stearylamine acetate, and lauryltrimethylammonium chloride; amphoteric surfactants such as lauryldimethylamine oxide; and nonionic surfactants such as polyoxyethylene alkyl ether, polyoxyethylene alkylphenyl ether, and polyoxyethylene alkylamine.

The amount of the dispersant to be used can be within the range of 0.01 to 20 parts by mass based on 100 parts by mass of the binder resin from the viewpoint of the droplet stability of the solvent composition in the aqueous medium.

In the present invention, a preferable weight average particle diameter of the toner (hereinafter, written as D4) is within the range of 3.00 to 15.0 μm, and more preferably 4.00 to 12.0 μm. At D4 within the range above, a high-definition image is easily obtained while the charging stability is kept.

The ratio (hereinafter, written as D4/D1) of D4 to the number average particle diameter (hereinafter, written as D1) of the toner is preferably 1.35 or less, and more preferably 1.30 or less because while high resolution is kept, fogging can be suppressed and transfer efficiency can be improved.

D4 and D1 in the toner according to the present invention are adjusted by an adjusting method, which varies according to the method of producing the toner particles. For example, in the case of the suspension polymerization method, D4 and D1 can be adjusted by controlling the concentration of the dispersant used in preparation of the aqueous dispersion medium, the reaction stirring rate, the reaction stirring time, or the like.

The toner according to the present invention may be a magnetic toner or a non-magnetic toner. In the case where the toner according to the present invention is used as the magnetic toner, a magnetic material may be mixed with the toner particles that form the toner according to the present invention, and used. Examples of such a magnetic material include iron oxides such as magnetite, maghemite, and ferrite; iron oxides containing other metal oxide; and a metal such as Fe, Co, and Ni, or an alloy or mixture of these metals and a metal such as Al, Co, Cu, Pb, Mg, Ni, Sn, Zn, Sb, Be, Bi, Cd, Ca, Mn, Se, Ti, W, and V. The magnetic material particularly suitable for the purpose of the present invention is fine particles of triiron tetraoxide or γ-diiron trioxide.

From the viewpoint of the developability of the toner, in these magnetic bodies, the average particle diameter can be 0.1 to 2 μm (preferably 0.1 to 0.3 μm); and as the magnetic properties at 795.8 kA/m, the coercivity can be 1.6 to 12 kA/m, the saturation magnetization can be 5 to 200 Am²/kg (preferably 50 to 100 Am²/kg), and the residual magnetization can be 2 to 20 Am²/kg.

As the amount of these magnetic materials to be added, 10 to 200 parts by mass, and preferably 20 to 150 parts by mass of the magnetic body is used based on 100 parts by mass of the binder resin.

### EXAMPLES

Hereinafter, the present invention will be described more in detail using Examples and Comparative Examples, but the present invention will not be limited to Examples below without departing the gist of the present invention. Hereinafter, “parts” and “%” are based on the mass unless otherwise specified.

Measurement methods used in Synthesis Examples are shown below.

(1) Measurement of Molecular Weight

In the present invention, the molecular weight of the polymeric portion and that of the azo compound are calculated in terms of polystyrene according to size exclusion chromatography (SEC). The measurement of the molecular weight according to SEC was performed as shown below.

A sample was added to an eluent shown below such that the concentration of the sample was 1.0% by mass, and left as it was at room temperature for 24 hours. The thus-obtained solution was filtered with a solvent-resistant membrane filter having a pore diameter of 0.2 μm. The obtained solution was used as a sample solution, and measured on the condition below:

apparatus: high-speed GPC apparatus (HLC-8220 GPC) [made by Tosoh Corporation],

column: two columns of TSKgel α-M [made by Tosoh Corporation],

eluent: DMF (containing 20 mM of LiBr),

flow rate: 1.0 ml/min,

oven temperature: 40° C., and

the amount of the sample to be poured: 0.10 ml.

In the calculation of the molecular weight of the sample, a molecular weight calibration curve created using standard polystyrene resins [made by Tosoh Corporation TSK Standard Polystyrenes F-850, F-450, F-288, F-128, F-80, F-40, F-20, F-10, F-4, F-2, F-1, A-5000, A-2500, A-1000, and A-500] was used.

(2) Measurement of Acid Value

In the present invention, the acid value of the polymeric portion and that of the azo compound are determined by the following method.

The basic operation is performed according to JIS K-0070.

1) 0.5 to 2.0 g of a sample is precisely weighed. The mass at this time is defined as W (g).

2) The sample is placed in a 300 ml beaker. 150 ml of a mixed solution of tetrahydrofuran/ethanol (2/1) is added to the sample to dissolve the sample.

3) Using an ethanol solution of 0.1 mol/l KOH, titration is performed with a potentiometric titrator [for example, an auto titration measurement apparatus COM-2500 made by Hiranuma Sangyo Co., Ltd. or the like can be used].

4) The amount of the KOH solution at this time is defined as S (ml). At the same time, a blank is measured, and the amount of the KOH to be used is defined as B (ml).

5) The acid value is calculated by the following expression. f is a factor of the KOH solution.

$$Acid value [ mgKOH \text{/} g ] = \frac{( S - B ) \times f \times 5.61}{M}$$

(3) Composition Analysis

In the present invention, the structure of the polymeric portion and that of the compound having an azo skeleton structure were determined using the apparatus below:

¹H NMR

ECA-400 made by JEOL, Ltd. (solvent used: deuterochloroform), and

¹³C NMR

FT-NMR AVANCE-600 made by Bruker BioSpin Corp. (solvent used: deuterochloroform)

In ¹³C NMR, quantification was performed by an inverse gated decoupling method using chromium(III) acetylacetonate as a relaxing reagent, and composition analysis was performed.

### Example 1

The compound having an azo skeleton structure was obtained by the following method.

<Production Example of Compound (101)>

Compound (101) having an azo skeleton structure was produced according to the following scheme:

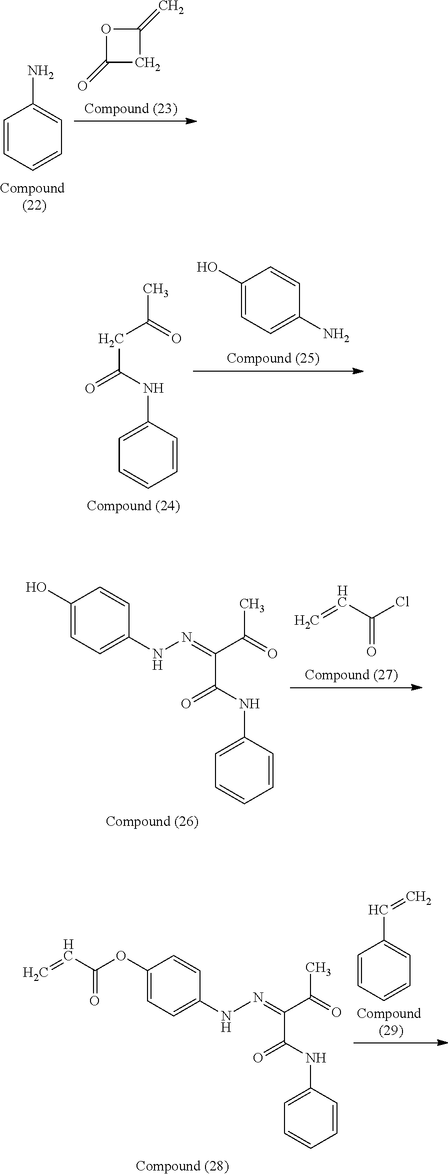

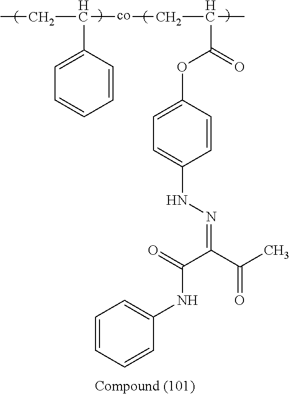

[wherein “co” refers to a symbol indicating that arrangements of monomer units that form the copolymer are in disorder].

First, 3.00 parts of Compound (22) were added to 30 parts of chloroform, and cooled with ice to 10° C. or less. Then, 2.71 parts of Compound (23) were added. Subsequently, the solution was stirred at 65° C. for 2 hours. After the reaction was completed, the reaction product was extracted with chloroform, and condensed to obtain 5.43 parts of Compound (24) (yield of 95.2%).

Next, 30.0 parts of water and 11.0 parts of concentrated hydrochloric acid were added to 5.00 parts of Compound (25), and the solution was cooled with ice to 10° C. or less. 3.46 parts of sodium nitrite added to 8.10 parts of water were dissolved in the solution, and the reaction was made at the same temperature for 1 hour. Next, 0.657 parts of sulfamic acid were added to the solution, and the solution was further stirred for 20 minutes (diazonium salt solution). Subsequently, 8.13 parts of Compound (24) were added to 48.0 parts of water. The obtained solution was cooled with ice to 10° C. or less, and the diazonium salt solution was added. Then, 14.3 parts of sodium carbonate dissolved in 80.0 parts of water were added, and the reaction was made at 10° C. or less for 2 hours. After the reaction was completed, 50 parts of water were added and stirring was performed for 30 minutes. Then, a solid was filtered, and refined by the recrystallization method using N,N-dimethylformamide to obtain 13.2 parts of Compound (26) (yield of 98.9%).

Next, 3.00 parts of Compound (26) and 1.20 parts of triethylamine were added to 30.0 parts of chloroform, and the solution was cooled with ice to 10° C. or less. 1.03 parts of Compound (27) were added to the solution, and the reaction was made at the same temperature for 20 minutes. The reaction product was extracted with chloroform, condensed, and refined to obtain 3.40 parts of Compound (28) (yield of 98.8%)

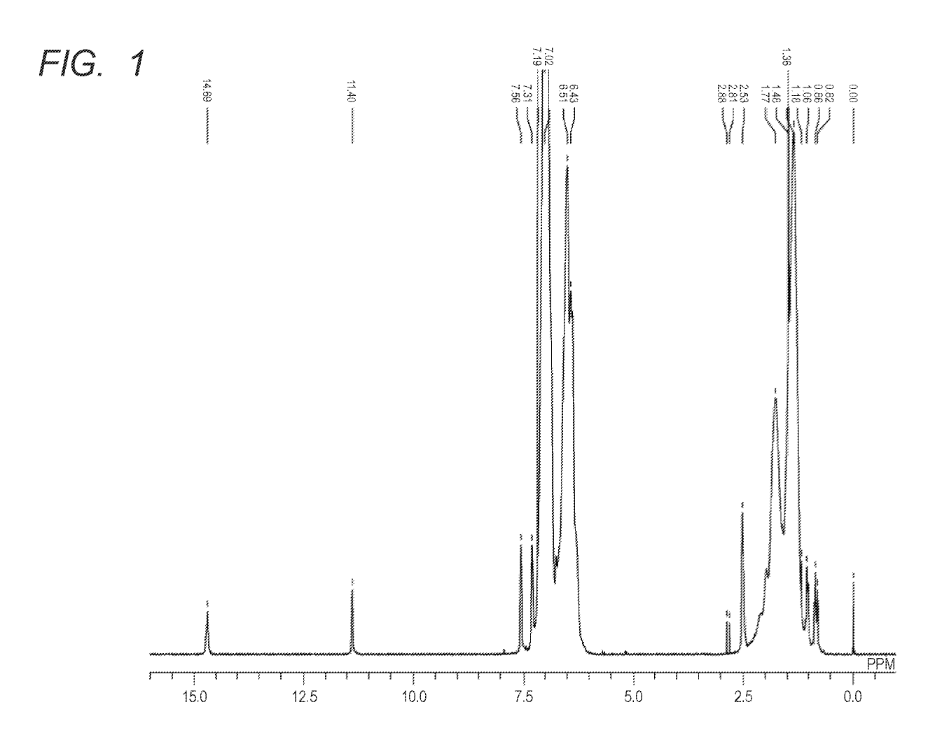

Next, 9.44 parts of N,N-dimethylformamide, 1.06 parts of Compound (28), and 0.327 parts of azobisisobutyronitrile were added to 10 parts of Compound (29), and the solution was stirred under a nitrogen atmosphere at 80° C. for 2 hours. After the reaction was completed, the reaction product was refined by the recrystallization method using N,N-dimethylformamide to obtain 7.60 parts of Compound (101) having an azo skeleton structure (yield of 69.0%).

[Results of Analysis of Compound (101) Having Azo Skeleton Structure]

[1] Result of measurement of molecular weight (GPC): weight average molecular weight (Mw)=16762, number average molecular weight (Mn)=10221

[2] Result of measurement of acid value: 0.0 mgKOH/g

[3] Result of ¹H NMR (400 MHz, CDCl₃, room temperature) (see FIG. 1): δ [ppm]=14.69 (s, 1H), 11.40 (s, 1H), 7.56 (s, 2H), 7.31 (s, 2H), 7.19-6.43 (m, 135H), 2.53 (s, 3H), 2.47-1.05 (m, 97H)

<Production Example of Compound (110)>

Compound (110) having an azo skeleton structure was produced according to the following scheme:

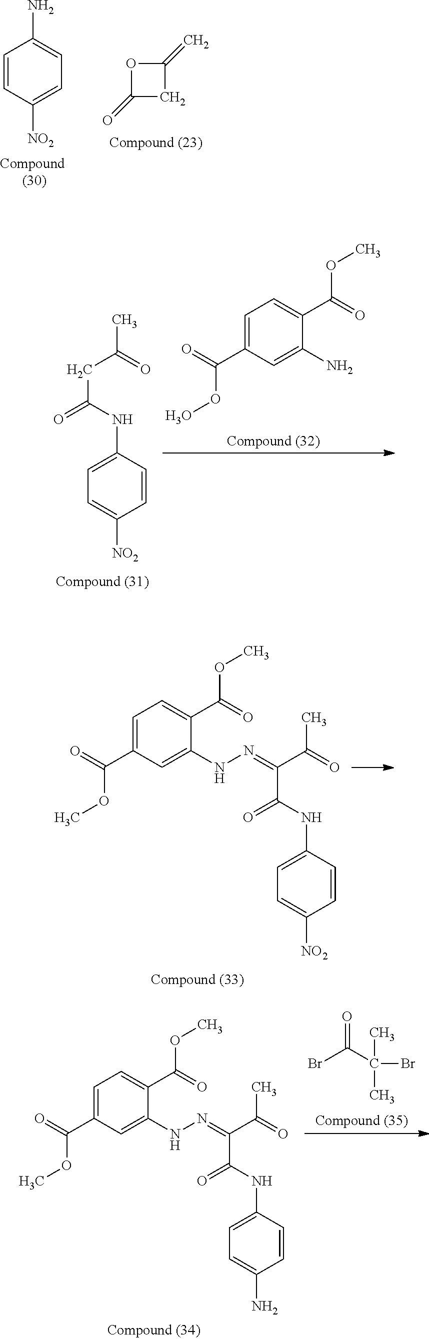

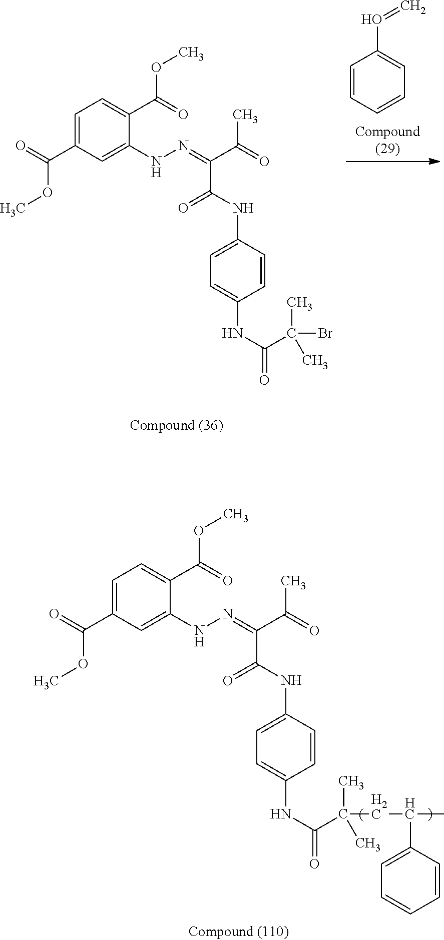

First, 3.11 parts of Compound (30) were added to 30 parts of chloroform. The solution was cooled with ice to 10° C. or less, and 1.89 parts of Compound (23) were added. Then, the solution was stirred at 65° C. for 2 hours. After the reaction was completed, the reaction product was extracted with chloroform, and condensed to obtain 4.80 parts of Compound (31) (yield of 96.0%).

Next, 40.0 parts of methanol and 5.29 parts of concentrated hydrochloric acid were added to 4.25 parts of Compound (32), and the solution was cooled with ice to 10° C. or less. 2.10 parts of sodium nitrite dissolved in 6.00 parts of water were added to the solution, and the reaction was made at the same temperature for 1 hour. Next, 0.990 parts of sulfamic acid were further added, stirring was performed for 20 minutes (diazonium salt solution). Subsequently, 4.51 parts of Compound (31) were added to 70.0 parts of methanol, and the obtained solution was cooled with ice to 10° C. or less. Then, the diazonium salt solution was added. Then, 5.83 parts of sodium acetate dissolved in 7.00 parts of water were added, and the reaction was made at 10° C. or less for 2 hours. After the reaction was completed, 300 parts of water were added, and stirring was performed for 30 minutes. Then, a solid was filtered, and refined by the recrystallization method using N,N-dimethylformamide to obtain 8.65 parts of Compound (33) (yield of 96.1%).

Next, 8.58 parts of Compound (33) and 0.4 parts of palladium-activated carbon (5% of palladium) were added to 150 parts of N,N-dimethylformamide, and the solution was stirred under a hydrogen gas atmosphere (reaction pressure of 0.1 to 0.4 MPa) at 40° C. for 3 hours. After the reaction was completed, the solution was filtered, and condensed to obtain 7.00 parts of Compound (34) (yield of 87.5%).

Next, 5.00 parts of Compound (34) and 1.48 parts of triethylamine were added to 25.0 parts of chloroform. The solution was cooled with ice to 10° C. or less, and 2.07 parts of Compound (35) were added. Then, stirring was performed at room temperature for 6 hours. After the reaction was completed, the reaction product was extracted with chloroform, and condensed to obtain 5.35 parts of Compound (36) (yield of 97.3%).

Next, 2.50 parts of Compound (36), 140 parts of Styrene (29), 1.77 parts of N,N,N′,N″,N″-pentamethyldiethylenetriamine, and 0.64 parts of copper(I) bromide were added to 50.0 parts of N,N-dimethylformamide. Then, the solution was stirred under a nitrogen atmosphere at 120° C. for 45 minutes. After the reaction was completed, the reaction product was extracted with chloroform, and refined by reprecipitation using methanol to obtain 86.2 parts of Compound (110) having an azo skeleton structure (yield of 60.5%).

Using the apparatus above, it was found that the obtained compound has the structure represented by the above formula. The results of analysis are shown below.

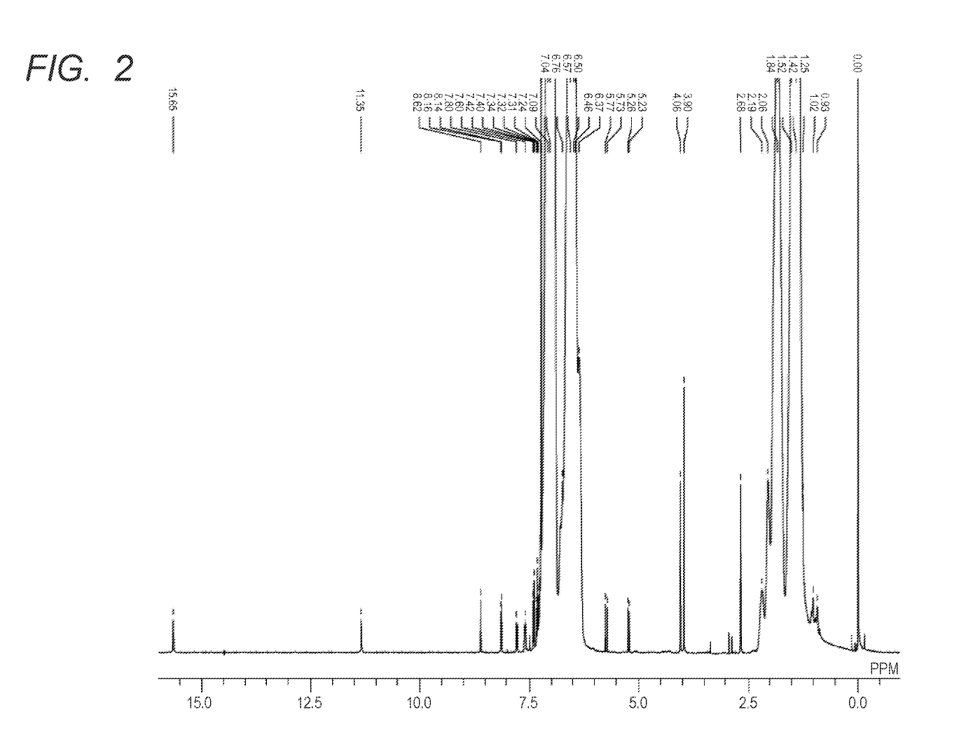

][Results of Analysis of Compound (110) Having Azo Skeleton Structure]

[1] Result of measurement of molecular weight (GPC): weight average molecular weight (Mw)=36377, number average molecular weight (Mn)=21338

[2] Result of measurement of acid value: 0.0 mgKOH/g

[3] Result of ¹H NMR (400 MHz, CDCl₃, room temperature) (see FIG. 2): δ [ppm]=15.65 (s, 1H), 11.35 (s, 1H), 8.62 (s, 1H), 7.37-6.27 (m, 1294H), 4.06 (s, 3H), 3.98 (4.06 (s, 3H), 2.47-1.05 (m, 786H)

<Production Example of Compound (118)>

Compound (118) having an azo skeleton structure having the following structure was produced according to the scheme:

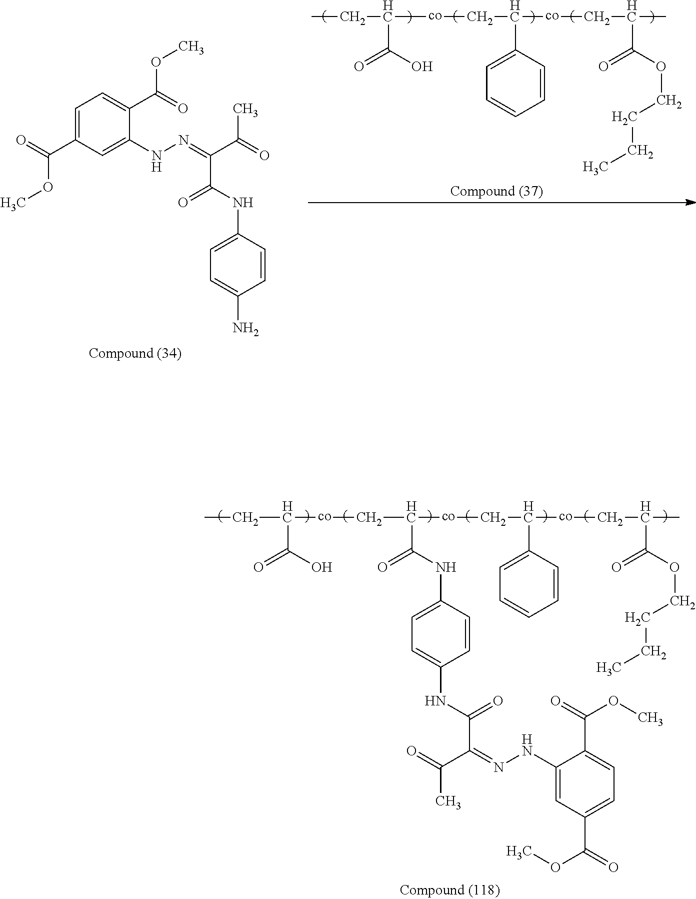

First, while an atmosphere was replaced by nitrogen, 100 parts of propylene glycol monomethyl ether were heated, and refluxed at a temperature of the solution of 120° C. or more. A mixture of 152 parts of styrene, 38 parts of butyl acrylate, 10 parts of acrylic acid, and 1.0 part of tert-butyl peroxybenzoate [organic peroxide polymerization initiator, made by NOF CORPORATION, trade name: PERBUTYL Z] was dropped over 3 hours to the solution. After dropping of the mixture was completed, the solution was stirred for 3 hours. Then, while the temperature of the solution was raised to 170° C., the solution was distilled under normal pressure. After the temperature of the solution reached 170° C., the solution was distilled at 1 hPa under reduced pressure for 1 hour to remove the solvent to obtain a resin solid product. The solid product was dissolved in tetrahydrofuran, and reprecipitated with n-hexane. The precipitated solid was filtered to obtain Compound (37).

Next, 2.0 parts of Compound (34) were added to 500 parts of tetrahydrofuran. The solution was heated to 80° C. to dissolve Compound (34). After Compound (34) was dissolved, the temperature was reduced to 50° C. 15 parts of Compound (37) were added and dissolved. Further, 2.0 parts of 1-ethyl-3-(3-dimethylaminopropyl)carbodiimide.hydrochloric acid salt (EDC.HCl) were added, and the solution was stirred at 50° C. for 5 hours. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 14.8 parts of Compound (118) having an azo skeleton structure were obtained.

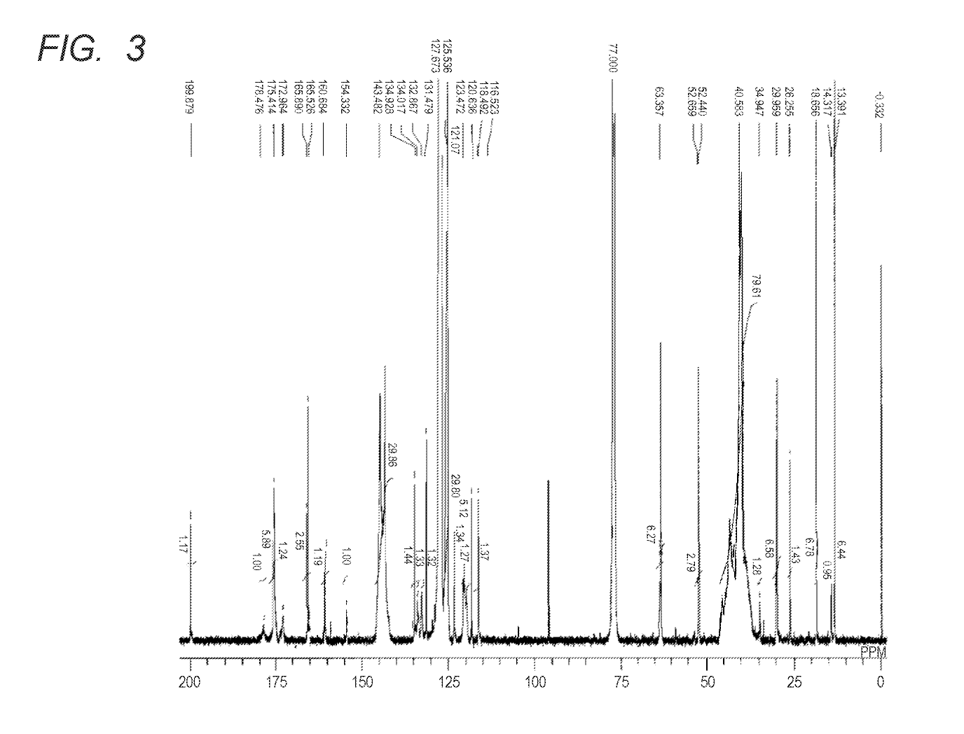

Using the apparatus above, it was found that the obtained compound has the structure represented by the above formula. The results of analysis are shown below.

[Results of Analysis of Compound (118) Having Azo Skeleton Structure]

[1] Result of measurement of molecular weight (GPC): number average molecular weight (Mn)=21998

[2] Result of measurement of acid value: 7.3 mgKOH/g

[3] Result of ¹³C NMR (600 MHz, CDCl₃, room temperature) (see FIG. 3): δ [ppm]=199.88 (6C), 178.45, 175.41 (30C), 172.96 (6C), 165.89, 165.52, 160.68, 154.34, 143.48 (143C), 134.93, 134.02, 132.87, 131.48, 127.67, 125.54, 123.47, 120.85-120.63, 118.49, 116.52, 63.36, 52.66, 52.44, 40.58, 29.96, 26.26, 18.66, 13.39

<Production Example of Compound (119)>

Compound (119) having an azo skeleton structure was produced according to the following scheme:

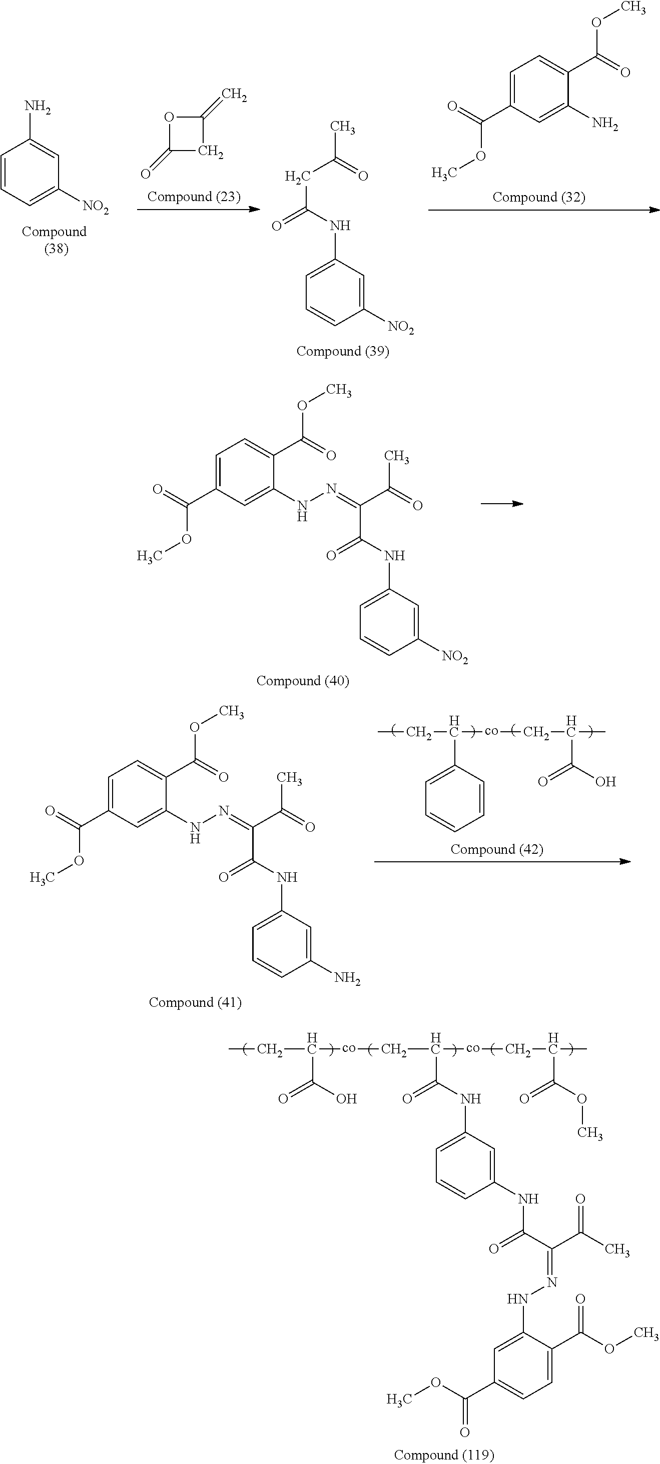

First, 3.00 parts of Compound (38) were added to 30 parts of chloroform. The solution was cooled with ice to 10° C. or less, and 1.83 parts of Compound (23) were added. Then, the solution was stirred at 65° C. for 2 hours. After the reaction was completed, the reaction product was extracted with chloroform, and condensed to obtain 4.70 parts of Compound (39) (yield of 97.4%).

Next, 40.0 parts of methanol and 6.00 parts of concentrated hydrochloric acid were added to 3.77 parts of Compound (38). The solution was cooled with ice to 10° C. or less. 1.37 parts of sodium nitrite dissolved in 5.50 parts of water were added to the solution, and the reaction was made at the same temperature for 1 hour (diazonium salt solution). 4.00 parts of Compound (39) were added to 70.0 parts of methanol, and the solution was cooled with ice to 10° C. or less. The diazonium salt solution was added. Then, 8.86 parts of sodium acetate dissolved in 35.0 parts of water were added, and the reaction was made at 10° C. or less for 2 hours. After the reaction was completed, 300 parts of water were added, stirring was performed for 30 minutes. Then, a solid was filtered, and refined by the recrystallization method using N,N-dimethylformamide to obtain 7.62 parts of Compound (40) (yield of 95.7%).

Next, 7.00 parts of Compound (40) and 0.35 parts of palladium-activated carbon (5% of palladium) were added to 150 parts of N,N-dimethylformamide, and the solution was stirred under a hydrogen gas atmosphere (reaction pressure of 0.1 to 0.4 MPa) at 40° C. for 3 hours. After the reaction was completed, the solution was filtered, and condensed to obtain 5.84 parts of Compound (41) (yield of 89.5%).

Next, while an atmosphere was replaced by nitrogen, 100 parts of propylene glycol monomethyl ether were heated, and refluxed at a temperature of the solution of 120° C. or more. A mixture of 120 parts of styrene, 10 parts of acrylic acid, and 1.0 part of tert-butyl peroxybenzoate [organic peroxide polymerization initiator, made by NOF CORPORATION, trade name: PERBUTYL Z] was dropped over 3 hours to the solution. After dropping of the mixture was completed, the solution was stirred for 3 hours. Then, while the temperature of the solution was raised to 170° C., the solution was distilled under normal pressure. After the temperature of the solution reached 170° C., the solution was distilled at 1 hPa under reduced pressure for 1 hour to remove the solvent to obtain a resin solid product. The solid product was dissolved in tetrahydrofuran, and reprecipitated with n-hexane. The precipitated solid was filtered to obtain Compound (42).

Next, 1.5 parts of Compound (41) were added to 500 parts of tetrahydrofuran. The solution was heated to 65° C. to dissolve Compound (41). After Compound (41) was dissolved, the temperature was reduced to 50° C. 15 parts of Compound (42) were added and dissolved. 2.0 parts of 1-ethyl-3-(3-dimethylaminopropyl)carbodiimide.hydrochloric acid salt (EDC.HCl) were added, and the solution was stirred at 50° C. for 5 hours. Then, 20 parts of methanol were added, and the solution was stirred at 65° C. for 1 hour. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 15.8 parts of Compound (119) having an azo skeleton structure was obtained.

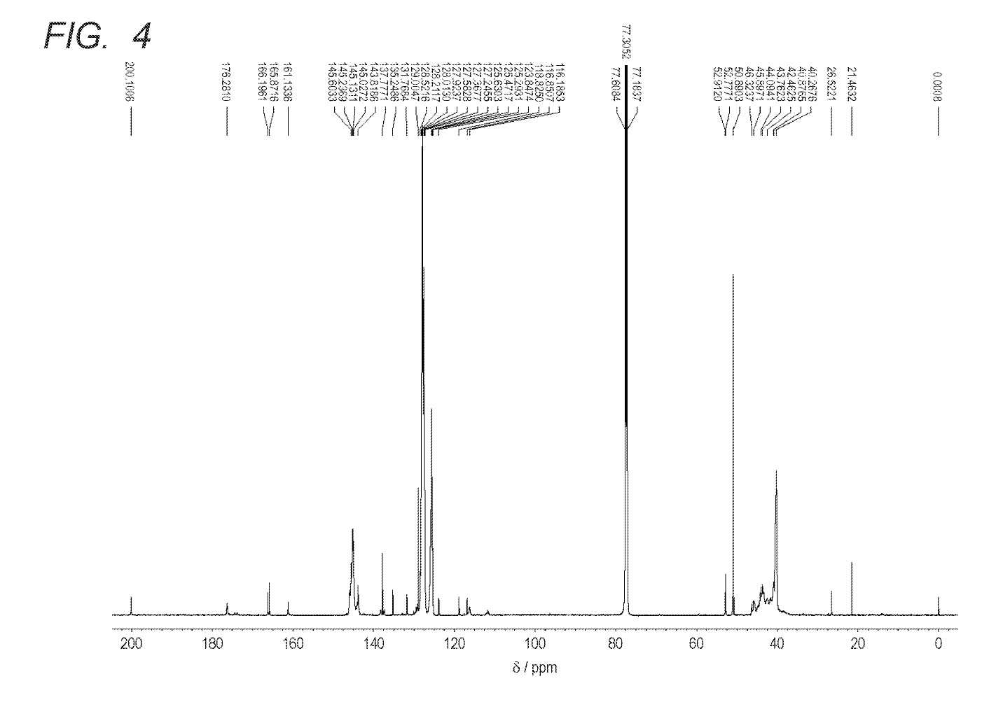

Using the apparatus above, it was found that the obtained compound has the structure represented by the above formula. The results of analysis are shown below.

[Results of Analysis of Compound (119) Having Azo Skeleton Structure]

[1] Result of measurement of molecular weight (GPC): number average molecular weight (Mn)=13557

[2] Result of measurement of acid value: 0.0 mgKOH/g

[3] Result of ¹³C NMR (600 MHz, CDCl₃, room temperature) (see FIG. 4): δ [ppm]=200.00 (3C), 175.68 (5C), 173.84 (3C), 166.14, 165.77, 161.10, 145.21-143.82 (113C), 138.15, 137.25, 135.24, 131.74, 127.99, 127.56, 125.61, 123.80, 118.78, 116.83, 116.08, 111.90, 59.70, 52.91, 52.73, 46.50-37.00, 26.52, 18.49, 14.02

<Production Example of Compound (150)>

Compound (150) having an azo skeleton structure was produced according to the following scheme:

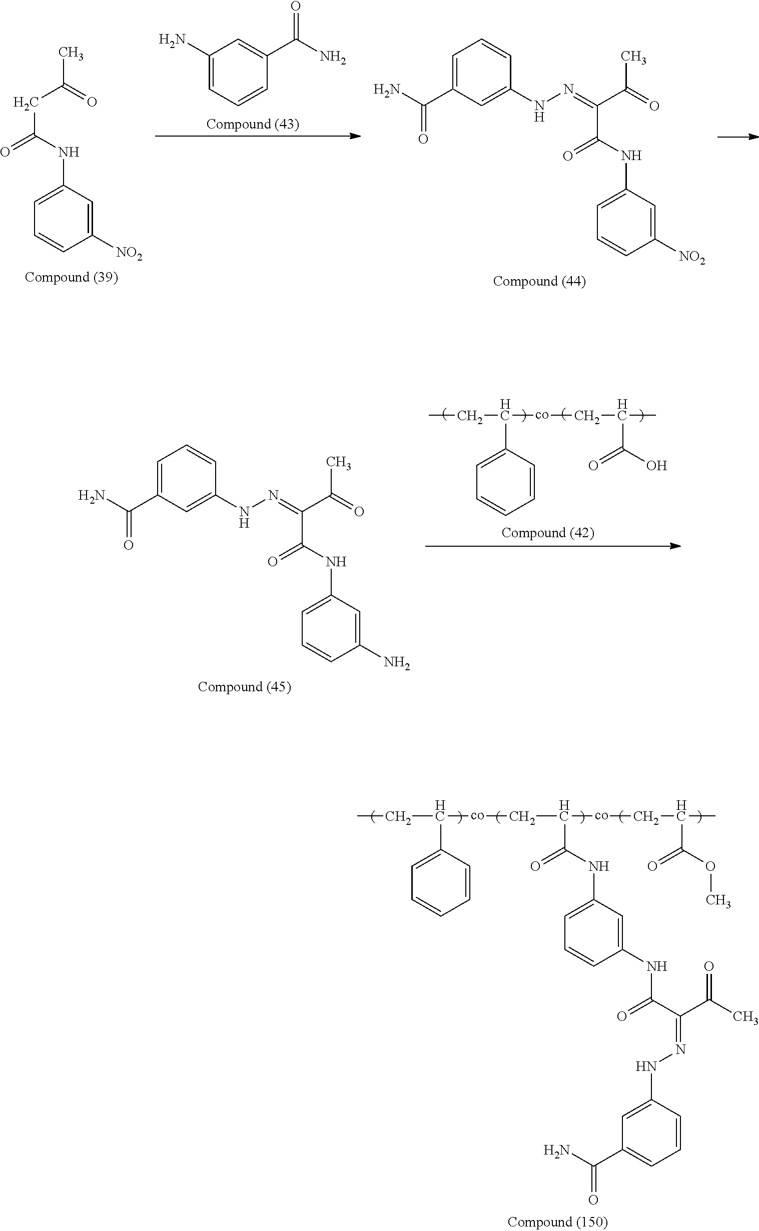

First, 25.0 parts of methanol and 6.00 parts of concentrated hydrochloric acid were added to 2.45 parts of Compound (43), and the solution was cooled with ice to 10° C. or less. 1.37 parts of sodium nitrite dissolved in 5.50 parts of water were added to the solution, and the reaction was made at the same temperature for 1 hour (diazonium salt solution). Subsequently, 4.00 parts of Compound (39) were added to 40.0 parts of methanol, and the solution was cooled with ice to 10° C. or less. Then, the diazonium salt solution was added. Then, 8.86 parts of sodium acetate dissolved in 35.0 parts of water were added, and the reaction was made at 10° C. or less for 2 hours. After the reaction was completed, 300 parts of water were added, and stirring was performed for 30 minutes. Then, a solid was filtered, and refined by the recrystallization method using N,N-dimethylformamide to obtain 6.37 parts of Compound (44) (yield of 95.8%).

Next, 6.00 parts of Compound (44) and 0.3 parts of palladium-activated carbon (5% of palladium) were added to 150 parts of N,N-dimethylformamide, and the solution was stirred under a hydrogen gas atmosphere (reaction pressure of 0.1 to 0.4 MPa) at 40° C. for 3 hours. After the reaction was completed, the solution was filtered, and condensed to obtain 4.84 parts of Compound (45) (yield of 87.9%).

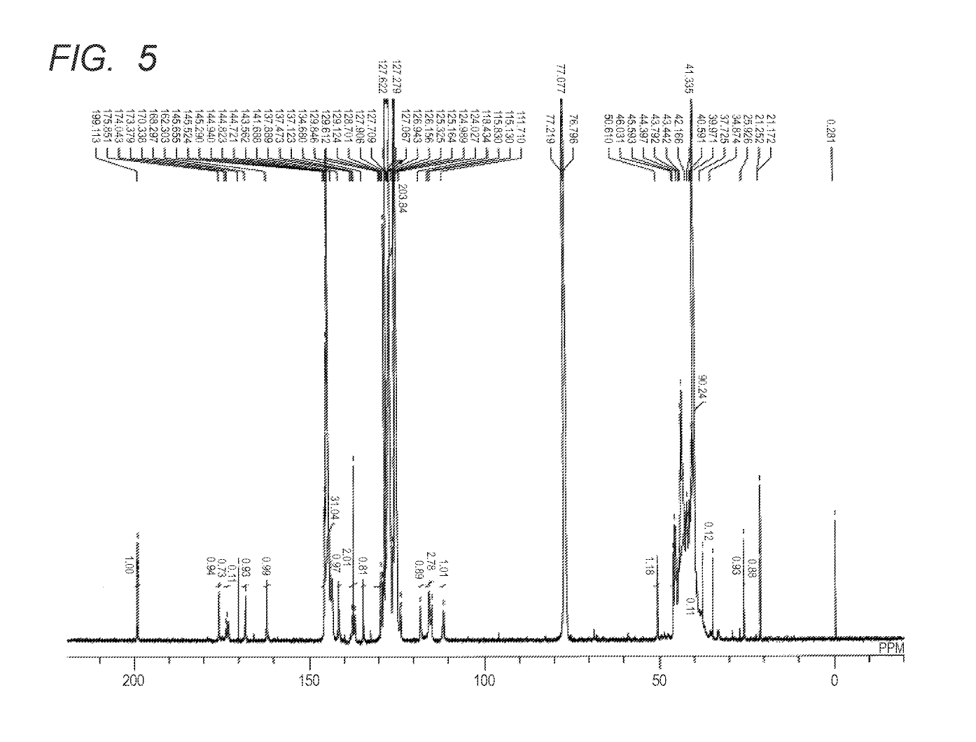

Next, 1.6 parts of Compound (45) was added to 500 parts of tetrahydrofuran. The solution was heated to 65° C. to dissolve Compound (45). After Compound (45) was dissolved, the temperature was reduced to 50° C. 15 parts of Compound (42) were added and dissolved. 2.0 parts of 1-ethyl-3-(3-dimethylaminopropyl)carbodiimide.hydrochloric acid salt (EDC.HCl) were added, and the solution was stirred at 50° C. for 5 hours. Then, 20 parts of methanol were added, and the solution was stirred at 65° C. for 1 hour. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 15.3 parts of Compound (150) having an azo skeleton structure were obtained.

[Results of Analysis of Compound (150) Having Azo Skeleton Structure]

[1] Result of measurement of molecular weight (GPC): number average molecular weight (Mn)=15374

[2] Result of measurement of acid value: 0.0 mgKOH/g

[3] Result of ¹³C NMR (600 MHz, CDCl₃, room temperature) (see FIG. 5): δ [ppm]=199.6 (4C), 176.3 (5C), 174.2 (4C), 168.8, 162.7, 144.0-146 (130C). 1, 142.0, 137.1-137.5, 134.6, 124.0-129.8, 118.0, 115.1-115.8, 111.7, 36.0-46.0, 25.9

<Production Example of Compound (107)>

Compound (107) having an azo skeleton structure was produced according to the following scheme:

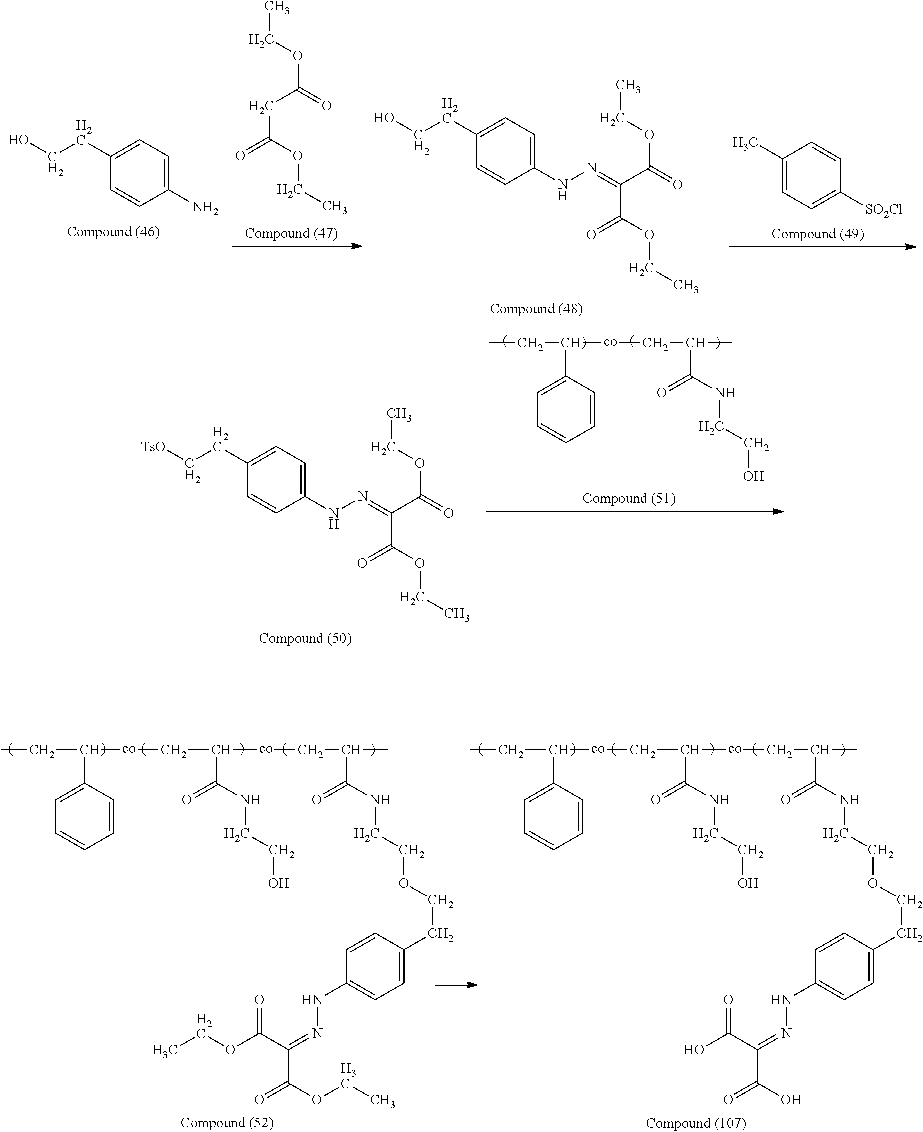

First, 100 parts of water and 15.1 parts of concentrated hydrochloric acid were added to 10.0 parts of Compound (46), and the solution was cooled with ice to 10° C. or less. 5.1 parts of sodium nitrite dissolved in 15.0 parts of water were added to the solution, and the reaction was made at the same temperature for 1 hour (diazonium salt solution). 10.9 parts of Compound (47) were added to 150.0 parts of methanol, and the solution was cooled with ice to 10° C. or less. Then, the diazonium salt solution was added. Then, 7.1 parts of sodium acetate dissolved in 50.0 parts of water were added, and the reaction was made at 10° C. or less for 2 hours. After the reaction was completed, the precipitated solid was filtered to obtain a solid. The solid was dispersed and washed with water, and filtered to obtain 15.6 parts of Dye Compound (48) (yield of 70.8%).

Next, 4.2 parts of Compound (48) were added to 50 parts of pyridine, and dissolved. Under cooling with ice, 2.6 parts of Compound (49) were added, and dissolved. The solution was stirred for 10 hours under cooling with ice. After the reaction was completed, the reaction product was extracted with chloroform. The reaction product was washed with 100 parts of 2 M hydrochloric acid twice, and with 150 parts of water, and condensed to obtain a crude refined product. The crude refined product was extracted with chloroform, and refined by reprecipitation with heptane. Thus, 4.5 parts of Compound (50) were obtained (yield of 71.5%).

Next, while an atmosphere was replaced by nitrogen, 100 parts of propylene glycol monomethyl ether were heated, and refluxed at a temperature of the solution of 120° C. or more. A mixture of 61.7 parts of styrene, 3.6 parts of N-(2-hydroxyethyl)acrylamide, and 1.0 part of tert-butyl peroxybenzoate [organic peroxide polymerization initiator, made by NOF CORPORATION, trade name: PERBUTYL Z] was dropped over 3 hours to the solution. After dropping of the mixture was completed, the solution was stirred for 3 hours. Then, while the temperature of the solution was raised to 170° C., the solution was distilled under normal pressure. After the temperature of the solution reached 170° C., the solution was distilled at 1 hPa under reduced pressure for 1 hour to remove the solvent to obtain a resin solid product. The solid product was dissolved in tetrahydrofuran, and reprecipitated with n-hexane. The precipitated solid was filtered to obtain Compound (51).

Next, 63.0 parts of Compound (51) were dissolved in 100 parts of N,N-dimethylformamide. Under cooling with ice, 0.2 parts of sodium hydride were added, and the solution was stirred for 1 hour. Then, 1.0 part of Compound (50) was added, and dissolved. Under a nitrogen atmosphere, the solution was stirred at a temperature of the solution of 90° C. for 27 hours. Then, the reaction solution was reprecipitated with methanol and refined to obtain 8.1 parts of Compound (52).

Next, 6.6 parts of Compound (52) was dissolved in 400 parts of tetrahydrofuran. 5.1 parts of a 6 M sodium hydroxide aqueous solution were added to dissolve Compound (52). Then, the solution was stirred at room temperature for 12 hours. The pH of the reaction solution was adjusted to 1 or less with concentrated hydrochloric acid. Then, the solvent was distilled to obtain a residue. The residue was extracted with chloroform, and refined by reprecipitation with methanol to obtain 5.0 parts of Compound (107) having an azo skeleton structure.

[Results of Analysis of Compound (107) Having Azo Skeleton Structure]

[1] Result of measurement of molecular weight (GPC): number average molecular weight (Mn)=13835

[2] Result of ¹³C NMR (600 MHz, CDCl₃, room temperature): δ [ppm]=178.00 (5C), 173.00 (3C), 167.76, 165.97, 144.93, −139.91 (118C), 135.00-123.00, 115.56, 72.13, 68.80, 61.79, 47.00-33.00

<Production Example of Compound (108)>

Compound (108) having an azo skeleton structure was produced according to the following scheme:

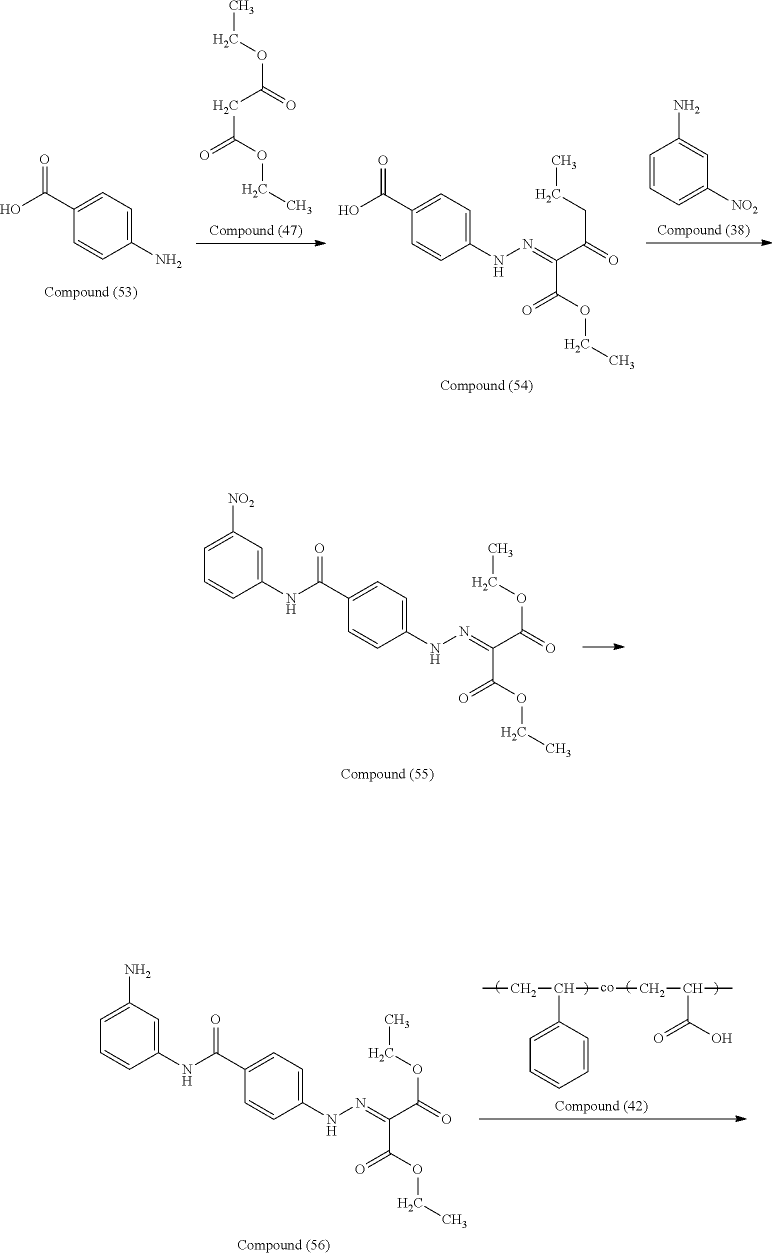

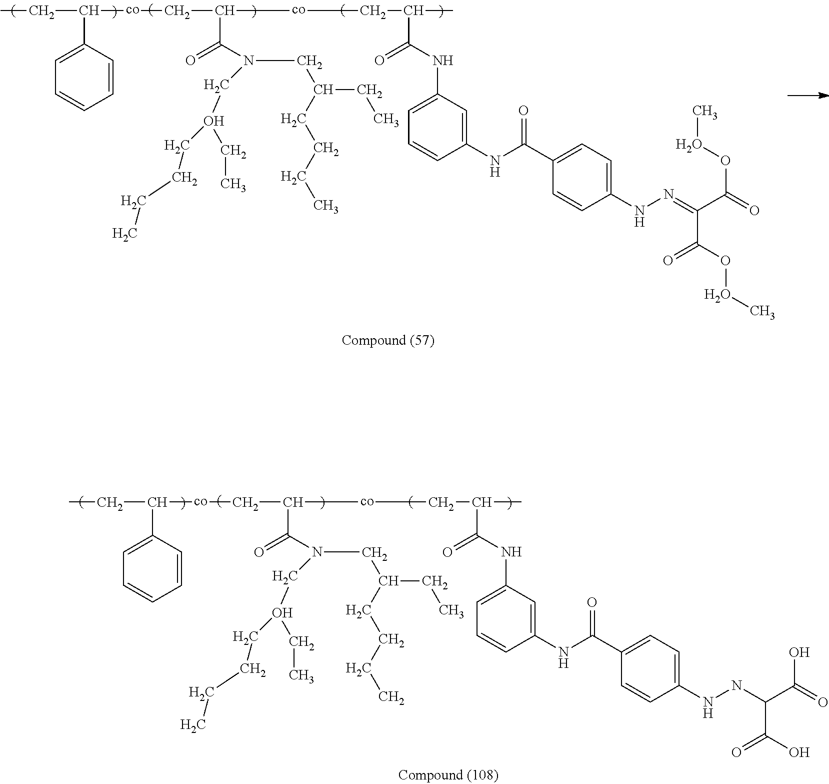

First, 40.0 parts of methanol and 9.72 parts of concentrated hydrochloric acid were added to 4.00 parts of Compound (53), and the solution was cooled with ice to 10° C. or less. 2.21 parts of sodium nitrites dissolved in 9.00 parts of water were added to the solution, and the reaction was made at the same temperature for 1 hour (diazonium salt solution). Subsequently, 4.67 parts of Compound (47) were added to 50.0 parts of methanol, and the solution was cooled with ice to 10° C. or less. Then, the diazonium salt solution was added. Then, 14.4 parts of sodium acetate dissolved in 60.0 parts of water were added, and the reaction was made at 10° C. or less for 2 hours. After the reaction was completed, 300 parts of water were added, stirring was performed for 30 minutes. Then, a solid was filtered, and refined by the recrystallization method using N,N-dimethylformamide to obtain 8.46 parts of Compound (54) (yield of 94.1%).

8.00 parts of Compound (54) were added to 80.0 parts of tetrahydrofuran. The solution was heated to 65° C. to dissolve Compound (54). After Compound (54) was dissolved, the temperature was reduced to 50° C. 3.58 parts of Compound (38) were added, and dissolved. 7.46 parts of 1-ethyl-3-(3-dimethylaminopropyl)carbodiimide.hydrochloric acid salt (EDC.HCl) were added, and the solution was stirred at 50° C. for 5 hours. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 10.0 parts of Compound (55) were obtained (yield of 90.1%)

Next, 9.50 parts of Compound (55) and 0.45 parts of palladium-activated carbon (5% of palladium) were added to 150 parts of N,N-dimethylformamide, and the solution was stirred under a hydrogen gas atmosphere (reaction pressure of 0.1 to 0.4 MPa) at 40° C. for 3 hours. After the reaction was completed, the solution was filtered, and condensed to obtain 7.73 parts of Compound (56) (yield of 87.5%).

7.6 parts of Compound (56) were added to 1500 parts of tetrahydrofuran. The solution was heated to 65° C. to dissolve Compound (56). After Compound (56) was dissolved, the temperature was reduced to 50° C. 60.5 parts of Compound (42) were added, and dissolved. 24.2 parts of 1-ethyl-3-(3-dimethylaminopropyl)carbodiimide.hydrochloric acid salt (EDC.HCl) were added, and the solution was stirred at 50° C. for 5 hours. Then, 300 parts of di(2-ethylhexyl)amine were added, and the solution was stirred at 65° C. for 1 hour. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 63.1 parts of Compound (57) having an azo skeleton structure were obtained.

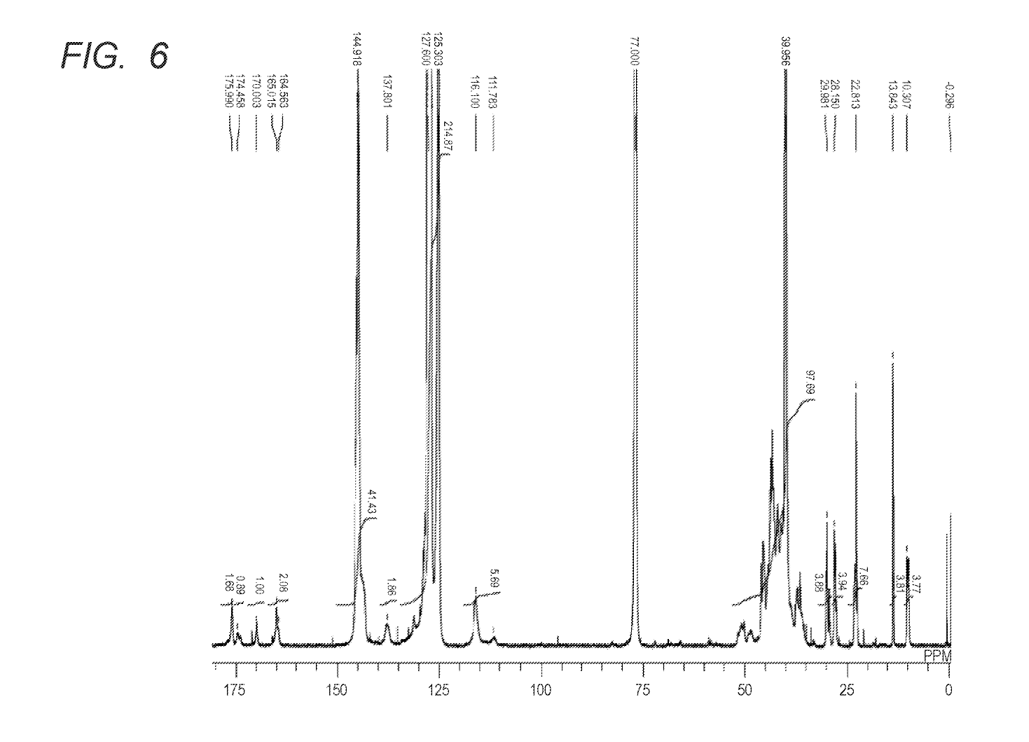

Next, 63.0 parts of Compound (57) were dissolved in 3000 parts of tetrahydrofuran. 300 parts of a 6 M sodium hydroxide aqueous solution were added to dissolve Compound (57). The solution was stirred at room temperature for 12 hours. The pH of the reaction solution was adjusted to 1 or less with concentrated hydrochloric acid. Then, the solvent was distilled to obtain a residue. The residue was extracted with chloroform, and refined by reprecipitation with methanol to obtain 54.1 parts of Compound (108) having an azo skeleton structure.

[Results of Analysis of Compound (108) Having Azo Skeleton Structure]

[1] Result of measurement of molecular weight (GPC): number average molecular weight (Mn)=15205

[2] Result of ¹³C NMR (600 MHz, CDCl₃, room temperature) (see FIG. 6): δ [ppm]=175.99 (6C), 174.46 (3C), 170.00, 167.00-163.00, 152.00-140.00 (120C), 137.80, 135.00-123.00, 120.00-113.00, 53.00-32.00), 31.00-28.00, 28.00-26.00, 24.00-22.00, 13.84, 11.00-9.00

<Production Example of Compound (109)>

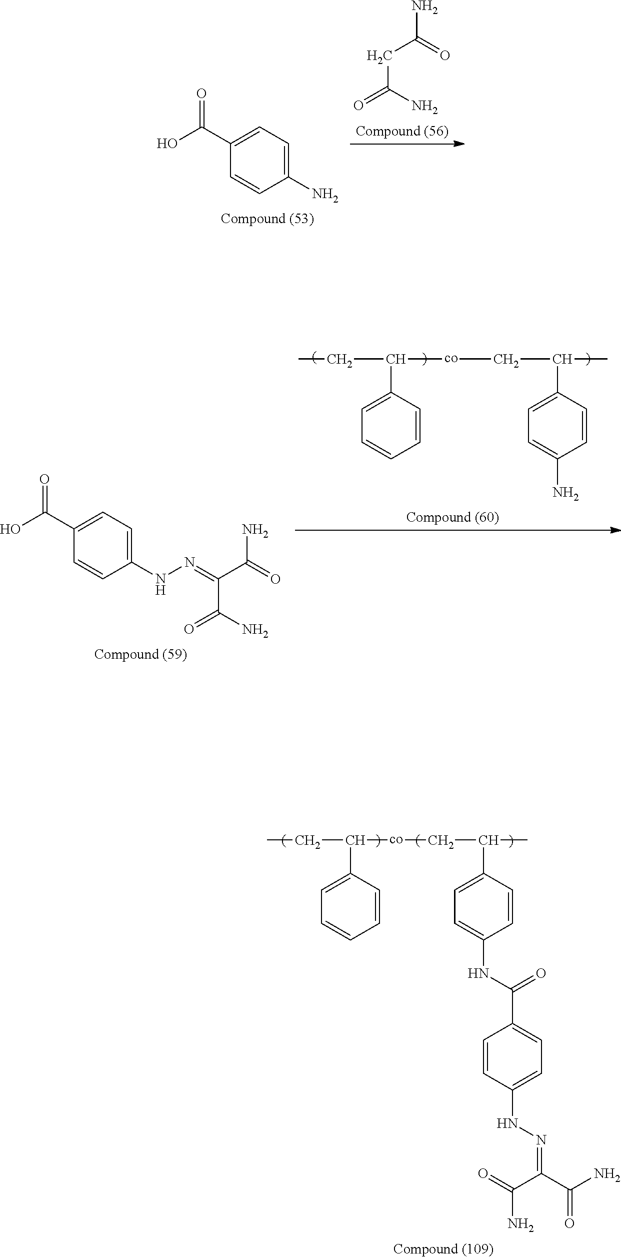

First, 50.0 parts of methanol and 12.2 parts of concentrated hydrochloric acid were added to 5.00 parts of Compound (53), and the solution was cooled with ice to 10° C. or less. 2.77 parts of sodium nitrite dissolved in 11.0 parts of water were added to the solution, and the reaction was made at the same temperature for 1 hour (diazonium salt solution). Subsequently, 3.72 parts of Compound (58) were added to 40.0 parts of methanol, and the solution was cooled with ice to 10° C. or less. Then, the diazonium salt solution was added. Then, 17.9 parts of sodium acetate dissolved in 70.0 parts of water were added, and the reaction was made at 10° C. or less for 2 hours. After the reaction was completed, 300 parts of water were added, stirring was performed for 30 minutes. Then, a solid was filtered, and refined by the recrystallization method using N,N-dimethylformamide to obtain 7.43 parts of Compound (59) (yield of 81.4%).

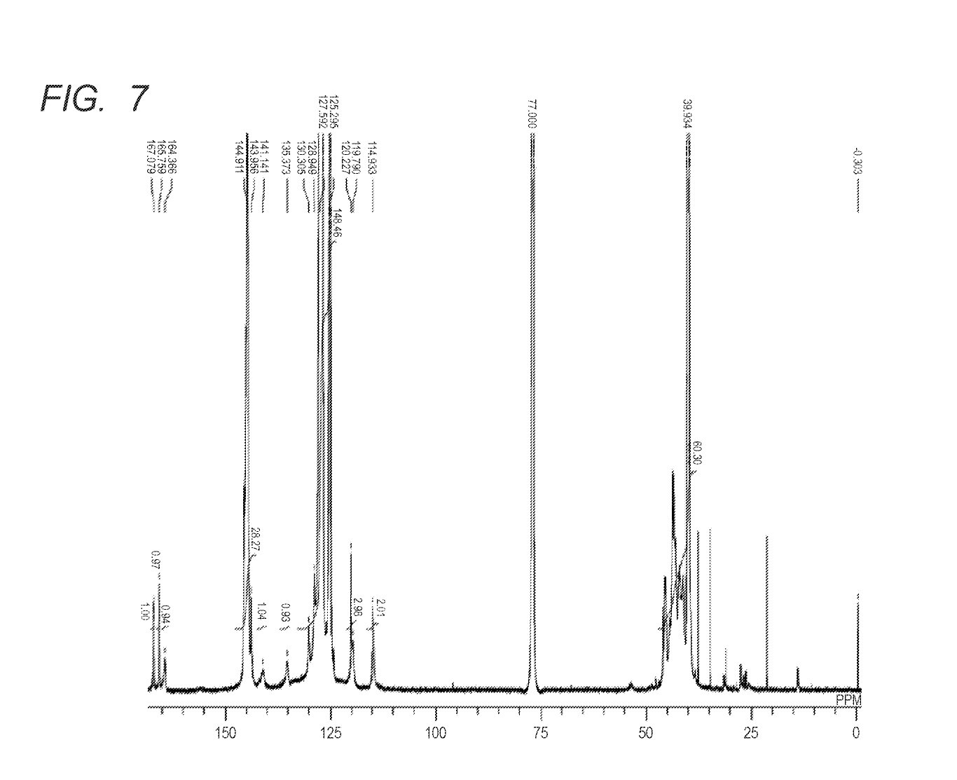

1.9 parts of Compound (59) and 10.0 parts of Compound (60) were added to 100 parts of N,N-dimethylacetamide to dissolve the compounds. 3.0 parts of 1-ethyl-3-(3-dimethylaminopropyl)carbodiimide.hydrochloric acid salt (EDC.HCl) were added, and the solution was stirred at room temperature for 12 days. The reaction solution was reprecipitated with 1000 parts of methanol and refined. Thus, 9.2 parts of Compound (109) having an azo skeleton structure were obtained.

[Results of Analysis of Compound (109) Having Azo Skeleton Structure]

[1] Result of measurement of molecular weight (GPC): number average molecular weight (Mn)=23171

[2] Result of measurement of acid value: 0.0 mgKOH/g

[3] Result of ¹³C NMR (600 MHz, CDCl₃, room temperature) (see FIG. 7): δ [ppm]=167.08 (9C), 165.76, 164.37, 150.00-143.00 (245C), 141.14, 135.37, 135.00-122.00, 122.00-117.00, 114.93, 51.00-38.00

<Production Example of Compound (152)>

Compound (152) having an azo skeleton structure was produced according to the following scheme:

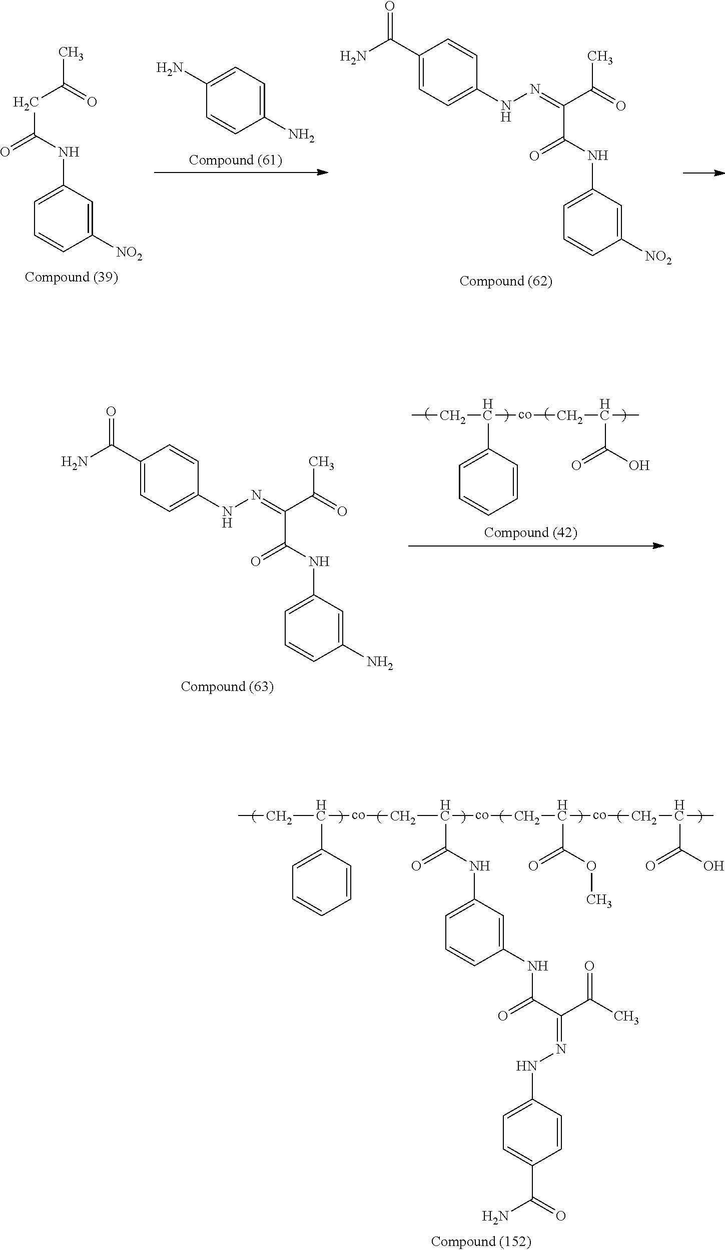

100.0 parts of DMF and 21.4 parts of concentrated hydrochloric acid were added to 10.0 parts of Compound (61), and the solution was cooled with ice to 5° C. or less. 5.28 parts of sodium nitrite dissolved in 20.0 parts of water were added to the solution, and the reaction was made at the same temperature for 30 minutes. Next, 1.00 part of sulfamic acid was added, and stirring was further performed for 30 minutes (diazonium salt solution). 15.5 parts of Compound (39) and 47.6 parts of potassium carbonate were added to 150.0 parts of DMF, and the solution was cooled with ice to 5° C. or less. The diazonium salt solution was added, and the reaction was made at the same temperature for 2 hours. After the reaction was completed, the reaction solution was discharged into 50 parts of water. Then, concentrated hydrochloric acid was added to adjust the pH to 1, and stirring was performed for 30 minutes. The precipitated solid was filtered, and washed with 150 parts of water. Then, the solid was dispersed and washed with 150 parts of methanol to obtain 22.4 parts of Compound (62) (yield of 88.3%).

Next, 20.0 parts of Compound (62) were added to 300 parts of N,N-dimethylformamide, and the solution was heated to 70° C. to dissolve Compound (62). The solution was cooled to room temperature. 2.28 parts of palladium-activated carbon (5% of palladium) were added, and the solution was stirred under a hydrogen gas atmosphere (reaction pressure of 0.1 to 0.4 MPa) at room temperature for 6 hours. After the reaction was completed, the solution was filtered, and the solvent was distilled under reduced pressure. Then, the reaction product was dispersed and washed with methanol to obtain 16.3 parts of Compound (63) (yield of 94.6%).

Next, 25.0 parts of Compound (42) were added to 250 parts of toluene, and dissolved. The reaction solution was cooled to 5° C. or less. 11.6 parts of oxalyl chloride were gradually dropped. While the temperature of the solution was gradually reduced to room temperature, the solution was stirred for 15 hours. After the solvent was distilled under reduced pressure, the reaction product was redissolved in 163 parts of N,N-dimethylacetamide. 3.00 parts of Compound (63) were added, the solution was stirred at 65° C. for 3 hours. 27.8 parts of methanol were added to the reaction solution, and the reaction solution was stirred at 65° C. for another 3 hours. Then, the temperature of the solution was gradually reduced to room temperature, and the solution was stirred overnight. Thus, the reaction was completed. After the reaction was completed, the reaction solution was discharged into methanol/water. The precipitated precipitation was filtered, and refined by washing with methanol to obtain 26.6 parts of Compound (152) having an azo skeleton structure.

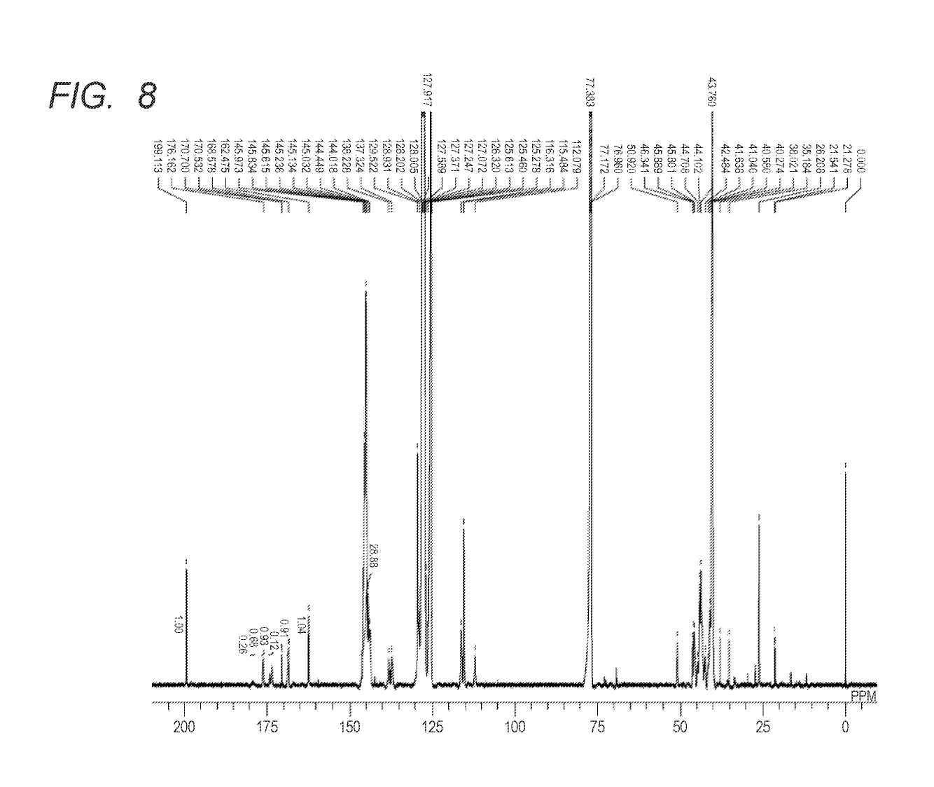

Using the apparatus above, it was found that the obtained compound has the structure represented by the above formula. The results of analysis are shown below.

[Results of Analysis of Compound (152) Having Azo Skeleton Structure]

[1] Result of GPC: number average molecular weight (Mn)=9,757

[2] Result of measurement of acid value: 4.1 mgKOH/g

[3] Result of ¹³C NMR (600 MHz, CDCl₃, room temperature) (see FIG. 8): δ [ppm]=199.5 (3C), 179.4 (1C), 176.2 (2C), 174.3-173.6 (3C), 170.1, 170.5, 168.6 (3C), 162.5 (3C), 146.0-144.0 (97C), 138.2, 137.3, 129.5, 128.2-127.1, 125.6-125.3, 116.3, 115.5, 112.1, 50.9, 46.3, 45.9, 44.1-43.8, 42.5, 41.0, 40.3, 38.0, 35.2, 26.2, 21.5, 21.3, 16.6, 11.9

<Production Example of Compound (155)>

Compound (155) having an azo skeleton structure was produced according to the following scheme:

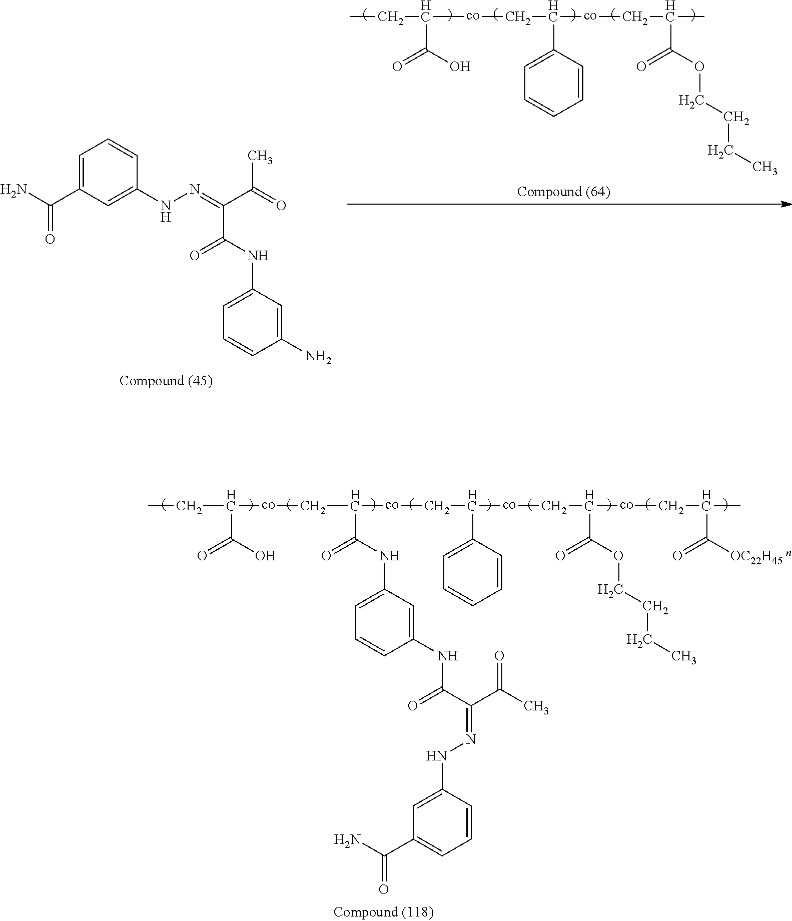

First, while an atmosphere was replaced by nitrogen, 100 parts of propylene glycol monomethyl ether were heated, and refluxed at a temperature of the solution of 120° C. or more. A mixture of 6.0 parts of styrene, 3.0 parts of butyl acrylate, 1.0 part of acrylic acid, and 1.0 part of tert-butyl peroxybenzoate [organic peroxide polymerization initiator, made by NOF CORPORATION, trade name: PERBUTYL Z] was dropped over 3 hours to the solution. After dropping of the mixture was completed, the solution was stirred for 3 hours. Then, while the temperature of the solution was raised to 170° C., the solution was distilled under normal pressure. After the temperature of the solution reached 170° C., the solution was distilled at 1 hPa under reduced pressure for 1 hour to remove the solvent to obtain a resin solid product. The solid product was dissolved in tetrahydrofuran, and reprecipitated with n-hexane. The precipitated solid was filtered to obtain Compound (64).

Next, 2.0 parts of Compound (45) were added to 500 parts of tetrahydrofuran. The solution was heated to 80° C. to dissolve Compound (45). After Compound (45) was dissolved, the temperature was reduced to 50° C. 15 parts of Compound (64) were added, and dissolved. 2.0 parts of 1-ethyl-3-(3-dimethylaminopropyl)carbodiimide.hydrochloric acid salt (EDC.HCl) were added, and the solution was stirred at 50° C. for 5 hours. Then, 2.0 parts of docosanol were added, and the solution was stirred at 65° C. for 1 hour. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 12.8 parts of Compound (155) having an azo skeleton structure were obtained.

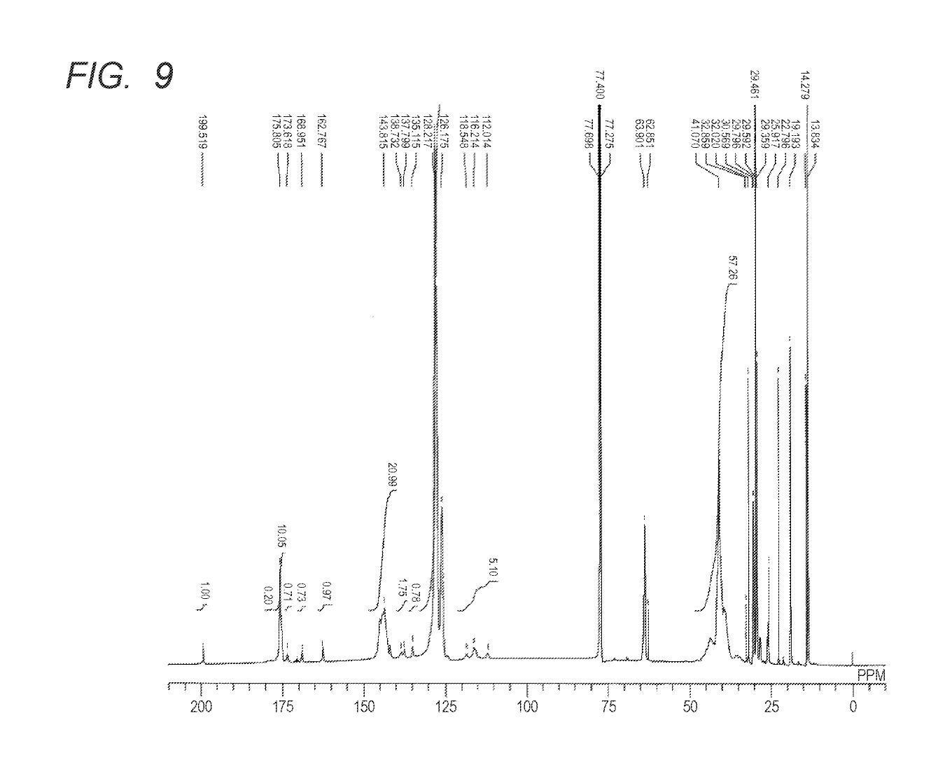

Using the apparatus above, it was found that the obtained compound has the structure represented by the above formula. The results of analysis are shown below.

[Results of Analysis of Compound (155) Having Azo Skeleton Structure]

[1] Result of measurement of molecular weight (GPC): number average molecular weight (Mn)=16293

[2] Result of measurement of acid value: 4.2 mgKOH/g

[3] Result of ¹³C NMR (600 MHz, CDCl₃, room temperature) (see FIG. 9): δ [ppm]=199.52 (3C), 175.81 (36C), 173.62 (3C), 168.95, 162.77, 145.21, 143.82 (64C), 138.73, 137.80, 135.12, 128.22, 126.18, 118.55, 116.21, 112.02, 63.9, 46.50-37.00, 32.86, 32.02, 30.60, 29.80, 29.48, 25.92, 22.80, 19.19, 14.28, 13.83

<Production Example of Compound (157)>

Compound (157) having an azo skeleton structure was produced according to the following scheme:

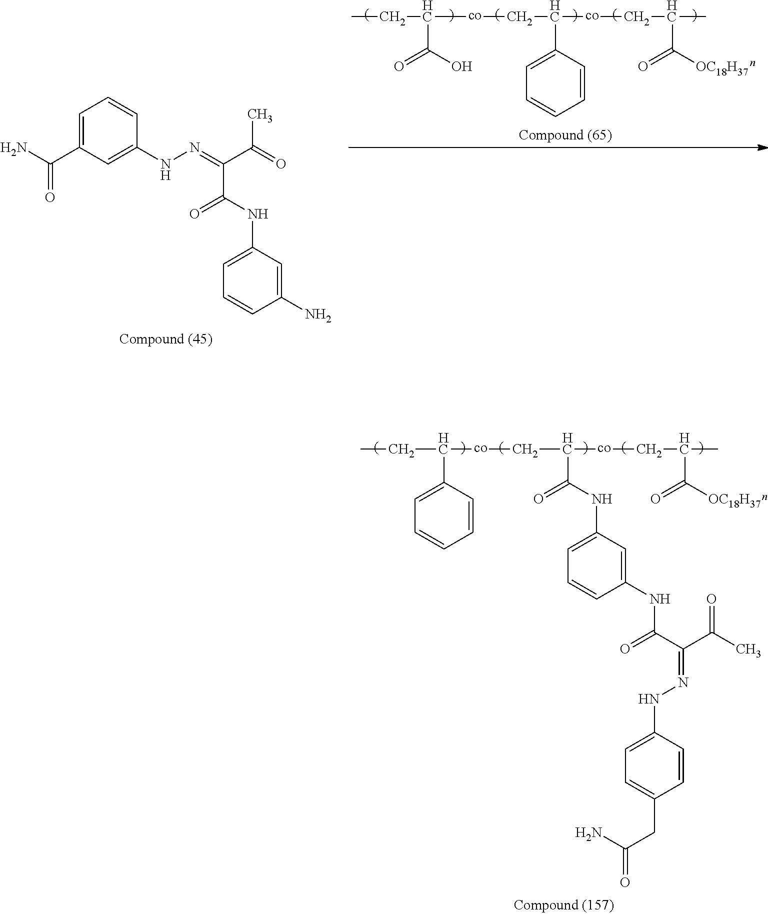

First, while an atmosphere was replaced by nitrogen, 100 parts of propylene glycol monomethyl ether were heated, and refluxed at a temperature of the solution of 120° C. or more. A mixture of 11.5 parts of styrene, 1.0 part of stearyl acrylate, 0.5 parts of acrylic acid, and 1.0 part of tert-butyl peroxybenzoate [organic peroxide polymerization initiator, made by NOF CORPORATION, trade name: PERBUTYL Z] was dropped over 3 hours to the solution. After dropping of the mixture was completed, the solution was stirred for 3 hours. Then, while the temperature of the solution was raised to 170° C., the solution was distilled under normal pressure. After the temperature of the solution reached 170° C., the solution was distilled at 1 hPa under reduced pressure for 1 hour to remove the solvent to obtain a resin solid product. The solid product was dissolved in tetrahydrofuran, and reprecipitated with n-hexane. The precipitated solid was filtered to obtain Compound (65).

Next, 2.0 parts of Compound (45) were added to 500 parts of tetrahydrofuran. The solution was heated to 80° C. to dissolve Compound (45). After Compound (45) was dissolved, the temperature was reduced to 50° C. 15 parts of Compound (65) were added, and dissolved. 2.0 parts of 1-ethyl-3-(3-dimethylaminopropyl)carbodiimide.hydrochloric acid salt (EDC.HCl) were added, and the solution was stirred at 50° C. for 5 hours. Then, the temperature of the solution was gradually reduced to room temperature, and the solution was stirred overnight. Thus, the reaction was completed. After the reaction was completed, the solution was filtered, condensed, and refined by reprecipitation with methanol. Thus, 12.5 parts of Compound (157) having an azo skeleton structure were obtained.

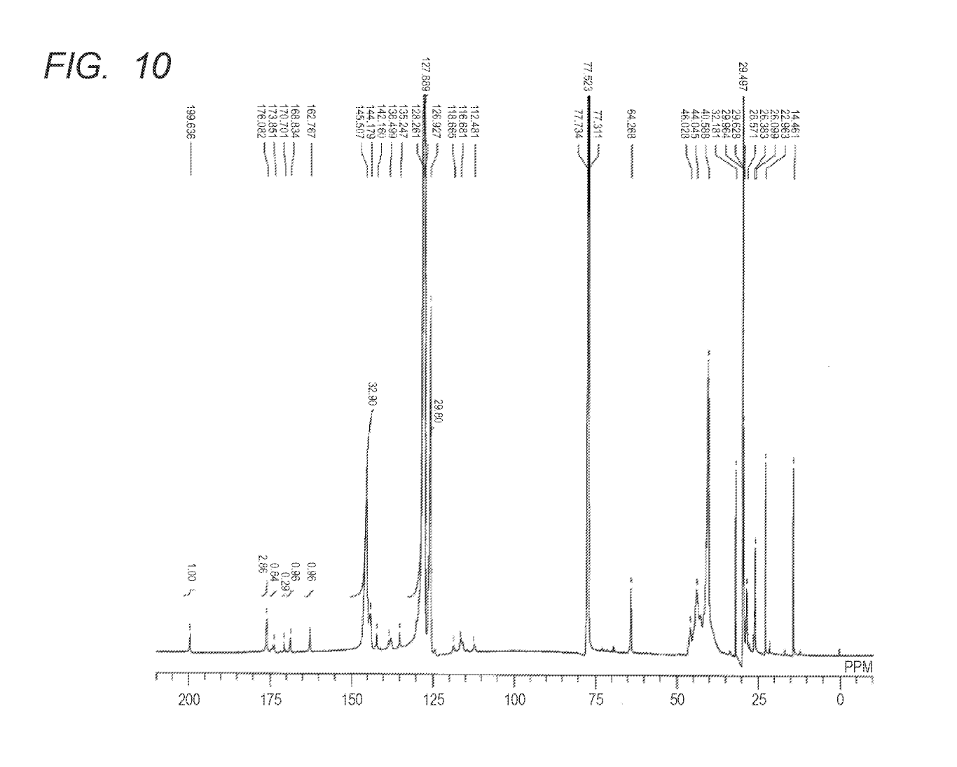

Using the apparatus above, it was found that the obtained compound has the structure represented by the above formula. The results of analysis are shown below.

[Results of Analysis of Compound (157) Having Azo Skeleton Structure]

[1] Result of measurement of molecular weight (GPC): number average molecular weight (Mn)=22047

[2] Result of measurement of acid value: 0.0 mgKOH/g

[3] Result of ¹³C NMR (600 MHz, CDCl₃, room temperature) (see FIG. 10): δ [ppm]=199.64 (3C), 176.08 (8C), 173.85 (3C), 170.70, 168.84, 162.77, 145.51 (93C), 144.18, 138.50, 135.25, 128.26, 127.89, 125.93, 118.67, 116.68, 112.48, 64.26, 50-36.00, 32.18, 29.57, 26.38, 22.66, 14.46

The same operation as that in Production Examples of Compounds (101), (107) to (110), (118), (119), (150), (152), (155), and (157) having an azo skeleton structure was performed to produce Compounds (102) to (106), (111) to (117), (120) to (149), (151), (153), (154), (156), (158), and (159) having an azo skeleton structure represented by the above formula (1).

The compounds having an azo skeleton structure according to the present invention are shown in Tables 1-1 and 1-2 below.

TABLE 1-1
Compounds having azo skeleton unit according to the present invention

| | Sequential arrangement of | | | | | | | |
|---|---|---|---|---|---|---|---|---|
| | monomers | | | | | | | |
| Compound | Copolymerization ratio | | | | | | | |
| No. | (X/Y/Z/W) | R₁ | R₂ | R₈ | R₉ | R₁₀ | R₁₁ | R₁₂ |
| 101 | poly(X₁-c-W) | —CH₃ | —NHPh | —H | —H | —R₁₀-1 | —H | —H |
| | (X₁/W = 100/4) | | | | | | | |
| 102 | poly(X₁-c-W) | —CH₃ | —NHPh | —H | —H | —R₁₀-2 | —H | —H |
| | (X₁/W = 100/4) | | | | | | | |
| 103 | poly(X₁-c-W) | —N(CH₃)₂ | —N(CH₃)₂ | —H | —H | —R₁₀-1 | —H | —H |
| | (X₁/W = 100/4) | | | | | | | |
| 104 | poly(X₁-c-W) | —OH | —OH | —H | —H | —R₁₀-1 | —H | —H |
| | (X₁/W = 100/4) | | | | | | | |
| 105 | poly(X₁-c-W) | —CH₃ | —CH₃ | —H | —H | —R₁₀-1 | —H | —H |
| | (X₁/W = 100/4) | | | | | | | |
| 106 | α-W-polyX₁ | —CH₃ | —NHPh | —H | —H | —R₁₀-3 | —H | —H |
| | (X₁/W = 110/1) | | | | | | | |
| 107 | poly(X₁-c-Y₅-c-W) | —OH | —OH | —H | —H | —R₁₀-4 | —H | —H |
| | (X₁/Y₅/W = 118/5/3) | | | | | | | |
| 108 | poly(X₁-c-Y₆-c-W) | —OH | —OH | —H | —H | —R₁₀-5 | —H | —H |
| | (X₁/Y₆/W = 120/6/3) | | | | | | | |
| 109 | poly(X₁-c-W) | —NH₂ | —NH₂ | —H | —H | —R₁₀-6 | —H | —H |
| | (X₁/W = 245/9) | | | | | | | |
| 110 | α-W-polyX₁ | —CH₃ | —R₂-2 | —COOCH₃ | —H | —H | —COOCH₃ | —H |
| | (X₁/W = 260/1) | | | | | | | |
| 111 | α-W-poly(X₁-c-Y₁) | —CH₃ | —R₂-1 | —COOCH₃ | —H | —H | —COOCH₃ | —H |
| | (X₁/Y₁/W = 71/18/1) | | | | | | | |
| 112 | α-W-poly(X₁-c-Y₁) | —CH₃ | —R₂-1 | —COOCH₃ | —H | —H | —COOCH₃ | —H |
| | (X₁/Y₁/W = 43/54/1) | | | | | | | |
| 113 | α-W-poly(X₁-c-Y₁) | —CH₃ | —R₂-1 | —COOCH₃ | —H | —H | —COOCH₃ | —H |
| | (X₁/Y₁/W = 18/88/1) | | | | | | | |
| 114 | α-W-poly(X₁-b-Y₁) | —CH₃ | —R₂-1 | —COOCH₃ | —H | —H | —COOCH₃ | —H |
| | (X₁/Y₁/W = 46/50/1) | | | | | | | |
| 115 | α-W-polyY₁ | —CH₃ | —R₂-1 | —COOCH₃ | —H | —H | —COOCH₃ | —H |
| | (Y₁/W = 101/1) | | | | | | | |
| 116 | PolyX₁-W-PolyX₁ | —R₁-1 | —R₂-1 | —COOCH₃ | —H | —H | —COOCH₃ | —H |
| | (X₁/W = 392/1) | | | | | | | |
| 117 | PolyX₁-W-PolyX₁ | —R₁-2 | —R₂-2 | —COOCH₃ | —H | —H | —COOCH₃ | —H |
| | (X₁/W = 386/1) | | | | | | | |
| 118 | poly(X₁-c-Y₁-c-Z₁-c-W) | —CH₃ | —R₂-3 | —COOCH₃ | —H | —H | —COOCH₃ | —H |
| | (X₁/Y₁/Z₁/W = 143/30/5/6) | | | | | | | |
| 119 | poly(X₁-c-Y₂-c-W) | —CH₃ | —R₂-4 | —COOCH₃ | —H | —H | —COOCH₃ | —H |
| | (X₁/Y₂//W = 113/5/3) | | | | | | | |
| 120 | poly(X₁-c-Y₁-c-Z₁-c-W) | —CH₃ | —R₂-3 | —COOCH₃ | —H | —H | —H | —H |
| | (X₁/Y₁/Z₁/W = 143/30/5/6) | | | | | | | |
| 121 | poly(X₁-c-Y₁-c-Z₁-c-W) | —CH₃ | —R₂-3 | —H | —COOCH₃ | —H | —H | —H |
| | (X₁/Y₁/Z₁/W = 143/30/5/6) | | | | | | | |
| 122 | poly(X₁-c-Y₁-c-Z₁-c-W) | —CH₃ | —R₂-3 | —H | —H | —COOCH₃ | —H | —H |
| | (X₁/Y₁/Z₁/W = 143/30/5/6) | | | | | | | |
| 123 | poly(X₁-c-Y₁-c-Z₁-c-W) | —CH₃ | —R₂-3 | —H | —H | —H | —H | —H |
| | (X₁/Y₁/Z₁/W = 143/30/5/6) | | | | | | | |
| 124 | poly(X₁-c-Y₁-Z₁-c-W) | —Ph | —R₂-3 | —COOCH₃ | —H | —H | —COOCH₃ | —H |
| | (X₁/Y₁/Z₁/W = 143/30/5/6) | | | | | | | |
| 125 | poly(X₁-c-Y₁-c-Z₁-c-W) | —CH₃ | —R₂-3 | —H | —COOCH₃ | —H | —COOCH₃ | —H |
| | (X₁/Y₁/Z₁/W = 143/30/5/6) | | | | | | | |
| 126 | poly(X₁-c-Y₁-c-Z₁-c-W) | —CH₃ | —R₂-3 | —CONHCH₃ | —H | —H | —CONHCH₃ | —H |
| | (X₁/Y₁/Z₁/W = 143/30/5/6) | | | | | | | |
| 127 | poly(X₁-c-Y₁-c-Z₁-c-W) | —CH₃ | —R₂-3 | —COOH | —H | —H | —COOH | —H |
| | (X₁/Y₁/Z₁/W = 143/30/5/6) | | | | | | | |
| 128 | poly(X₁-c-Y₁-c-Z₁-c-W) | —CH₃ | —R₂-3 | —COOPr(i) | —H | —H | —COOPr(i) | —H |
| | (X₁/Y₁/Z₁/W = 143/30/5/6) | | | | | | | |
| 129 | poly(X₂-c-Y₂-c-Z₁-c-W) | —CH₃ | —R₂-3 | —COOCH₃ | —H | —H | —COOCH₃ | —H |
| | (X₂/Y₂/Z₁/W = 143/30/5/6) | | | | | | | |

TABLE 1-2
Compounds having azo skeleton unit according
to the present invention

| Com- | | | | | | | | |
|---|---|---|---|---|---|---|---|---|
| pound | Sequential arrangement of | | | | | | | |
| No. | monomers | R₁ | R₂ | R₈ | R₉ | R₁₀ | R₁₁ | R₁₂ |
| 130 | poly(X₁-c-Y₃-c-Z₁-c-W) | —CH₃ | —R₂-3 | —COOCH₃ | —H | —H | —COOCH₃ | —H |
| | (X₁/Y₃/Z₁/W = 143/30/5/6) | | | | | | | |
| 131 | poly(X₁-c-Y₄-c-Z₁-c-W) | —CH₃ | —R₂-3 | —COOCH₃ | —H | —H | —COOCH₃ | —H |
| | (X₁/Y₄/Z₁/W = 143/30/5/6) | | | | | | | |
| 132 | poly(X₁-c-Y₁-c-W) | —CH₃ | —R₂-3 | —COOCH₃ | —H | —H | —COOCH₃ | —H |
| | (X₁/Y₁/W = 143/30/11) | | | | | | | |
| 133 | poly(X₁-c-Z₁-c-W) | —CH₃ | —R₂-3 | —COOCH₃ | —H | —H | —COOCH₃ | —H |
| | (X₁/Z₁/W = 221/3/8) | | | | | | | |
| 134 | poly(X₁-c-W) | —CH₃ | —R₂-3 | —COOCH₃ | —H | —H | —COOCH₃ | —H |
| | (X₁/W = 221/11) | | | | | | | |
| 135 | polyX₁-b-polyW) | —CH₃ | —R₂-3 | —COOCH₃ | —H | —H | —COOCH₃ | —H |
| | (X₁/W = 84/5) | | | | | | | |
| 136 | poly(Y₁-c-Z₁-c-W) | —CH₃ | —R₂-3 | —COOCH₃ | —H | —H | —COOCH₃ | —H |
| | (Y₁/Z₁/W = 90/2/8) | | | | | | | |
| 137 | poly(X₁-c-Y₁-c-Z₁-c-W) | —CH₃ | —R₂-3 | —COOCH₃ | —H | —H | —COOCH₃ | —H |
| | (X₁/Y₁/Z₁/W = 10/11/5/2) | | | | | | | |
| 138 | poly(X₁-c-Z₁-c-W) | —CH₃ | —R₂-3 | —COOCH₃ | —H | —H | —COOCH₃ | —H |
| | (X₁/Z₁/W = 974/384/197) | | | | | | | |
| 139 | poly(X₂-c-Y₃-c-W) | —CH₃ | —R₂-3 | —COOCH₃ | —H | —H | —COOCH₃ | —H |
| | (X₂/Y₃/W = 142/30/11) | | | | | | | |
| 140 | α-W-polyX₁ | —R₁-1 | —NHPh | —COOCH₃ | —H | —H | —COOCH₃ | —H |
| | (X₁/W = 110/1) | | | | | | | |
| 141 | poly(X₁-c-Y₁-c-Z₁-c-W) | —R₁-3 | —NHCH₃ | —COOCH₃ | —H | —H | —COOCH₃ | —H |
| | (X₁/Y₁/Z₁/W = 141/29/9/2) | | | | | | | |
| 142 | poly(X₁-c-Y₁-c-Z₁-c-W) | —R₁-3 | —N(CH₃)₂ | —COOCH₃ | —H | —H | —COOCH₃ | —H |
| | (X₁/Y₁/Z₁/W = 141/29/9/2) | | | | | | | |
| 143 | poly(X₁-c-Y₁-c-Z₁-c-W) | —R₁-3 | —OEt | —COOCH₃ | —H | —H | —COOCH₃ | —H |
| | (X₁/Y₁/Z₁/W = 141/29/9/2) | | | | | | | |
| 144 | poly(X₁-c-Y₁-c-Z₁-c-W) (X₁/Y₁/Z₁/W = 141/29/9/2) | —R₁-3 | 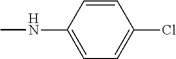 | —COOCH₃ | —H | —H | —COOCH₃ | —H |
| 145 | poly(X₁-c-Y₁-c-Z₁-c-W) (X₁/Y₁/Z₁/W = 141/29/9/2) | —R₁-3 | 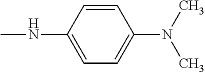 | —COOCH₃ | —H | —H | —COOCH₃ | —H |
| 146 | poly(X₁-c-Y₁-c-Z₁-c-W) (X₁/Y₁/Z₁/W = 141/29/9/2) | —R₁-3 | 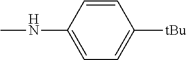 | —COOCH₃ | —H | —H | —COOCH₃ | —H |
| 147 | poly(X₁-c-Y₁-c-Z₁-c-W) (X₁/Y₁/Z₁/W = 141/29/9/2) | —R₁-3 | 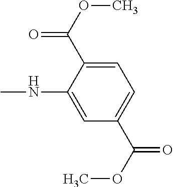 | —COOCH₃ | —H | —H | —COOCH₃ | —H |
| 148 | poly(X₁-c-Y₁-c-Z₁-c-W) | —R₁-3 | —NHCH₃ | —COOCH₃ | —H | —H | —COOCH₃ | —H |
| | (X₁/Y₁/Z₁/W = 141/29/9/2) | | | | | | | |
| 149 | poly(X₁-c-Y₁-c-Z₁-c-W) | —R₁-3 | —NHPh | —COOCH₃ | —H | —H | —COOCH₃ | —H |
| | (X₁/Y₁/Z₁/W = 141/29/9/2) | | | | | | | |
| 150 | poly(X₁-c-Y₂-c-W) | —CH₃ | —R₂-4 | —H | —CONH₂ | —H | —H | —H |
| | (X₁/Y₂//W = 130/5/4) | | | | | | | |
| 151 | poly(X₁-c-Y₂-c-Z₁-c-W) | —CH₃ | —R₂-4 | —CONH₂ | —H | —H | —H | —H |
| | (X₁/Y₂/Z₁/W = 97/3/1/3) | | | | | | | |
| 152 | poly(X₁-c-Y₂-c-Z₁-c-W) | —CH₃ | —R₂-4 | —H | —H | —CONH₂ | —H | —H |
| | (X₁/Y₂/Z₁/W = 97/3/1/3) | | | | | | | |
| 153 | poly(X₁-c-Y₂-c-Z₁-c-W) | —CH₃ | —R₂-4 | —CONH₂ | —H | —CONH₂ | —H | —H |
| | (X₁/Y₂/Z₁/W = 97/3/1/3) | | | | | | | |
| 154 | poly(X₁-c-Y₁-c-Y₂-c-Z₁-c-W) | —CH₃ | —R₂-4 | —H | —CONH₂ | —H | —H | —H |
| | (X₁/Y₁/Y₂/Z₁/W = 88/8/4/1/3) | | | | | | | |
| 155 | poly(X₁-c-Y₁-c-Y₈-c-Z₁-c-W) | —CH₃ | —R₂-4 | —H | —CONH₂ | —H | —H | —H |
| | (X₁/Y₁/Y₂/Z₁/W = 64/30/6/1/3) | | | | | | | |
| 156 | poly(X₁-c-Y₁-c-Y₈-c-Z₁-c-W) | —CH₃ | —R₂-4 | —H | —CONH₂ | —H | —H | —H |
| | (X₁/Y₁/Y₄/Z₁/W = 88/8/4/1/3) | | | | | | | |
| 157 | poly(X₁-c-Y₇-c-W) | —CH₃ | —R₂-4 | —H | —CONH₂ | —H | —H | —H |
| | (X₁/Y₃/W = 93/8/3) | | | | | | | |
| 158 | poly(X₁-c-Y₈-c-Z₁-c-W) | —CH₃ | —R₂-4 | —H | —CONH₂ | —H | —H | —H |
| | (X₁/Y₄/Z₁/W = 97/3/1/3) | | | | | | | |
| 159 | poly(X₁-c-Y₆-c-Z₁-c-W) | —CH₃ | —R₂-4 | —H | —CONH₂ | —H | —H | —H |
| | (X₁/Y₅/Z₁/W = 97/3/1/3) | | | | | | | |

[In Tables 1-1 and 1-2, α represents a terminal group located in the left of the structure; “Pr(i)” represents an unsubstituted isopropyl group; “Ph” represents an unsubstituted phenyl group; “Et” represents an ethyl group; “tBu” represents a tertiary butyl group.]

In Tables 1-1 and 1-2, the structures of X₁, X₂, Y₁ to Y₈, Z₁, W, R₁-1 to R₁-3, R₂-1 to R₂-7, and R₁₀-1 to R₁₀-6 are shown below.

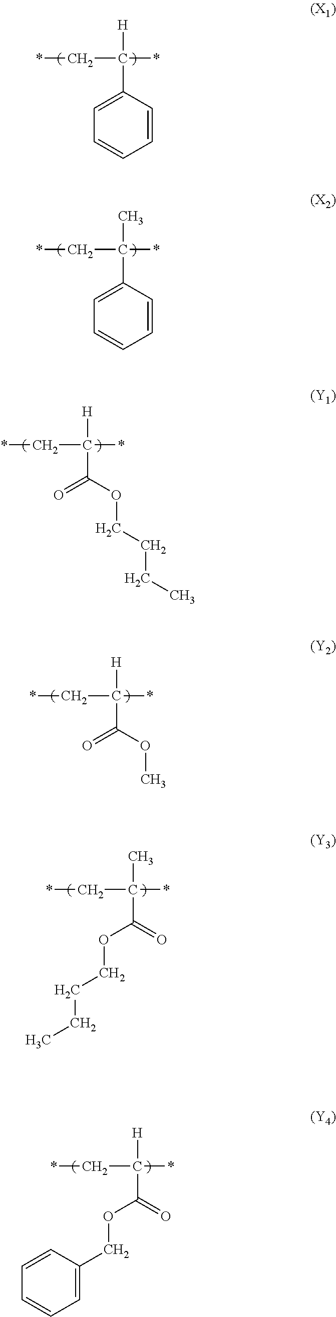

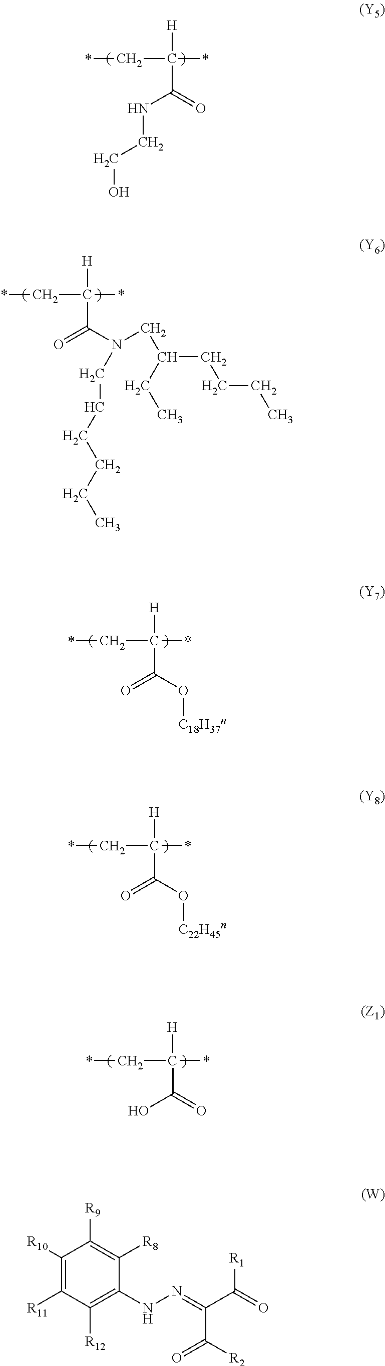

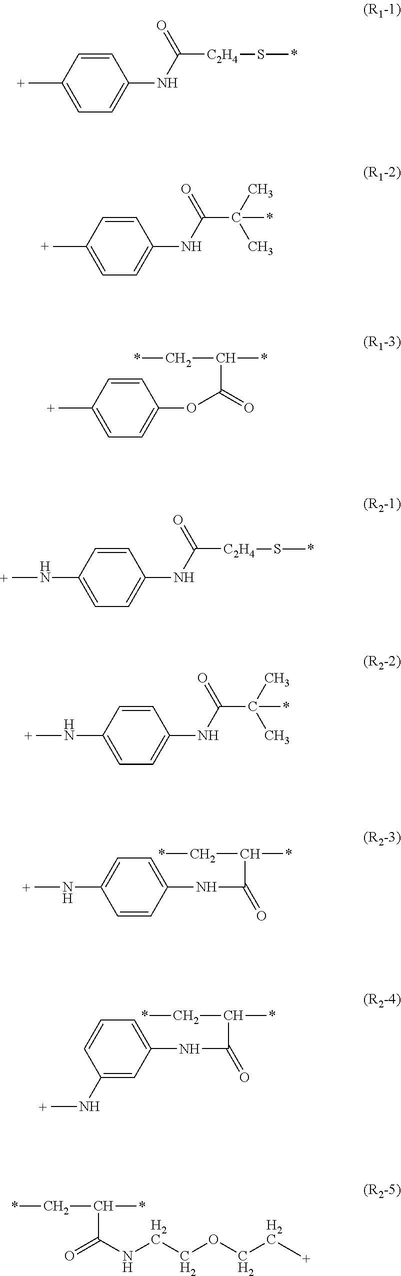

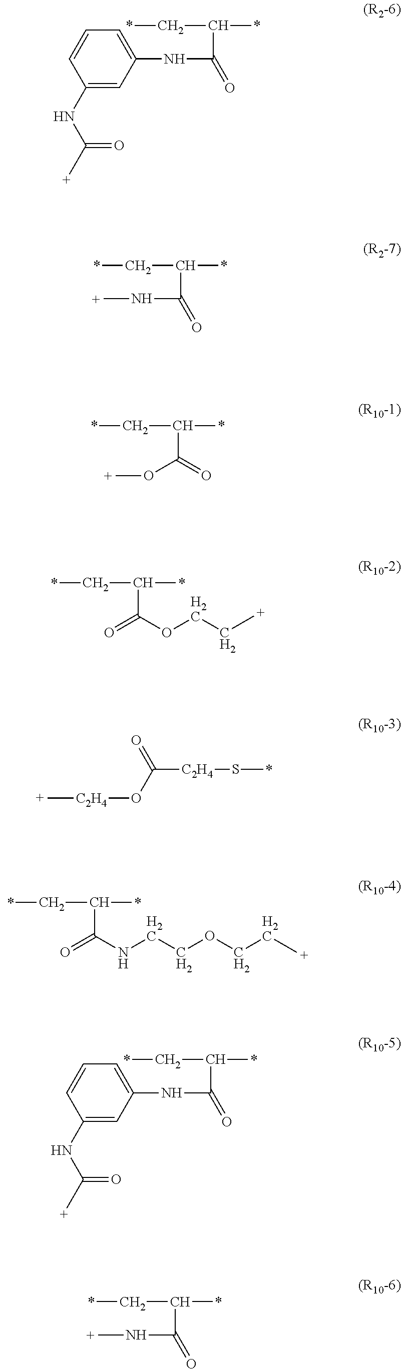

[in the formula (W), R₈, R₂, and R₈ to R₁₂ each represent the substituent shown in Table 1; “*” in X₁, X₂, Y₁ to Y₈, Z₁, R₁-1 to R₁-3, R₂-1 to R₂-7, and R₁₀-1 to R₁₀-6 represents a linking site to the main chain of the polymer; “+” in R₁-1 to R₁-3, R₂-1 to R₂-7, and R₁₀-1 to R₁₀-6 represents a linking site to the structure represented by the formula (W)].

### Example 2

First, in the toner production process according to the suspension polymerization method, a pigment dispersion containing the phthalocyanine pigment and the compound having an azo skeleton structure was prepared by the following method.

<Preparation Example 1 of Pigment Dispersion>

18.0 parts of C.I. Pigment Blue 15:3 represented by the formula (21) as a colorant, 1.8 parts of Compound (150) having an azo skeleton structure, 180 parts of styrene as a water-insoluble solvent, and 130 parts of glass beads (diameter of 1 mm) were mixed. Using an Attritor [made by NIPPON COKE & ENGINEERING CO., LTD.], the mixture was dispersed for 3 hours. The mixture was filtered with a mesh to obtain a pigment dispersion (DIS 1).

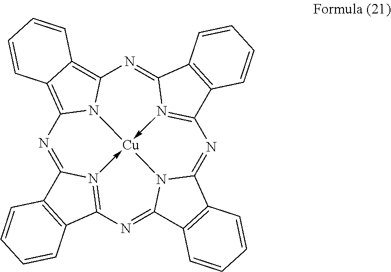

<Preparation Example 2 of Pigment Dispersion>

The same operation was performed except that Compounds (101) to (149) having an azo skeleton structure, and (151) to (159) were used instead of Compound (150) having an azo skeleton structure in Preparation Example 1 of the pigment dispersion. Thus, pigment dispersions (DIS 2) to (DIS 59) were obtained.

<Preparation Example 3 of Pigment Dispersion>

The same operation was performed except that C.I. Pigment Blue 15:4 represented by the formula (21), C.I. Pigment Blue 15:6 represented by the formula (21), C.I. Pigment Blue 16 represented by the following formula (66), and C.I. Pigment Blue 17:1 represented by the following formula (67) were used instead of C.I. Pigment Blue 15:3 represented by the formula (21) in Preparation Example 1 of the pigment dispersion. Thus, pigment dispersions (DIS 60) to (DIS 63) were obtained.

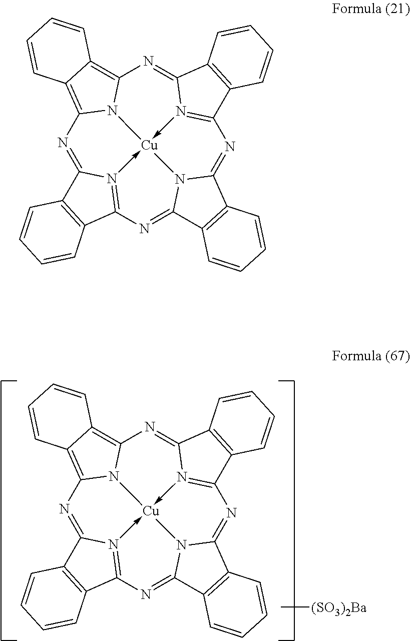

<Preparation Example 4 of Pigment Dispersion>

The same operation was performed except that Compound (107), Compound (110), Compound (119), Compound (152), and Compound (157) were used instead of Compound (150) having an azo skeleton structure in Preparation Example 3 of the pigment dispersion. Thus, pigment dispersions (DIS 64) to (DIS 83) were obtained.

### Comparative Example 1

Pigment dispersions demonstrating a reference value in evaluation and comparative pigment dispersions were prepared by the following method.

<Preparation Example 1 of Reference Pigment Dispersion>

The same operation was performed except that Compound (150) having an azo skeleton structure was not added in Preparation Example 1 of the pigment dispersion in Example 2. Thus, a reference pigment dispersion (DIS 84) was obtained.

<Preparation Example 2 of Reference Pigment Dispersion>

The same operation was performed except that Compound (150) having an azo skeleton structure was not added in Preparation Example 3 of the pigment dispersion in Example 2. Thus, reference pigment dispersions (DIS 85) to (DIS 88) were obtained.

<Preparation Example 1 of Comparative Pigment Dispersion>

The same operation was performed except that 1.8 parts of the styrene/4-vinylpyridine copolymer described in PTL 1 (styrene/4-vinylpyridine copolymerization ratio: 96/4, Mn=2040, Mw=4470) (Comparative Compound 1) and 0.09 parts of zinc phthalocyanine (Comparative Compound 2) were added instead of Compound (150) having an azo skeleton structure in Preparation Example 1 of the pigment dispersion in Example 2. Thus, a comparative pigment dispersion (DIS 89) was obtained.

<Preparation Example 2 of Comparative Pigment Dispersion>

The same operation was performed except that 1.8 parts of the styrene/2-acrylamide-2-methylpropanesulfonic acid copolymer described in PTL 2 (Mw=12000) (Comparative Compound 3) and 0.09 parts of zinc phthalocyanine (Comparative Compound 2) were added instead of Compound (150) having an azo skeleton structure in Preparation Example 1 of the pigment dispersion in Example 2. Thus, a comparative pigment dispersion (DIS 90) was obtained.

<Preparation Example 3 of Comparative Pigment Dispersion>

The same operation was performed except that 1.8 parts of the methyl methacrylate/sodium styrenesulfonate copolymer described in PTL 3 (Comparative Compound 4) were added instead of Compound (150) having an azo skeleton structure in Preparation Example 1 of the pigment dispersion in Example 2. Thus, a comparative pigment dispersion (DIS 91) was obtained.

<Preparation Example 4 of Comparative Pigment Dispersion>

The same operation was performed except that 1.8 parts of Solsperse 5000 (trade name) made by Lubrizol Corporation Japan Limited (Comparative Compound 5) were added instead of Compound (150) having an azo skeleton structure in Preparation Example 1 of the pigment dispersion in Example 2. Thus, a comparative pigment dispersion (DIS 92) was obtained.

### Example 3

The pigment dispersions were evaluated by the following method.

The pigment dispersibility of the compound having an azo dye skeleton structure according to the present invention was evaluated by performing a gloss test of the coating film formed by the pigment dispersion. Namely, the pigment dispersion was taken by a pipette, and disposed on an upper portion of a super art paper [S A Kanefuji 180 kg 80×160, made by Oji Paper Co., Ltd.] in a linear form. Using a wire bar (#10), the pigment dispersion was applied onto the art paper uniformly. After drying the coating, the gloss (reflection angle: 75°) was measured using a gloss meter Gloss Meter VG2000 [made by Nippon Denshoku Industries Co., Ltd.], and evaluated on the following criterion. The smoothness of the coating film is further improved and the gloss is further improved as the phthalocyanine pigment is dispersed more finely.

The improvement rates of the gloss values of the pigment dispersions (DIS 1) to (DIS 59) and (DIS 89) to (DIS 92) using C.I. Pigment Blue 15:3 represented by the formula (21) as the colorant were determined using the gloss value of the reference pigment dispersion (DIS 84) as a reference.

The improvement rates of the gloss values of the pigment dispersions (DIS 60), (DIS 64), (DIS 68), (DIS 72), (DIS 76), and (DIS 80) using C.I. Pigment Blue 15:4 represented by the formula (21) as the colorant were determined using the gloss value of the reference pigment dispersion (DIS 85) as the reference.

The improvement rates of the gloss values of the pigment dispersions (DIS 61), (DIS 65), (DIS 69), (DIS 73), (DIS 77), and (DIS 81) using C.I. Pigment Blue 15:6 represented by the formula (21) as the colorant were determined using the gloss value of the reference pigment dispersion (DIS 86) as the reference.

The improvement rates of the gloss values of the pigment dispersions (DIS 62), (DIS 66), (DIS 70), (DIS 74), (DIS 78), and (DIS 82) using C.I. Pigment Blue 16 represented by the formula (66) as the colorant were determined using the gloss value of the reference pigment dispersion (DIS 87) as the reference.

The improvement rates of the gloss values of the pigment dispersions (DIS 63), (DIS 67), (DIS 71), (DIS 75), (DIS 79), and (DIS 83) using the C.I. Pigment Blue 17:1 represented by the formula (67) as the colorant were determined using the gloss value of the reference pigment dispersion (DIS 88) as the reference.

Hereinafter, the criterion for evaluation of the pigment dispersion is shown.

A: the improvement rate of the gloss value is 10% or more

B: the improvement rate of the gloss value is not less than 5% and less than 10%

C: the improvement rate of the gloss value is not less than 0% and less than 5%

D: the improvement rate of the gloss value less than 0%

If the improvement rate of the gloss value was 5% or more, it was determined that the pigment dispersibility is good.

The results of evaluation of the pigment dispersibility in the present invention are shown in Table 2.

TABLE 2
Results of evaluation of pigment dispersibility

| | | | Evaluation of | | | | Evaluation of |
|---|---|---|---|---|---|---|---|
| Pigment | | | dispersibility | Pigment | | | dispersibility |
| dispersion | Compound | Pigment | (gloss level) | dispersion | Compound | Pigment | (gloss level) |
| DIS1 | 150 | 15:3 | A(57) | DIS47 | 146 | 15:3 | A(53) |
| DIS2 | 101 | 15:3 | A(53) | DIS48 | 147 | 15:3 | A(55) |
| DIS3 | 102 | 15:3 | A(58) | DIS49 | 148 | 15:3 | A(53) |
| DIS4 | 103 | 15:3 | A(53) | DIS50 | 149 | 15:3 | A(53) |
| DIS5 | 104 | 15:3 | A(54) | DIS51 | 151 | 15:3 | A(53) |
| DIS6 | 105 | 15:3 | A(56) | DIS52 | 152 | 15:3 | A(56) |
| DIS7 | 106 | 15:3 | A(53) | DIS53 | 153 | 15:3 | A(54) |
| DIS8 | 107 | 15:3 | A(57) | DIS54 | 154 | 15:3 | A(55) |
| DIS9 | 108 | 15:3 | A(64) | DIS55 | 155 | 15:3 | A(55) |
| DIS10 | 109 | 15:3 | A(61) | DIS56 | 156 | 15:3 | A(56) |
| DIS11 | 110 | 15:3 | A(53) | DIS57 | 157 | 15:3 | A(55) |
| DIS12 | 111 | 15:3 | A(53) | DIS58 | 158 | 15:3 | A(55) |
| DIS13 | 112 | 15:3 | A(56) | DIS59 | 159 | 15:3 | A(57) |
| DIS14 | 113 | 15:3 | A(53) | DIS60 | 150 | 15:4 | A(75) |
| DIS15 | 114 | 15:3 | A(54) | DIS61 | 150 | 15:6 | A(78) |
| DIS16 | 115 | 15:3 | A(55) | DIS62 | 150 | Formula | A(70) |
| | | | | | | (51) | |
| DIS17 | 116 | 15:3 | A(55) | DIS63 | 150 | Formula | A(70) |
| | | | | | | (52) | |
| DIS18 | 117 | 15:3 | A(53) | DIS64 | 107 | 15:4 | A(79) |
| DIS19 | 118 | 15:3 | A(54) | DIS65 | 107 | 15:6 | A(76) |
| DIS20 | 119 | 15:3 | A(53) | DIS66 | 107 | Formula | A(71) |
| | | | | | | (51) | |
| DIS21 | 120 | 15:3 | A(54) | DIS67 | 107 | Formula | A(70) |
| | | | | | | (52) | |
| DIS22 | 121 | 15:3 | A(55) | DIS68 | 110 | 15:4 | A(70) |
| DIS23 | 122 | 15:3 | A(53) | DIS69 | 110 | 15:6 | A(77) |
| DIS24 | 123 | 15:3 | A(55) | DIS70 | 110 | Formula | A(71) |
| | | | | | | (51) | |
| DIS25 | 124 | 15:3 | A(53) | DIS71 | 110 | Formula | A(70) |
| | | | | | | (52) | |
| DIS26 | 125 | 15:3 | A(54) | DIS72 | 119 | 15:4 | A(70) |
| DIS27 | 126 | 15:3 | A(56) | DIS73 | 119 | 15:6 | A(77) |
| DIS28 | 127 | 15:3 | A(55) | DIS74 | 119 | Formula | A(70) |
| | | | | | | (51) | |
| DIS29 | 128 | 15:3 | A(54) | DIS75 | 119 | Formula | A(70) |
| | | | | | | (52) | |
| DIS30 | 129 | 15:3 | A(53) | DIS76 | 152 | 15:4 | A(76) |
| DIS31 | 130 | 15:3 | A(57) | DIS77 | 152 | 15:6 | A(78) |
| DIS32 | 131 | 15:3 | A(53) | DIS78 | 152 | Formula | A(71) |
| | | | | | | (51) | |
| DIS33 | 132 | 15:3 | A(54) | DIS79 | 152 | Formula | A(70) |
| | | | | | | (52) | |
| DIS34 | 133 | 15:3 | A(54) | DIS80 | 157 | 15:4 | A(75) |
| DIS35 | 134 | 15:3 | A(57) | DIS81 | 157 | 15:6 | A(79) |
| DIS36 | 135 | 15:3 | A(55) | DIS82 | 157 | Formula | A(70) |
| | | | | | | (51) | |
| DIS37 | 136 | 15:3 | A(55) | DIS83 | 157 | Formula | A(70) |
| | | | | | | (52) | |
| DIS38 | 137 | 15:3 | A(55) | DIS84 | None | 15:3 | Reference (48) |
| DIS39 | 138 | 15:3 | A(53) | DIS85 | None | 15:4 | Reference (64) |
| DIS40 | 139 | 15:3 | A(55) | DIS86 | None | 15:6 | Reference (69) |
| DIS41 | 140 | 15:3 | A(54) | DIS87 | None | Formula | Reference (63) |
| | | | | | | (51) | |
| DIS42 | 141 | 15:3 | A(55) | DIS88 | None | Formula | Reference (63) |
| | | | | | | (52) | |
| DIS43 | 142 | 15:3 | A(54) | DIS89 | Comparative | 15:3 | B(51) |
| DIS44 | 143 | 15:3 | A(55) | | compound 1 | | |
| | | | | | Comparative | | |
| | | | | | compound 2 | | |
| DIS45 | 144 | 15:3 | A(56) | DIS90 | Comparative | 15:3 | B(51) |
| DIS46 | 145 | 15:3 | A(54) | | compound 2 | | |
| | | | | | Comparative | | |
| | | | | | compound 3 | | |
| DIS47 | 146 | 15:3 | A(53) | DIS91 | Comparative | 15:3 | C(49) |
| | | | | | compound 4 | | |
| | | | | DIS92 | Comparative | 15:3 | A(72) |
| | | | | | compound 5 | | |

[In the item Pigment in Table 2, 15:3 represents C.I. Pigment Blue 15:3 represented by the formula (21); 15:4 represents C.I. Pigment Blue 15:4 represented by the formula (21); 15:6 represents C.I. Pigment Blue 15:6 represented by the formula (21).]

### Example 4

The toner according to the present invention was produced by the suspension polymerization method according to the following method.

<Toner Production Example 1>

710 parts of ion exchange water and 450 parts of a 0.1 mol/l-Na₃PO₄ aqueous solution were added into a 2 L four-necked flask including a high speed stirring apparatus T.K. homomixer [made by PRIMIX Corporation]. The number of rotation was adjusted to 12000 rpm. The temperature was raised to 60° C. 68 parts of a 1.0 mol/l-CaCl₂ aqueous solution were gradually added thereto to prepare an aqueous medium containing a fine, poorly water-soluble dispersion stabilizer Ca₃(PO₄)₂. Next, the composition below was heated to 60° C., and uniformly dissolved or dispersed at 5000 rpm using the high speed stirring apparatus T.K. homomixer [made by PRIMIX Corporation].

| | |
|---|---|
| the pigment dispersion (DIS 1) | 132 parts |
| styrene monomer | 46 parts |
| n-butyl acrylate monomer | 34 parts |
| polar resin [saturated polyester resin (terephthalic | 10 parts |
| acid-propylene oxide modified bisphenol A, acid value | |
| of 15, peak molecular weight of 6000)] | |
| ester wax (the largest endothermic peak in DSC | 25 parts |
| measurement = 70° C., Mn = 704) | |
| aluminum salicylate compound [made by ORIENT CHEMICAL | 2 parts |
| INDUSTRIES CO., LTD., trade name: BONTRON E-108] | |
| divinylbenzene monomer | 0.1 parts |

10 parts of 2,2′-azobis(2,4-dimethylvaleronitrile) as the polymerization initiator were added to the composition. The obtained mixture was added into the aqueous medium. Granulation was performed for 15 minutes while the number of rotation was kept at 12000 rpm. Then, the stirrer was changed from the high speed stirring apparatus to a propeller stirring blade. The polymerization was continued for 5 hours at a temperature of the solution of 60° C. Then, the temperature of the solution was raised to 80° C., and the polymerization was continued for 8 hours. After the polymerization reaction was completed, the remaining monomer was distilled at 80° C. under reduced pressure. Then, a polymer fine particle dispersion was obtained by cooling to 30° C.

The obtained polymer fine particle dispersion was put into a washing container. While the polymer fine particle dispersion was stirred, diluted hydrochloric acid was added. Further, stirring was performed at a pH of 1.5 for 2 hours to dissolve a compound of phosphoric acid and calcium containing Ca₃(PO₄)₂. The solution was subjected to solid liquid separation using a filter to obtain polymer fine particles. The polymer fine particles were put into water, and stirred to prepare a dispersion again. Then, the dispersion was subjected to solid liquid separation using a filter. Re-dispersion of the polymer fine particles in water and solid liquid separation of the dispersion were repeated until the compound of phosphoric acid and calcium containing Ca₃(PO₄)₂ was sufficiently removed. Then, the polymer fine particles finally subjected to solid liquid separation was sufficiently dried with a dryer to obtain toner particles.

1.0 part of hydrophobic silica fine powder surface treated with hexamethyldisilazane (number average particle diameter of the primary particle of 7 nm), 0.15 parts of rutile titanium oxide fine powder (primary particle number average particle diameter of 45 nm), 0.5 parts of rutile titanium oxide fine powder (number average particle diameter of the primary particle of 200 nm) were dry mixed based on 100 parts of the obtained toner particles for 5 minutes using Henschel mixer [made by NIPPON COKE & ENGINEERING CO., LTD.]. Thus, a toner (TNR 1) was obtained.

<Toner Production Example 2>

Toners according to the present invention (TNR 2) to (TNR 83) were obtained in the same manner as in Toner Production Example 1 except that pigment dispersions (DIS 2) to (DIS 83) were used instead of the pigment dispersion (DIS 1) in Toner Production Example 1.

### Comparative Example 2

Toners demonstrating a reference value for evaluation and comparative toners for the toners according to the present invention produced in Example 4 were produced by the following method.

<Production Example 1 of Reference Toner>

Reference toners (TNR 84) to (TNR 88) were obtained in the same manner as in Toner Production Example 1 except that pigment dispersions (DIS 84) to (DIS 88) were used instead of the pigment dispersion (DIS 1) in Toner Production Example 1.

<Comparative Toner Production Example 1>

Comparative toners (TNR 89) to (TNR 92) were obtained in the same manner as in Toner Production Example 1 except that pigment dispersions (DIS 89) to (DIS 92) were used instead of the pigment dispersion (DIS 1) in Toner Production Example 1.

### Example 5

Next, the toner according to the present invention was produced by the suspension granulation method according to the following method.

<Toner Production Example 3>

180 parts of ethyl acetate, 18 parts of C.I. Pigment Blue 15:3, 1.8 parts of Compound (150) having an azo skeleton structure, and 130 parts of glass beads (φ of 1 mm) were mixed. Using an Attritor [made by NIPPON COKE & ENGINEERING CO., LTD.], the mixture was dispersed for 3 hours, and filtered with a mesh to prepare a pigment dispersion.

The composition below was dispersed for 24 hours using a ball mill to obtain 200 parts of a toner composition mixed solution.

| | |
|---|---|
| the pigment dispersion | 96.0 parts |
| polar resin [saturated polyester resin (polycondensate | 85.0 parts |
| of propylene oxide modified bisphenol A and phthalic | |
| acid, Tg = 75.9° C., Mw = 11000, Mn = 4200, acid value of | |
| 11)] | |
| hydrocarbon wax (Fischer-Tropsch wax, the largest | 9.0 parts |
| endothermic peak in DSC measurement = 80° C., Mw = 750) | |
| aluminum salicylate compound [made by BONTRON E-108, | 2 parts |
| ORIENT CHEMICAL INDUSTRIES CO., LTD.] | |
| ethyl acetate (solvent) | 10.0 parts |

The composition below was dispersed for 24 hours using a ball mill to dissolve carboxymethyl cellulose and obtain an aqueous medium.

| | |
|---|---|
| calcium carbonate (coated with acrylic acid copolymer) | 20.0 parts |
| carboxymethyl cellulose [Celogen BS-H, made by Dai- | 0.5 parts |
| ichi Kogyo Seiyaku Co., Ltd.] | |
| ion exchange water | 99.5 parts |

1200 parts of the aqueous medium were put into a high speed stirring apparatus T.K. homomixer [made by PRIMIX Corporation]. While the aqueous medium was stirred using a rotary blade at a circumferential speed of 20 m/sec, 1000 parts of the toner composition mixed solution were added. While the temperature was kept constant at 25° C., the aqueous medium was stirred for 1 minute to obtain a suspension.

While 2200 parts of the suspension were stirred using a FULLZONE Impeller [made by Kobelco Eco-Solutions Co., Ltd.] at a circumferential speed of 45 m/min, the temperature of the solution was kept constant at 40° C. Using a blower, a gaseous phase on the suspension was forcibly sucked to start removal of the solvent. At this time, 15 minutes later from the start of removing the solvent, 75 parts of aqueous ammonia diluted to be 1% were added as an ionic substance. Subsequently, one hour later from the start of removing the solvent, 25 parts of the aqueous ammonia were added. Subsequently, two hours later from the start of removing the solvent, 25 parts of the aqueous ammonia were added. Finally, three hours later from the start of removing the solvent, 25 parts of the aqueous ammonia were added. The total amount of the aqueous ammonia to be added was 150 parts. Further, while the temperature of the solution was kept at 40° C., the temperature was kept for 17 hours from the start of removing the solvent to remove the solvent (ethyl acetate) from suspended particles. Thereby, a toner dispersion was obtained.

80 parts of 10 mol/l hydrochloric acid were added to 300 parts of the toner dispersion obtained in the solvent removing step. Further, the toner dispersion was neutralized with a 0.1 mol/l sodium hydroxide aqueous solution, and washed with ion exchange water by suction filtration. The operation was repeated 4 times. Thus, a toner cake was obtained. The obtained toner cake was dried with a vacuum drier. The dried toner cake was sieved with a sieve having an opening of 45 μm to obtain toner particles. The operation subsequent to this was performed in the same manner as in Toner Production Example 1 to obtain a toner (TNR 101).

### <Toner Production Example 4>

Toners according to the present invention (TNR 102) to (TNR 159) were obtained by the same operation as in Toner Production Example 3 except that Compounds (101) to (149), and (151) to (159) were used instead of Compound (150) having an azo skeleton structure in Toner Production Example 3.

<Toner Production Example 5>

Toners according to the present invention (TNR 160) to (TNR 163) were obtained in the same manner as in Toner Production Example 3 except that C.I. Pigment Blue 15:4 represented by the formula (21), C.I. Pigment Blue 15:6 represented by the formula (21), C.I. Pigment Blue 16 represented by the formula (66), and C.I. Pigment Blue 17:1 represented by the formula (67) were used instead of C.I. Pigment Blue 15:3 represented by the formula (21) in Toner Production Example 3.

<Toner Production Example 6>

Toners according to the present invention (TNR 164) to (TNR 183) were obtained in the same manner as in Toner Production Example 5 except that Compounds (107), (110), (119), (152), and (157) were used instead of Compound (150) having an azo skeleton structure in Toner Production Example 5.

### Comparative Example 3

Toners demonstrating a reference value for evaluation and comparative toners for the toners according to the present invention produced in Example 5 were produced by the following method.

<Reference Toner Production Example 2>

A reference toner (TNR 184) was obtained in the same manner as in Toner Production Example 3 except that Compound (150) having an azo skeleton structure in Toner Production Example 3 was not added.

<Reference Toner Production Example 3>

Reference toners (TNR 185) to (TNR 188) were obtained in the same manner as in Toner Production Example 5 except that Compound (150) having an azo skeleton structure in Toner Production Example 5 was not added.

<Comparative Toner Production Example 2>

A comparative toner (TNR 189) was obtained in the same manner as in Toner Production Example 3 except that 1.8 parts of Comparative Compound 1 and 0.09 parts of Comparative Compound 2 were used instead of Compound (150) having an azo skeleton structure in Toner Production Example 3.

<Comparative Toner Production Example 3>

A comparative toner (TNR 190) was obtained in the same manner as in Toner Production Example 3 except that 1.8 parts of Comparative Compound 3 and 0.09 parts of Comparative Compound 2 were used instead of Compound (150) having an azo skeleton structure in Toner Production Example 3.

<Comparative Toner Production Example 4>

A comparative toner (TNR 191) was obtained in the same manner as in Toner Production Example 3 except that Comparative Compound 4 was used instead of Compound (150) having an azo skeleton structure in Toner Production Example 3.

<Comparative Toner Production Example 4>

A comparative toner (TNR 192) was obtained in the same manner as in Toner Production Example 3 except that Comparative Compound 5 was used instead of Compound (150) having an azo skeleton structure in Toner Production Example 3.

### Example 6

The toners obtained in the present invention were evaluated according to the following method.

Using the toners (TNR 1) to (TNR 83) and (TNR 101) to (TNR 183), image samples were output, and image properties thereof described later were compared and evaluated. In comparison of the image properties, a sheet feeding durability test was performed using a modified machine of an LBP-5300 (made by Canon Inc.) as an image forming apparatus (hereinafter, abbreviated to an LBP). In the modification, the developing blade in the process cartridge (hereinafter, referred to a CRG) was replaced by an SUS blade having a thickness of 8 [μm]. Additional modification was made such that a blade bias of −200 [V] could be applied with respect to the developing bias applied to a developing roller serving as a toner carrier.

A Coulter Multisizer [made by Beckman Coulter, Inc.] was used, and an interface for outputting the number distribution and the volume distribution [made by Nikkaki-Bios Co., Ltd.] and a personal computer were connected to the Coulter Multisizer. Sodium chloride was used for an electrolyte solution, and a 1% NaCl aqueous solution was used. For example, ISOTON R-II [made by Beckman Coulter, Inc.] can be used. The specific measurement procedure is shown in the catalog of the Coulter Multisizer published by Beckman Coulter, Inc. (February 2002 edition) and an operation manual for the measurement apparatus. The procedure is as follows.

2 to 20 mg of a measurement sample was added to 100 to 150 ml of the electrolytic aqueous solution. The electrolyte solution having the suspended sample was dispersed for approximately 1 to 3 minutes using an ultrasonic disperser. Using the 100 μm aperture for the Coulter Multisizer, the volume and number of toner particles having a particle diameter of not less than 2.0 μm and not more than 64.0 μm were measured. The obtained data was divided for 16 channels, and the weight average particle diameter D4, the number average particle diameter D1, and D4/D1 were determined.

Under a normal temperature and normal humidity [N/N (23.5° C., 60% RH)] environment, a solid image was formed on a transfer paper (75 g/m² paper) at an amount of the toner to be applied of 0.5 mg/cm². Using a reflection densitometer Spectrolino (made by Gretag Macbeth GmbH), the density of the solid image was measured. The coloring ability of toner was evaluated using the improvement rate of the density of the solid image.

The improvement rates of the densities of the solid images formed using the toners (TNR 1) to (TNR 59) produced according to the suspension polymerization method by using C.I. Pigment Blue 15:3 represented by the formula (21) as the colorant were determined using the density of the solid image of the reference toner (TNR 84) as the reference value.

The improvement rates of the densities of the solid images formed using the toners (TNR 60), (TNR 64), (TNR 68), (TNR 72), (TNR 76), and (TNR 80) produced according to the suspension polymerization method by using C.I. Pigment Blue 15:4 represented by the formula (21) as the colorant were determined using the density of the solid image of the reference toner (TNR 85) as the reference value.

The improvement rates of the densities of the solid images formed using the toners (TNR 61), (TNR 65), (TNR 69), (TNR 73), (TNR 77), and (TNR 81) produced according to the suspension polymerization method by using C.I. Pigment Blue 15:6 represented by the formula (21) as the colorant were determined using the density of the solid image of the reference toner (TNR 86) as the reference value.

The improvement rates of the densities of the solid images formed by using the toners (TNR 62), (TNR 66), (TNR 70), (TNR 74), (TNR 78), and (TNR 82) produced according to the suspension polymerization method using C.I. Pigment Blue 16 represented by the formula (66) as the colorant were determined using the density of the solid image of the reference toner (TNR 87) as the reference value.

The improvement rates of the densities of the solid images formed using the toners (TNR 63), (TNR 67), (TNR 71), (TNR 75), (TNR 79), and (TNR 83) produced according to the suspension polymerization method by using C.I. Pigment Blue 17:1 represented by the formula (67) as the colorant were determined using the density of the solid image of the reference toner (TNR 88) as the reference value.

The improvement rates of the densities of the solid images formed using the toners (TNR 101) to (TNR 159) produced according to the suspension granulation method by using C.I. Pigment Blue 15:3 represented by the formula (21) as the colorant were determined using the density of the solid image of the reference toner (TNR 184) as the reference value.

The improvement rates of the densities of the solid images formed using the toners (TNR 160), (TNR 164), (TNR 168), (TNR 172), (TNR 176), and (TNR 180) produced according to the suspension granulation method by using C.I. Pigment Blue 15:4 represented by the formula (21) as the colorant were determined using the density of the solid image of the reference toner (TNR 185) as the reference value.

The improvement rates of the densities of the solid images formed using the toners (TNR 161), (TNR 165), (TNR 169), (TNR 173), (TNR 177), and (TNR 181) produced according to the suspension granulation method by using C.I. Pigment Blue 15:6 represented by the formula (21) as the colorant were determined using the density of the solid image of the reference toner (TNR 186) as reference value.

The improvement rates of the densities of the solid images formed using the toners (TNR 162), (TNR 166), (TNR 170), (TNR 174), (TNR 178), and (TNR 182) produced according to the suspension granulation method by using C.I. Pigment Blue 16 represented by the formula (66) as the colorant were determined using the density of the solid image of the reference toner (TNR 187) as the reference value.

The improvement rates of the densities of the solid images formed using the toners (TNR 163), (TNR 167), (TNR 171), (TNR 175), (TNR 179), and (TNR 183) produced according to the suspension granulation method by using C.I. Pigment Blue 17:1 represented by the formula (67) as the colorant were determined using the density of the solid image of the reference toner (TNR 188) as the reference value.

The criterion for evaluation of the improvement rate of the density of the solid image is shown below:

A: the improvement rate of the density of the solid image is 30% or more

B: the improvement rate of the density of the solid image is not less than 20% and less than 30%

C: the improvement rate of the density of the solid image is not less than 10% and less than 20%

D: the density of the solid image is less than 10%

If the improvement rate of the density of the solid image was 10% or more, it was determined that the coloring ability is good.

The results of evaluation of the color tone of the toners according to the present invention produced by the suspension polymerization method are shown in Tables 3-1 and 3-2, and the results of evaluation of the color tone of the toners by the suspension granulation method are shown in Tables 4-1 to 4-2.

Under a normal temperature and normal humidity [N/N (23.5° C., 60% RH)] environment and a high temperature and high humidity [H/H (30° C., 80% RH)] environment, an image output test was performed in which using a transfer paper (75 g/m² paper), an image having a coverage rate of 2% was printed out on 10,000 sheets of the transfer paper. In this test, an image having white portion was output when the evaluation of durability was completed. The fogging density (%) [=Dr (%)−Ds (%)] was calculated from the difference between the white chromaticity [reflectance Ds (%)] of the white portion in the printed image and the white chromaticity [average reflectance Dr (%)] of the transfer paper, which were measured using a “REFLECTMETER MODEL TC-6DS” [made by Tokyo Denshoku Co., Ltd.]. The fogging when the evaluation of durability was completed was evaluated using the fogging density.

A: less than 1.0%

B: not less than 1.0% and less than 2.0%

C: not less than 2.0% and less than 3.0%

D: 3.0% or more

If the fogging density was less than 3.0%, it was determined that fogging is sufficiently suppressed.

The results of evaluation of the fogging of the toners according to the present invention produced by the suspension polymerization method are shown in Table 3, and the results of evaluation of the fogging of the toners produced by the suspension granulation method are shown in Table 4.

Under a high temperature and high humidity [H/H (30° C., 80% RH)] environment, an image output test was performed in which using a transfer paper (75 g/m² paper), an image having a coverage rate of 2% was printed out on 10,000 sheets of the transfer paper. In this test, transfer efficiency was checked when the evaluation of durability was completed. A solid image was developed on a drum at an amount of the toner to be applied of 0.65 mg/cm², and transferred onto a transfer paper (75 g/m² paper) to obtain a non-fixed image. The transfer efficiency was determined from the difference between the amount of the toner on the drum and the amount of the toner on the transfer paper (the transfer efficiency is 100% when the amount of the toner on the drum is totally transferred onto the transfer paper).

A: the transfer efficiency is 90% or more

B: the transfer efficiency is not less than 80% and less than 90%

C: the transfer efficiency is not less than 70% and less than 80%

D: the transfer efficiency is less than 70%

If the transfer efficiency was 70% or more, it was determined that the transfer efficiency is good.

The results of evaluation of the transfer efficiency of the toners according to the present invention produced by the suspension polymerization method are shown in Tables 3-1 and 3-2, and the results of evaluation of the transfer efficiency of the toners produced by the suspension granulation method are shown in Tables 4-1 and 4-2.

### Comparative Example 4

In the comparative toners (TNR 89) to (TNR 92), and (TNR 189) to (TNR 192), the color tone, fogging, and transfer efficiency were evaluated by the same method as that in Example 6.

In the comparative toners (TNR 89) to (TNR 92), the improvement rate of the density of the solid image was determined using the density of the solid image of the reference toner (TNR 84) as the reference value.

In the comparative toners (TNR 189) to (TNR 192), the improvement rate of the density of the solid image was determined using the density of the solid image of the reference toner (TNR 184) as the reference value.

The results of evaluation of the comparative toners produced by the suspension polymerization method are shown in Table 3-2, and the results of evaluation of the comparative toners produced by the suspension granulation method are shown in Table 4-2.

TABLE 3-1
Results of evaluation of suspension
polymerized toners according to the present invention

| | | | | Weight | | | | | |
|---|---|---|---|---|---|---|---|---|---|
| | | | | average | | Solid image | | | |
| | | | | diameter of | | density | | | |
| | | | | toner D4 | | improvement | Fogging | Fogging | Transfer |
| Toner | | Compound | Pigment | [μm] | D4/D1 | rate | (N/N) | (H/H) | properties |
| TNR1 | The present | 150 | 15:3 | 6.11 | 1.19 | A | A | A | A |
| | invention | | | | | | | | |
| TNR2 | The present | 101 | 15:3 | 6.20 | 1.10 | A | A | A | A |
| | invention | | | | | | | | |
| TNR3 | The present | 102 | 15:3 | 6.22 | 1.20 | A | A | A | A |
| | invention | | | | | | | | |
| TNR4 | The present | 103 | 15:3 | 6.06 | 1.28 | A | A | A | A |
| | invention | | | | | | | | |
| TNR5 | The present | 104 | 15:3 | 6.01 | 1.20 | A | A | A | A |
| | invention | | | | | | | | |
| TNR6 | The present | 105 | 15:3 | 6.21 | 1.19 | A | A | A | A |
| | invention | | | | | | | | |
| TNR7 | The present | 106 | 15:3 | 6.14 | 1.17 | A | A | A | A |
| | invention | | | | | | | | |
| TNR8 | The present | 107 | 15:3 | 6.11 | 1.30 | A | A | A | A |
| | invention | | | | | | | | |
| TNR9 | The present | 108 | 15:3 | 6.21 | 1.22 | A | A | A | A |
| | invention | | | | | | | | |
| TNR10 | The present | 109 | 15:3 | 6.23 | 1.20 | A | A | A | A |
| | invention | | | | | | | | |
| TNR11 | The present | 110 | 15:3 | 6.08 | 1.13 | A | A | A | A |
| | invention | | | | | | | | |
| TNR12 | The present | 111 | 15:3 | 6.22 | 1.16 | A | A | A | A |
| | invention | | | | | | | | |
| TNR13 | The present | 112 | 15:3 | 6.29 | 1.18 | A | A | A | A |
| | invention | | | | | | | | |
| TNR14 | The present | 113 | 15:3 | 6.19 | 1.25 | A | A | A | A |
| | invention | | | | | | | | |
| TNR15 | The present | 114 | 15:3 | 6.18 | 1.28 | A | A | A | A |
| | invention | | | | | | | | |
| TNR16 | The present | 115 | 15:3 | 6.12 | 1.11 | A | A | A | A |
| | invention | | | | | | | | |
| TNR17 | The present | 116 | 15:3 | 6.13 | 1.19 | A | A | A | A |
| | invention | | | | | | | | |
| TNR18 | The present | 117 | 15:3 | 6.06 | 1.29 | A | A | A | A |
| | invention | | | | | | | | |
| TNR19 | The present | 118 | 15:3 | 6.22 | 1.30 | A | A | A | A |
| | invention | | | | | | | | |
| TNR20 | The present | 119 | 15:3 | 6.25 | 1.28 | A | A | A | A |
| | invention | | | | | | | | |
| TNR21 | The present | 120 | 15:3 | 6.02 | 1.11 | A | A | A | A |
| | invention | | | | | | | | |
| TNR22 | The present | 121 | 15:3 | 6.21 | 1.16 | A | A | A | A |
| | invention | | | | | | | | |
| TNR23 | The present | 122 | 15:3 | 6.28 | 1.19 | A | A | A | A |
| | invention | | | | | | | | |
| TNR24 | The present | 123 | 15:3 | 6.07 | 1.19 | A | A | A | A |
| | invention | | | | | | | | |
| TNR25 | The present | 124 | 15:3 | 6.21 | 1.20 | A | A | A | A |
| | invention | | | | | | | | |
| TNR26 | The present | 125 | 15:3 | 6.17 | 1.16 | A | A | A | A |
| | invention | | | | | | | | |
| TNR27 | The present | 126 | 15:3 | 6.15 | 1.15 | A | A | A | A |
| | invention | | | | | | | | |
| TNR28 | The present | 127 | 15:3 | 6.11 | 1.22 | A | A | A | A |
| | invention | | | | | | | | |
| TNR29 | The present | 128 | 15:3 | 6.11 | 1.16 | A | A | A | A |
| | invention | | | | | | | | |
| TNR30 | The present | 129 | 15:3 | 6.17 | 1.21 | A | A | A | A |
| | invention | | | | | | | | |
| TNR31 | The present | 130 | 15:3 | 6.19 | 1.21 | A | A | A | A |
| | invention | | | | | | | | |
| TNR32 | The present | 131 | 15:3 | 6.11 | 1.20 | A | A | A | A |
| | invention | | | | | | | | |
| TNR33 | The present | 132 | 15:3 | 6.07 | 1.15 | A | A | A | A |
| | invention | | | | | | | | |
| TNR34 | The present | 133 | 15:3 | 6.05 | 1.20 | A | A | A | A |
| | invention | | | | | | | | |
| TNR35 | The present | 134 | 15:3 | 6.25 | 1.29 | A | A | A | A |
| | invention | | | | | | | | |
| TNR36 | The present | 135 | 15:3 | 6.19 | 1.30 | A | A | A | A |
| | invention | | | | | | | | |
| TNR37 | The present | 136 | 15:3 | 6.12 | 1.25 | A | A | A | A |
| | invention | | | | | | | | |
| TNR38 | The present | 137 | 15:3 | 6.10 | 1.21 | A | A | A | A |
| | invention | | | | | | | | |
| TNR39 | The present | 138 | 15:3 | 6.27 | 1.17 | A | A | A | A |
| | invention | | | | | | | | |
| TNR40 | The present | 139 | 15:3 | 6.30 | 1.30 | A | A | A | A |
| | invention | | | | | | | | |
| TNR41 | The present | 140 | 15:3 | 6.07 | 1.19 | A | A | A | A |
| | invention | | | | | | | | |
| TNR42 | The present | 141 | 15:3 | 6.12 | 1.29 | A | A | A | A |
| | invention | | | | | | | | |
| TNR43 | The present | 142 | 15:3 | 6.05 | 1.30 | A | A | A | A |
| | invention | | | | | | | | |
| TNR44 | The present | 143 | 15:3 | 6.14 | 1.19 | A | A | A | A |
| | invention | | | | | | | | |
| TNR45 | The present | 144 | 15:3 | 6.15 | 1.25 | A | A | A | A |
| | invention | | | | | | | | |
| TNR46 | The present | 145 | 15:3 | 6.48 | 1.30 | A | A | A | A |
| | invention | | | | | | | | |
| TNR47 | The present | 146 | 15:3 | 6.11 | 1.13 | A | A | A | A |
| | invention | | | | | | | | |

TABLE 3-2
Results of evaluation of suspension
polymerized toners according to the present invention

| | | | | Weight | | | | | |
|---|---|---|---|---|---|---|---|---|---|
| | | | | average | | Solid image | | | |
| | | | | diameter of | | density | | | |
| | | | | toner D4 | | improvement | Fogging | Fogging | Transfer |
| Toner | | Compound | Pigment | [μm] | D4/D1 | rate | (N/N) | (H/H) | Properties |
| TNR48 | The present | 147 | 15:3 | 6.42 | 1.43 | A | A | A | A |
| | invention | | | | | | | | |
| TNR49 | The present | 148 | 15:3 | 6.28 | 1.32 | A | A | A | A |
| | invention | | | | | | | | |
| TNR50 | The present | 149 | 15:3 | 6.24 | 1.21 | A | A | A | A |
| | invention | | | | | | | | |
| TNR51 | The present | 151 | 15:3 | 6.25 | 1.30 | A | A | A | A |
| | invention | | | | | | | | |
| TNR52 | The present | 152 | 15:3 | 6.20 | 1.28 | A | A | A | A |
| | invention | | | | | | | | |
| TNR53 | The present | 153 | 15:3 | 6.18 | 1.28 | A | A | A | A |
| | invention | | | | | | | | |
| TNR54 | The present | 154 | 15:3 | 6.28 | 1.25 | A | A | A | A |
| | invention | | | | | | | | |
| TNR55 | The present | 155 | 15:3 | 6.15 | 1.25 | A | A | A | A |
| | invention | | | | | | | | |
| TNR56 | The present | 156 | 15:3 | 6.14 | 1.26 | A | A | A | A |
| | invention | | | | | | | | |
| TNR57 | The present | 157 | 15:3 | 6.16 | 1.24 | A | A | A | A |
| | invention | | | | | | | | |
| TNR58 | The present | 158 | 15:3 | 6.20 | 1.28 | A | A | A | A |
| | invention | | | | | | | | |
| TNR59 | The present | 159 | 15:3 | 6.24 | 1.20 | A | A | A | A |
| | invention | | | | | | | | |
| TNR60 | The present | 150 | 15:4 | 6.10 | 1.19 | A | A | A | A |
| | invention | | | | | | | | |
| TNR61 | The present | 150 | 15:6 | 6.13 | 1.21 | A | A | A | A |
| | invention | | | | | | | | |
| TNR62 | The present | 150 | Formula | 6.24 | 1.20 | A | A | A | A |
| | invention | | (51) | | | | | | |
| TNR63 | The present | 150 | Formula | 6.21 | 1.21 | A | A | A | A |
| | invention | | (52) | | | | | | |
| TNR64 | The present | 107 | 15:4 | 6.14 | 1.22 | A | A | A | A |
| | invention | | | | | | | | |
| TNR65 | The present | 107 | 15:6 | 6.15 | 1.21 | A | A | A | A |
| | invention | | | | | | | | |
| TNR66 | The present | 107 | Formula | 6.19 | 1.21 | A | A | A | A |
| | invention | | (51) | | | | | | |
| TNR67 | The present | 107 | Formula | 6.18 | 1.23 | A | A | A | A |
| | invention | | (52) | | | | | | |
| TNR68 | The present | 110 | 15:4 | 6.29 | 1.21 | A | A | A | A |
| | invention | | | | | | | | |
| TNR69 | The present | 110 | 15:6 | 6.21 | 1.20 | A | A | A | A |
| | invention | | | | | | | | |
| TNR70 | The present | 110 | Formula | 6.28 | 1.28 | A | A | A | A |
| | invention | | (51) | | | | | | |
| TNR71 | The present | 110 | Formula | 6.26 | 1.24 | A | A | A | A |
| | invention | | (52) | | | | | | |
| TNR72 | The present | 119 | 15:4 | 6.24 | 1.24 | A | A | A | A |
| | invention | | | | | | | | |
| TNR73 | The present | 119 | 15:6 | 6.10 | 1.28 | A | A | A | A |
| | invention | | | | | | | | |
| TNR74 | The present | 119 | Formula | 6.18 | 1.24 | A | A | A | A |
| | invention | | (51) | | | | | | |
| TNR75 | The present | 119 | Formula | 6.21 | 1.20 | A | A | A | A |
| | invention | | (52) | | | | | | |
| TNR76 | The present | 152 | 15:4 | 6.23 | 1.30 | A | A | A | A |
| | invention | | | | | | | | |
| TNR77 | The present | 152 | 15:6 | 6.28 | 1.24 | A | A | A | A |
| | invention | | | | | | | | |
| TNR78 | The present | 152 | Formula | 6.27 | 1.28 | A | A | A | A |
| | invention | | (51) | | | | | | |
| TNR79 | The present | 152 | Formula | 6.24 | 1.24 | A | A | A | A |
| | invention | | (52) | | | | | | |
| TNR80 | The present | 157 | 15:4 | 6.18 | 1.26 | A | A | A | A |
| | invention | | | | | | | | |
| TNR81 | The present | 157 | 15:6 | 6.18 | 1.28 | A | A | A | A |
| | invention | | | | | | | | |
| TNR82 | The present | 157 | Formula | 6.15 | 1.24 | A | A | A | A |
| | invention | | (51) | | | | | | |
| TNR83 | The present | 157 | Formula | 6.24 | 1.28 | A | A | A | A |
| | invention | | (52) | | | | | | |
| TNR84 | For reference | None | 15:3 | 6.17 | 1.21 | Reference | C | C | C |
| TNR85 | For reference | None | 15:4 | 6.19 | 1.24 | Reference | C | C | C |
| TNR86 | For reference | None | 15:6 | 6.13 | 1.25 | Reference | C | C | C |
| TNR87 | For reference | None | Formula | 6.10 | 1.25 | Reference | C | C | C |
| | | | (51) | | | | | | |
| TNR88 | For reference | None | Formula | 6.12 | 1.28 | Reference | C | C | C |
| | | | (52) | | | | | | |
| TNR89 | Comparative | Comparative | 15:3 | 6.18 | 1.26 | B | B | B | B |
| | Example | compound 1 | | | | | | | |
| | | Comparative | | | | | | | |
| | | compound 2 | | | | | | | |
| TNR90 | Comparative | Comparative | 15:3 | 6.24 | 1.21 | B | B | B | B |
| | Example | compound 2 | | | | | | | |
| | | Comparative | | | | | | | |
| | | compound 3 | | | | | | | |
| TNR91 | Comparative | Comparative | 15:3 | 6.24 | 1.24 | C | D | D | D |
| | Example | compound 4 | | | | | | | |
| TNR92 | Comparative | Comparative | 15:3 | 7.57 | 1.45 | C | D | D | D |
| | Example | compound 5 | | | | | | | |

[In the item Pigment in Table 3, 15:3 represents C.I. Pigment Blue 15:3 represented by the formula (21); 15:4 represents C.I. Pigment Blue 15:4 represented by the formula (21); 15:6 represents C.I. Pigment Blue 15:6 represented by the formula (21).]

TABLE 4-1
Results of evaluation of suspension granulated
toners according to the present invention

| | | | | Weight | | | | | |
|---|---|---|---|---|---|---|---|---|---|
| | | | | average | | Solid image | | | |
| | | | | diameter of | | density | | | |
| | | | | toner D4 | | improvement | Fogging | Fogging | Transfer |
| Toner | | Compound | Pigment | [μm] | D4/D1 | rate | (N/N) | (H/H) | properties |
| TNR101 | The present | 150 | 15:3 | 6.15 | 1.21 | A | A | A | A |
| | invention | | | | | | | | |
| TNR102 | The present | 101 | 15:3 | 6.24 | 1.23 | A | A | A | A |
| | invention | | | | | | | | |
| TNR103 | The present | 102 | 15:3 | 6.21 | 1.24 | A | A | A | A |
| | invention | | | | | | | | |
| TNR104 | The present | 103 | 15:3 | 6.23 | 1.24 | A | A | A | A |
| | invention | | | | | | | | |
| TNR105 | The present | 104 | 15:3 | 6.21 | 1.20 | A | A | A | A |
| | invention | | | | | | | | |
| TNR106 | The present | 105 | 15:3 | 6.20 | 1.19 | A | A | A | A |
| | invention | | | | | | | | |
| TNR107 | The present | 106 | 15:3 | 6.19 | 1.24 | A | A | A | A |
| | invention | | | | | | | | |
| TNR108 | The present | 107 | 15:3 | 6.20 | 1.24 | A | A | A | A |
| | invention | | | | | | | | |
| TNR109 | The present | 108 | 15:3 | 6.24 | 1.23 | A | A | A | A |
| | invention | | | | | | | | |
| TNR110 | The present | 109 | 15:3 | 6.14 | 1.21 | A | A | A | A |
| | invention | | | | | | | | |
| TNR111 | The present | 110 | 15:3 | 6.20 | 1.20 | A | A | A | A |
| | invention | | | | | | | | |
| TNR112 | The present | 111 | 15:3 | 6.18 | 1.22 | A | A | A | A |
| | invention | | | | | | | | |
| TNR113 | The present | 112 | 15:3 | 6.19 | 1.21 | A | A | A | A |
| | invention | | | | | | | | |
| TNR114 | The present | 113 | 15:3 | 6.20 | 1.23 | A | A | A | A |
| | invention | | | | | | | | |
| TNR115 | The present | 114 | 15:3 | 6.23 | 1.24 | A | A | A | A |
| | invention | | | | | | | | |
| TNR116 | The present | 115 | 15:3 | 6.20 | 1.25 | A | A | A | A |
| | invention | | | | | | | | |
| TNR117 | The present | 116 | 15:3 | 6.20 | 1.21 | A | A | A | A |
| | invention | | | | | | | | |
| TNR118 | The present | 117 | 15:3 | 6.24 | 1.21 | A | A | A | A |
| | invention | | | | | | | | |
| TNR119 | The present | 118 | 15:3 | 6.24 | 1.20 | A | A | A | A |
| | invention | | | | | | | | |
| TNR120 | The present | 119 | 15:3 | 6.21 | 1.24 | A | A | A | A |
| | invention | | | | | | | | |
| TNR121 | The present | 120 | 15:3 | 6.14 | 1.23 | A | A | A | A |
| | invention | | | | | | | | |
| TNR122 | The present | 121 | 15:3 | 6.15 | 1.20 | A | A | A | A |
| | invention | | | | | | | | |
| TNR123 | The present | 122 | 15:3 | 6.24 | 1.19 | A | A | A | A |
| | invention | | | | | | | | |
| TNR124 | The present | 123 | 15:3 | 6.27 | 1.18 | A | A | A | A |
| | invention | | | | | | | | |
| TNR125 | The present | 124 | 15:3 | 6.17 | 1.20 | A | A | A | A |
| | invention | | | | | | | | |
| TNR126 | The present | 125 | 15:3 | 6.18 | 1.16 | A | A | A | A |
| | invention | | | | | | | | |
| TNR127 | The present | 126 | 15:3 | 6.19 | 1.18 | A | A | A | A |
| | invention | | | | | | | | |
| TNR128 | The present | 127 | 15:3 | 6.10 | 1.20 | A | A | A | A |
| | invention | | | | | | | | |
| TNR129 | The present | 128 | 15:3 | 6.20 | 1.18 | A | A | A | A |
| | invention | | | | | | | | |
| TNR130 | The present | 129 | 15:3 | 6.21 | 1.20 | A | A | A | A |
| | invention | | | | | | | | |
| TNR131 | The present | 130 | 15:3 | 6.24 | 1.17 | A | A | A | A |
| | invention | | | | | | | | |
| TNR132 | The present | 131 | 15:3 | 6.10 | 1.21 | A | A | A | A |
| | invention | | | | | | | | |
| TNR133 | The present | 132 | 15:3 | 6.13 | 1.28 | A | A | A | A |
| | invention | | | | | | | | |
| TNR134 | The present | 133 | 15:3 | 6.13 | 1.24 | A | A | A | A |
| | invention | | | | | | | | |
| TNR135 | The present | 134 | 15:3 | 6.28 | 1.21 | A | A | A | A |
| | invention | | | | | | | | |
| TNR136 | The present | 135 | 15:3 | 6.14 | 1.25 | A | A | A | A |
| | invention | | | | | | | | |
| TNR137 | The present | 136 | 15:3 | 6.15 | 1.27 | A | A | A | A |
| | invention | | | | | | | | |
| TNR138 | The present | 137 | 15:3 | 6.25 | 1.18 | A | A | A | A |
| | invention | | | | | | | | |
| TNR139 | The present | 138 | 15:3 | 6.15 | 1.19 | A | A | A | A |
| | invention | | | | | | | | |
| TNR140 | The present | 139 | 15:3 | 6.25 | 1.20 | A | A | A | A |
| | invention | | | | | | | | |
| TNR141 | The present | 140 | 15:3 | 6.23 | 1.30 | A | A | A | A |
| | invention | | | | | | | | |
| TNR142 | The present | 141 | 15:3 | 6.24 | 1.28 | A | A | A | A |
| | invention | | | | | | | | |
| TNR143 | The present | 142 | 15:3 | 6.24 | 1.29 | A | A | A | A |
| | invention | | | | | | | | |
| TNR144 | The present | 143 | 15:3 | 6.15 | 1.17 | A | A | A | A |
| | invention | | | | | | | | |
| TNR145 | The present | 144 | 15:3 | 6.19 | 1.21 | A | A | A | A |
| | invention | | | | | | | | |
| TNR146 | The present | 145 | 15:3 | 6.15 | 1.28 | A | A | A | A |
| | invention | | | | | | | | |
| TNR147 | The present | 146 | 15:3 | 6.27 | 1.15 | A | A | A | A |
| | invention | | | | | | | | |

TABLE 4-2
Results of evaluation of suspension
granulated toners according to the present invention

| | | | | Weight | | | | | |
|---|---|---|---|---|---|---|---|---|---|
| | | | | average | | Solid image | | | |
| | | | | diameter of | | density | | | |
| | | | | toner D4 | | improvement | Fogging | Fogging | Transfer |
| Toner | | Compound | Pigment | [μm] | D4/D1 | rate | (N/N) | (H/H) | properties |
| TNR148 | The present | 147 | 15:3 | 6.17 | 1.31 | A | A | A | A |
| | invention | | | | | | | | |
| TNR149 | The present | 148 | 15:3 | 6.28 | 1.20 | A | A | A | A |
| | invention | | | | | | | | |
| TNR150 | The present | 149 | 15:3 | 6.10 | 1.34 | A | A | A | A |
| | invention | | | | | | | | |
| TNR151 | The present | 151 | 15:3 | 6.12 | 1.28 | A | A | A | A |
| | invention | | | | | | | | |
| TNR152 | The present | 152 | 15:3 | 6.18 | 1.28 | A | A | A | A |
| | invention | | | | | | | | |
| TNR153 | The present | 153 | 15:3 | 6.13 | 1.24 | A | A | A | A |
| | invention | | | | | | | | |
| TNR154 | The present | 154 | 15:3 | 6.14 | 1.28 | A | A | A | A |
| | invention | | | | | | | | |
| TNR155 | The present | 155 | 15:3 | 6.20 | 1.30 | A | A | A | A |
| | invention | | | | | | | | |
| TNR156 | The present | 156 | 15:3 | 6.18 | 1.25 | A | A | A | A |
| | invention | | | | | | | | |
| TNR157 | The present | 157 | 15:3 | 6.19 | 1.24 | A | A | A | A |
| | invention | | | | | | | | |
| TNR158 | The present | 158 | 15:3 | 6.20 | 1.29 | A | A | A | A |
| | invention | | | | | | | | |
| TNR159 | The present | 159 | 15:3 | 6.12 | 1.28 | A | A | A | A |
| | invention | | | | | | | | |
| TNR160 | The present | 150 | 15:4 | 6.13 | 1.21 | A | A | A | A |
| | invention | | | | | | | | |
| TNR161 | The present | 150 | 15:6 | 6.30 | 1.24 | A | A | A | A |
| | invention | | | | | | | | |
| TNR162 | The present | 150 | Formula | 6.15 | 1.25 | A | A | A | A |
| | invention | | (51) | | | | | | |
| TNR163 | The present | 150 | Formula | 6.21 | 1.20 | A | A | A | A |
| | invention | | (52) | | | | | | |
| TNR164 | The present | 107 | 15:4 | 6.18 | 1.20 | A | A | A | A |
| | invention | | | | | | | | |
| TNR165 | The present | 107 | 15:6 | 6.14 | 1.21 | A | A | A | A |
| | invention | | | | | | | | |
| TNR166 | The present | 107 | Formula | 6.19 | 1.23 | A | A | A | A |
| | invention | | (51) | | | | | | |
| TNR167 | The present | 107 | Formula | 6.18 | 1.20 | A | A | A | A |
| | invention | | (52) | | | | | | |
| TNR168 | The present | 110 | 15:4 | 6.20 | 1.28 | A | A | A | A |
| | invention | | | | | | | | |
| TNR169 | The present | 110 | 15:6 | 6.21 | 1.24 | A | A | A | A |
| | invention | | | | | | | | |
| TNR170 | The present | 110 | Formula | 6.20 | 1.19 | A | A | A | A |
| | invention | | (51) | | | | | | |
| TNR171 | The present | 110 | Formula | 6.21 | 1.18 | A | A | A | A |
| | invention | | (52) | | | | | | |
| TNR172 | The present | 119 | 15:4 | 6.21 | 1.20 | A | A | A | A |
| | invention | | | | | | | | |
| TNR173 | The present | 119 | 15:6 | 6.27 | 1.21 | A | A | A | A |
| | invention | | | | | | | | |
| TNR174 | The present | 119 | Formula | 6.25 | 1.28 | A | A | A | A |
| | invention | | (51) | | | | | | |
| TNR175 | The present | 119 | Formula | 6.24 | 1.21 | A | A | A | A |
| | invention | | (52) | | | | | | |
| TNR176 | The present | 152 | 15:4 | 6.24 | 1.21 | A | A | A | A |
| | invention | | | | | | | | |
| TNR177 | The present | 152 | 15:6 | 6.20 | 1.23 | A | A | A | A |
| | invention | | | | | | | | |
| TNR178 | The present | 152 | Formula | 6.24 | 1.24 | A | A | A | A |
| | invention | | (51) | | | | | | |
| TNR179 | The present | 152 | Formula | 6.18 | 1.28 | A | A | A | A |
| | invention | | (52) | | | | | | |
| TNR180 | The present | 157 | 15:4 | 6.10 | 1.28 | A | A | A | A |
| | invention | | | | | | | | |
| TNR181 | The present | 157 | 15:6 | 6.18 | 1.27 | A | A | A | A |
| | invention | | | | | | | | |
| TNR182 | The present | 157 | Formula | 6.15 | 1.27 | A | A | A | A |
| | invention | | (51) | | | | | | |
| TNR183 | The present | 157 | Formula | 6.20 | 1.28 | A | A | A | A |
| | invention | | (52) | | | | | | |
| TNR184 | For reference | None | 15:3 | 6.21 | 1.24 | Reference | C | C | C |
| TNR185 | For reference | None | 15:4 | 6.22 | 1.24 | Reference | C | C | C |
| TNR186 | For reference | None | 15:6 | 6.22 | 1.23 | Reference | C | C | C |
| TNR187 | For reference | None | Formula | 6.27 | 1.25 | Reference | C | C | C |
| | | | (51) | | | | | | |
| TNR188 | For reference | None | Formula | 6.29 | 1.28 | Reference | C | C | C |
| | | | (52) | | | | | | |
| TNR189 | Comparative | Comparative | 15:3 | 6.17 | 1.27 | B | B | B | B |
| | Example | compound 1 | | | | | | | |
| | | Comparative | | | | | | | |
| | | compound 2 | | | | | | | |
| TNR190 | Comparative | Comparative | 15:3 | 6.13 | 1.21 | B | B | B | B |
| | Example | compound 2 | | | | | | | |
| | | Comparative | | | | | | | |
| | | compound 3 | | | | | | | |
| TNR191 | Comparative | Comparative | 15:3 | 6.18 | 1.38 | C | D | D | D |
| | Example | compound 4 | | | | | | | |
| TNR192 | Comparative | Comparative | 15:3 | 7.41 | 1.67 | C | D | D | D |
| | Example | compound 5 | | | | | | | |

[In the item Pigment in Table 4, 15:3 represents C.I. Pigment Blue 15:3 represented by the formula (21); 15:4 represents C.I. Pigment Blue 15:4 represented by the formula (21); 15:6 represents C.I. Pigment Blue 15:6 represented by the formula (21).]

Apparently from Table 2, it was found that use of the compound having an azo skeleton structure improves the dispersibility of the phthalocyanine pigment in the binder resin.

Moreover, apparently from Tables 3-1 and 3-2, it was found that use of the compound having an azo skeleton structure improves the dispersibility of the phthalocyanine pigment in the binder resin to provide a cyan toner having a good coloring ability. Additionally, it was found that use of the compound having an azo skeleton structure suppresses fogging to provide a cyan toner having high transfer efficiency.

Further, apparently from Tables 4-1 and 4-2, it was found that the granulation method also improves the dispersibility of the phthalocyanine pigment in the binder resin to provide a cyan toner having a good coloring ability. It was also found that fogging is suppressed to provide a cyan toner having high transfer efficiency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-043075, filed Feb. 29, 2012, which is hereby incorporated by reference herein in its entirety.

1. A cyan toner comprising toner particles comprising:
a binder resin;
a compound having a partial structure and a polymeric portion having a monomer unit, the partial structure being bound to the polymeric portion; and
a phthalocyanine pigment as a colorant, wherein, the partial structure is represented by the following formula (1): 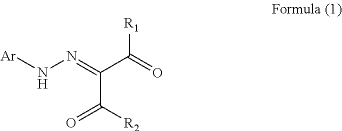
[wherein at least one of R₁, R₂, and Ar is bound to the polymeric portion with a linking group or a single bond;
R₁ and R₂ not bound to the polymeric portion each independently represent an alkyl group, a phenyl group, an OR₅ group, or an NR₆R₇ group; Ar not bound to the polymeric portion represents an aryl group;
R₁ bound to the polymeric portion and R₂ bound to the polymeric portion each independently represent a divalent group in which a hydrogen atom in the alkyl group, the phenyl group, the OR₅ group, or the NR₆R₇ group is eliminated; Ar bound to the polymeric portion represents a divalent group in which a hydrogen atom in the aryl group is eliminated; and
R₅ to R₇ each independently represent a hydrogen atom, an alkyl group, a phenyl group, or an aralkyl group; and the monomer unit being represented by the following formula (2): 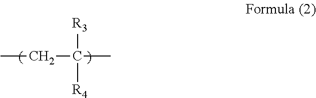
wherein R₃ represents a hydrogen atom or an alkyl group; and
R₄ represents a phenyl group, a carboxyl group, a carboxylic acid ester group, or a carboxylic acid amide group].

2. The cyan toner according to claim 1, wherein the partial structure represented by the formula (1) is represented by the following formula (3): 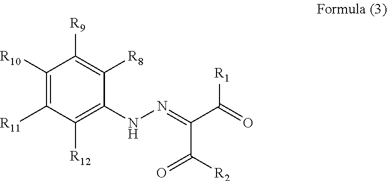
[wherein
R₁ and R₂ each independently represent an alkyl group, a phenyl group, an OR₅ group, or an NR₆R₇ group;
R₈ to R₁₂ each independently represent a hydrogen atom, a COOR₁₃ group, or a CONR₁₄R₁₅ group;
R₁₃ to R₁₅ each independently represent a hydrogen atom, an alkyl group, a phenyl group, or an aralkyl group; and
at least one of R₁, R₂, and R₈ to R₁₂ has a linking portion to the polymeric portion].

3. The cyan toner according to claim 1, wherein in the formula (1), R₂ is an NR₆R₇ group, R₆ is a hydrogen atom, and R₇ is a phenyl group.

4. The cyan toner according to claim 1, wherein in the formula (1), R₂ is an NR₆R₇ group, R₆ is a hydrogen atom, and R₇ is a phenyl group having the linking portion to the polymeric portion.

5. The cyan toner according to claim 1, wherein in the formula (1), at least one of substituents to substitute Ar is a COOR₁₃ group or a CONR₁₄R₁₅ group (wherein R₁₃ to R₁₅ each independently represent a hydrogen atom, an alkyl group, a phenyl group, or an aralkyl group).

6. The cyan toner according to claim 1, wherein the partial structure represented by the formula (1) is bound to the polymeric portion having a monomer unit represented by the formula (2) via a carboxylic acid ester bond or a carboxylic acid amide bond.

7. The cyan toner according to claim 1, wherein the partial structure represented by the formula (1) is represented by the following formula (4): 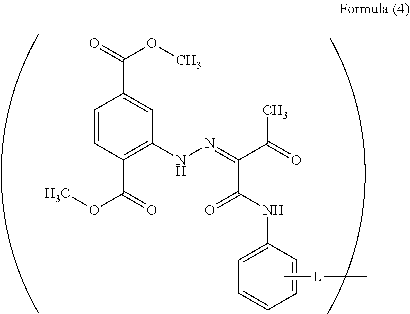
[wherein L represents a divalent linking group that links to the polymeric portion having a monomer unit represented by the above formula (2)].

8. The cyan toner according to claim 1, wherein the partial structure represented by the formula (1) is represented by the following formula (5): 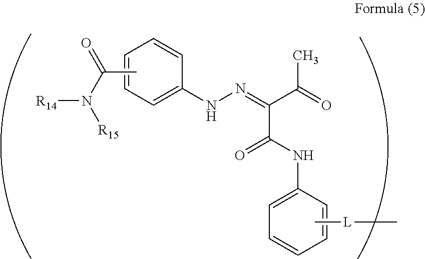
[wherein
R₁₄ and R₁₅ each independently represent a hydrogen atom, an alkyl group, a phenyl group, or an aralkyl group; and
L represents a divalent linking group that links to the polymeric portion having a monomer unit represented by the above formula (2)].

9. The cyan toner according to claim 1, wherein the phthalocyanine pigment is represented by the following formula (6): 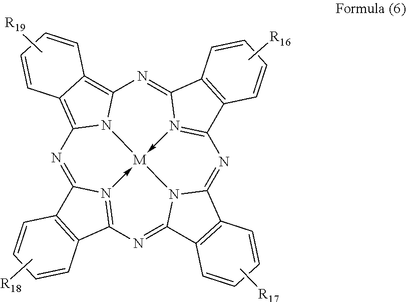
[wherein R₁₆ to R₁₉ each independently represent a hydrogen atom, an alkyl group, a sulfonic acid group, or a sulfonic acid salt group; and
M represents a metal atom or a hydrogen atom].

10. The cyan toner according to claim 1, wherein in the formula (6), R₁₆ to R₁₉ are a hydrogen atom, and M is Cu(II).

11. The cyan toner according to claim 1, wherein the toner particles are produced using a suspension polymerization method or a suspension granulation method.
